(19) United States
(12) Patent Application Publication
(10) Pub. No.: US 2007/0151360 A1
(43) Pub. Date: Jul. 5, 2007

(54) EXPANDABLE TUBULAR

(75) Inventors: Lev Ring, Houston, TX (US); Andrei Gregory Filippov, Houston, TX (US); Robert Lance Cook, Katy, TX (US); Mark Shuster, Voorburg (NL); Kevin K. Waddell, Houston, TX (US); Jose Menchaca, Houston, TX (US); Edwin Arnold Zwald JR., Houston, TX (US); Malcolm Gray, Houston, TX (US); Grigoriy Grinberg, Sylvania, OH (US); Scott Costa, Katy, TX (US)

Correspondence Address: HAYNES AND BOONE, LLP, 901 MAIN STREET, SUITE 3100, DALLAS, TX, 75202, US

(73) Assignee: Shell Oil Company, Houston, TX (US)

(21) Appl. No.: 11/554,288

(22) Filed: Oct. 30, 2006

Related U.S. Application Data
(63) Continuation-in-part of application No. PCT/US05/23391, filed on Jun. 29, 2005.
(63) Continuation-in-part of application No. 10/528,498, filed on Nov. 8, 2005.
(63) Continuation-in-part of application No. 10/528,499, filed on Nov. 8, 2005.
(63) Continuation-in-part of application No. 10/528,222, filed on Mar. 18, 2005.
(60) Provisional application No. 60/734,302, filed on Nov. 7, 2005.
(60) Provisional application No. 60/585,370, filed on Jul. 2, 2004.
(60) Provisional application No. 60/412,653, filed on Sep. 20, 2002.
(60) Provisional application No. 60/412,544, filed on Sep. 20, 2002.
(60) Provisional application No. 60/412,371, filed on Sep. 20, 2002.

(51) Int. Cl. G01N 3/08

(52) U.S. Cl. 73/834

(57) ABSTRACT

An expandable tubular member.

### CROSS REFERENCE TO RELATED APPLICATIONS

The present application claims the benefit of the filing date of U.S. provisional patent application Ser. No. 60/734,302, attorney docket no. 25791.24, filed on Nov. 7, 2005, the disclosure of which is incorporated herein by reference.

The present application is a continuation in part of PCT Application PCT/US2005/023391, attorney docket no. 25791.299.02, filed on Jun. 29, 2005, which claims priority from U.S. provisional patent application Ser. No. 60/585,370, attorney docket no. 25791.299, filed on Jul. 2, 2004, the disclosures of which is incorporated herein by reference.

The present application is a continuation in part of each of the following: (1) U.S. utility patent application Ser. No. 10/528,498, attorney docket no. 25791.118.08, filed on Mar. 18, 2005, which was the National Stage for PCT application serial no. PCT/US2003/025667, 25791.118.02, filed on Aug. 18, 2003, which claimed the benefit of the filing date of U.S. provisional patent application Ser. No. 60/412,653, attorney docket no. 25791.118, filed on Sep. 20, 2002; (2) U.S. utility patent application Ser. No. 10/528,499, attorney docket no. 25791.121.05, filed on Mar. 18, 2005, which was the National Stage for PCT application serial no. PCT/US2003/025675, 25791.121.02, filed on Aug. 18, 2003, which claimed the benefit of the filing date of U.S. provisional patent application Ser. No. 60/412,544, attorney docket no. 25791.121, filed on Sep. 20, 2002; and (3) U.S. utility patent application Ser. No. 10/528,222, attorney docket no. 25791.129.03, filed on Mar. 20, 2005, which was the National Stage for PCT application serial no. PCT/US2003/025716, 25791.129.02, filed on Aug. 18, 2003, which claimed the benefit of the filing date of U.S. provisional patent application Ser. No. 60/412,371, attorney docket no. 25791.129, filed on Sep. 20, 2002, the disclosures of which are incorporated herein by reference.

This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/1111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 17, 1999, (60) U.S. patent application Ser. No. 10/092,481, attorney docket no. 25791.85, filed on Mar. 17, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 17, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, (now U.S. Pat. No. 6,634,431 which issued Oct. 21, 2003), which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, (now U.S. Pat. No. 6,640,903 which issued Nov. 4, 2003), which claims priority from provisional application 60/124,042, filed on Mar. 11, 1999; (122) PCT patent application serial no. PCT/US2004/06246, attorney docket no. 25791.238.02, filed on Feb. 26, 2004; (123) PCT patent application serial number PCT/US2004/08170, attorney docket number 25791.40.02, filed on Mar. 15, 2004; (124) PCT patent application serial number PCT/US2004/08171, attorney docket number 25791.236.02, filed on Mar. 15, 2004; (125) PCT patent application serial number PCT/US2004/08073, attorney docket number 25791.262.02, filed on Mar. 18, 2004; (126) PCT patent application serial number PCT/US2004/07711, attorney docket number 25791.253.02, filed on Mar. 11, 2004; (127) PCT patent application serial number PCT/US2004/029025, attorney docket number 25791.260.02, filed on Mar. 26, 2004; (128) PCT patent application serial number PCT/US2004/010317, attorney docket number 25791.270.02, filed on Apr. 2, 2004; (129) PCT patent application serial number PCT/US2004/010712, attorney docket number 25791.272.02, filed on Apr. 6, 2004; (130) PCT patent application serial number PCT/US2004/010762, attorney docket number 25791.273.02, filed on Apr. 6, 2004; (131) PCT patent application serial number PCT/US2004/011973, attorney docket number 25791.277.02, filed on Apr. 15, 2004; (132) U.S. provisional patent application Ser. No. 60/495,056, attorney docket number 25791.301, filed on Aug. 14, 2003; (133) U.S. provisional patent application Ser. No. 60/600,679, attorney docket number 25791.194, filed on Aug. 11, 2004; (134) PCT patent application serial number PCT/US2005/027318, attorney docket number 25791.329.02, filed on Jul. 29, 2005; (135) PCT patent application serial number PCT/US2005/028936, attorney docket number 25791.338.02, filed on Aug. 12, 2005; (136) PCT patent application serial number PCT/US2005/028669, attorney docket number 25791.194.02, filed on Aug. 11, 2005; (137) PCT patent application serial number PCT/US2005/028453, attorney docket number 25791.371, filed on Aug. 11, 2005; (138) PCT patent application serial number PCT/US2005/028641, attorney docket number 25791.372, filed on Aug. 11, 2005; (139) PCT patent application serial number PCT/US2005/028819, attorney docket number 25791.373, filed on Aug. 11, 2005; (140) PCT patent application serial number PCT/US2005/028446, attorney docket number 25791.374, filed on Aug. 11, 2005; (141) PCT patent application serial number PCT/US2005/028642, attorney docket number 25791.375, filed on Aug. 11, 2005; (142) PCT patent application serial number PCT/US2005/028451, attorney docket number 25791.376, filed on Aug. 11, 2005, and (143) PCT patent application serial number PCT/US2005/028473, attorney docket number 25791.377, filed on Aug. 11, 2005, the disclosures of which are incorporated herein by reference.

### BACKGROUND OF THE INVENTION

This invention relates generally to oil and gas exploration, and in particular to forming and repairing wellbore casings to facilitate oil and gas exploration.

### BRIEF DESCRIPTION OF THE DRAWINGS

FIG. 1 is a fragmentary cross sectional view of an exemplary embodiment of an expandable tubular member positioned within a preexisting structure.

FIG. 2 is a fragmentary cross sectional view of the expandable tubular member of FIG. 1 after positioning an expansion device within the expandable tubular member.

FIG. 3 is a fragmentary cross sectional view of the expandable tubular member of FIG. 2 after operating the expansion device within the expandable tubular member to radially expand and plastically deform a portion of the expandable tubular member.

FIG. 4 is a fragmentary cross sectional view of the expandable tubular member of FIG. 3 after operating the expansion device within the expandable tubular member to radially expand and plastically deform another portion of the expandable tubular member.

FIG. 5 is a graphical illustration of exemplary embodiments of the stress/strain curves for several portions of the expandable tubular member of FIGS. 1-4.

FIG. 6 is a graphical illustration of the an exemplary embodiment of the yield strength vs. ductility curve for at least a portion of the expandable tubular member of FIGS. 1-4.

FIG. 7 is a fragmentary cross sectional illustration of an embodiment of a series of overlapping expandable tubular members.

FIG. 8 is a fragmentary cross sectional view of an exemplary embodiment of an expandable tubular member positioned within a preexisting structure.

FIG. 9 is a fragmentary cross sectional view of the expandable tubular member of FIG. 8 after positioning an expansion device within the expandable tubular member.

FIG. 10 is a fragmentary cross sectional view of the expandable tubular member of FIG. 9 after operating the expansion device within the expandable tubular member to radially expand and plastically deform a portion of the expandable tubular member.

FIG. 11 is a fragmentary cross sectional view of the expandable tubular member of FIG. 10 after operating the expansion device within the expandable tubular member to radially expand and plastically deform another portion of the expandable tubular member.

FIG. 12 is a graphical illustration of exemplary embodiments of the stress/strain curves for several portions of the expandable tubular member of FIGS. 8-11.

FIG. 13 is a graphical illustration of an exemplary embodiment of the yield strength vs. ductility curve for at least a portion of the expandable tubular member of FIGS. 8-11.

FIG. 14 is a fragmentary cross sectional view of an exemplary embodiment of an expandable tubular member positioned within a preexisting structure.

FIG. 15 is a fragmentary cross sectional view of the expandable tubular member of FIG. 14 after positioning an expansion device within the expandable tubular member.

FIG. 16 is a fragmentary cross sectional view of the expandable tubular member of FIG. 15 after operating the expansion device within the expandable tubular member to radially expand and plastically deform a portion of the expandable tubular member.

FIG. 17 is a fragmentary cross sectional view of the expandable tubular member of FIG. 16 after operating the expansion device within the expandable tubular member to radially expand and plastically deform another portion of the expandable tubular member.

FIG. 18 is a flow chart illustration of an exemplary embodiment of a method of processing an expandable tubular member.

FIG. 19 is a graphical illustration of the an exemplary embodiment of the yield strength vs. ductility curve for at least a portion of the expandable tubular member during the operation of the method of FIG. 18.

FIG. 20 is a graphical illustration of stress/strain curves for an exemplary embodiment of an expandable tubular member.

FIG. 21 is a graphical illustration of stress/strain curves for an exemplary embodiment of an expandable tubular member.

FIG. 22 is a fragmentary cross-sectional view illustrating an embodiment of the radial expansion and plastic deformation of a portion of a first tubular member having an internally threaded connection at an end portion, an embodiment of a tubular sleeve supported by the end portion of the first tubular member, and a second tubular member having an externally threaded portion coupled to the internally threaded portion of the first tubular member and engaged by a flange of the sleeve. The sleeve includes the flange at one end for increasing axial compression loading.

FIG. 23 is a fragmentary cross-sectional view illustrating an embodiment of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial tension loading.

FIG. 24 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial compression/tension loading.

FIG. 25 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends having sacrificial material thereon.

FIG. 26 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a thin walled cylinder of sacrificial material.

FIG. 27 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a variable thickness along the length thereof.

FIG. 28 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a member coiled onto grooves formed in the sleeve for varying the sleeve thickness.

FIG. 29 is a fragmentary cross-sectional illustration of an exemplary embodiment of an expandable connection.

FIGS. 30a-30c are fragmentary cross-sectional illustrations of exemplary embodiments of expandable connections.

FIG. 31 is a fragmentary cross-sectional illustration of an exemplary embodiment of an expandable connection.

FIGS. 32a and 32b are fragmentary cross-sectional illustrations of the formation of an exemplary embodiment of an expandable connection.

FIG. 33 is a fragmentary cross-sectional illustration of an exemplary embodiment of an expandable connection.

FIGS. 34a, 34b and 34c are fragmentary cross-sectional illustrations of an exemplary embodiment of an expandable connection.

FIG. 35a is a fragmentary cross-sectional illustration of an exemplary embodiment of an expandable tubular member.

FIG. 35b is a graphical illustration of an exemplary embodiment of the variation in the yield point for the expandable tubular member of FIG. 35a.

FIG. 36a is a flow chart illustration of an exemplary embodiment of a method for processing a tubular member.

FIG. 36b is an illustration of the microstructure of an exemplary embodiment of a tubular member prior to thermal processing.

FIG. 36c is an illustration of the microstructure of an exemplary embodiment of a tubular member after thermal processing.

FIG. 37a is a flow chart illustration of an exemplary embodiment of a method for processing a tubular member.

FIG. 37b is an illustration of the microstructure of an exemplary embodiment of a tubular member prior to thermal processing.

FIG. 37c is an illustration of the microstructure of an exemplary embodiment of a tubular member after thermal processing.

FIG. 38a is a flow chart illustration of an exemplary embodiment of a method for processing a tubular member.

FIG. 38b is an illustration of the microstructure of an exemplary embodiment of a tubular member prior to thermal processing.

FIG. 38c is an illustration of the microstructure of an exemplary embodiment of a tubular member after thermal processing.

FIG. 39 is a side view of an exemplary embodiment of an expansion device.

FIG. 40 is a cross sectional view of an exemplary embodiment of an expandable tubular member used with the expansion device of FIG. 39.

FIG. 41a is a partial cross sectional view of the expandable tubular member of FIG. 40 being expanded by the expansion device of FIG. 39.

FIG. 41b is a cross sectional view of the expandable tubular member of FIG. 40.

### DETAILED DESCRIPTION OF THE ILLUSTRATIVE EMBODIMENTS

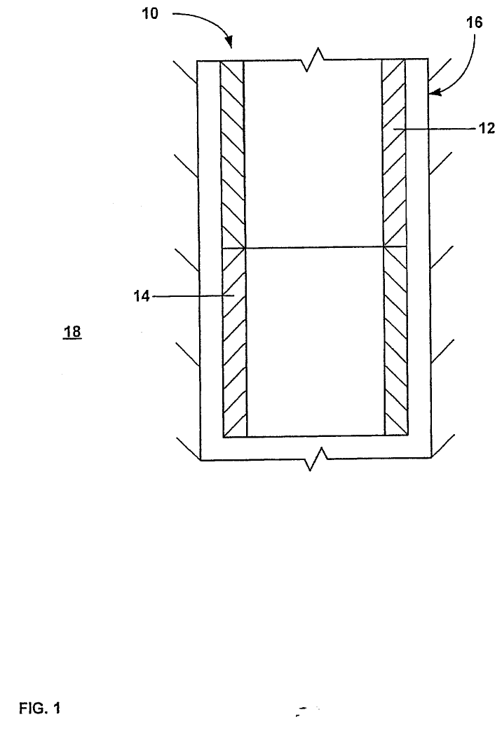

Referring initially to FIG. 1, an exemplary embodiment of an expandable tubular assembly 10 includes a first expandable tubular member 12 coupled to a second expandable tubular member 14. In several exemplary embodiments, the ends of the first and second expandable tubular members, 12 and 14, are coupled using, for example, a conventional mechanical coupling, a welded connection, a brazed connection, a threaded connection, and/or an interference fit connection. In an exemplary embodiment, the first expandable tubular member 12 has a plastic yield point YP1, and the second expandable tubular member 14 has a plastic yield point YP2. In an exemplary embodiment, the expandable tubular assembly 10 is positioned within a preexisting structure such as, for example, a wellbore 16 that traverses a subterranean formation 18.

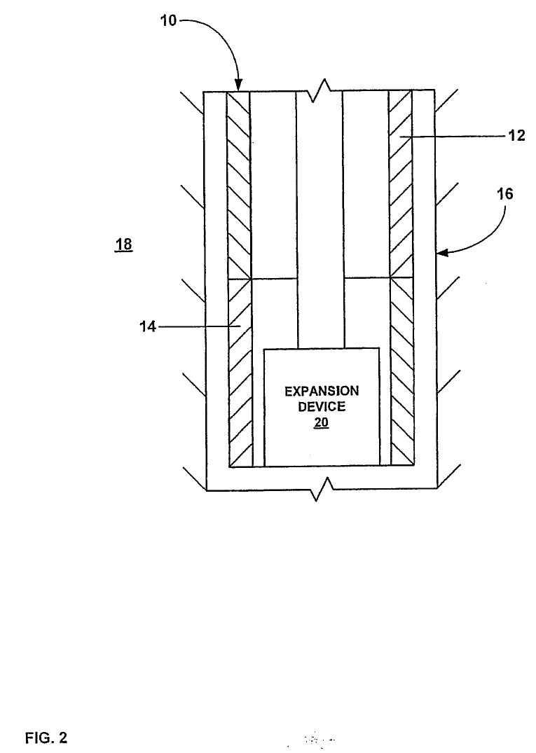

As illustrated in FIG. 2, an expansion device 20 may then be positioned within the second expandable tubular member 14. In several exemplary embodiments, the expansion device 20 may include, for example, one or more of the following conventional expansion devices: a) an expansion cone; b) a rotary expansion device; c) a hydroforming expansion device; d) an impulsive force expansion device; d) any one of the expansion devices commercially available from, or disclosed in any of the published patent applications or issued patents, of Weatherford International, Baker Hughes, Halliburton Energy Services, Shell Oil Co., Schlumberger, and/or Enventure Global Technology L.L.C. In several exemplary embodiments, the expansion device 20 is positioned within the second expandable tubular member 14 before, during, or after the placement of the expandable tubular assembly 10 within the preexisting structure 16.

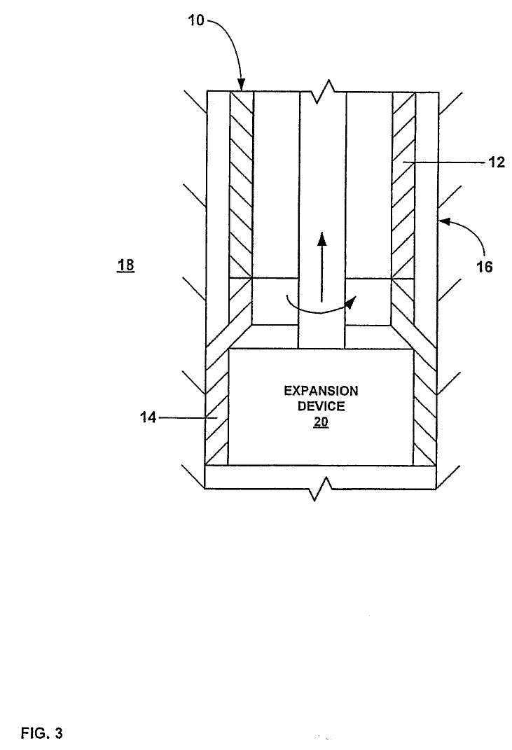

As illustrated in FIG. 3, the expansion device 20 may then be operated to radially expand and plastically deform at least a portion of the second expandable tubular member 14 to form a bell-shaped section.

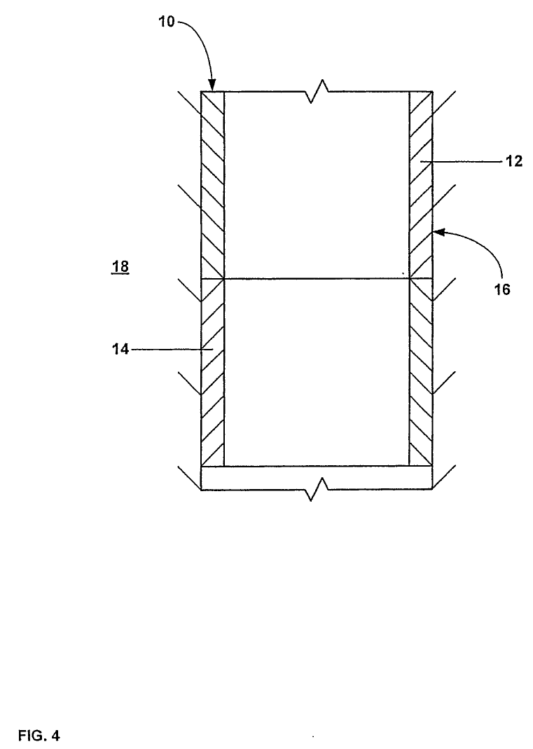

As illustrated in FIG. 4, the expansion device 20 may then be operated to radially expand and plastically deform the remaining portion of the second expandable tubular member 14 and at least a portion of the first expandable tubular member 12.

In an exemplary embodiment, at least a portion of at least a portion of at least one of the first and second expandable tubular members, 12 and 14, are radially expanded into intimate contact with the interior surface of the preexisting structure 16.

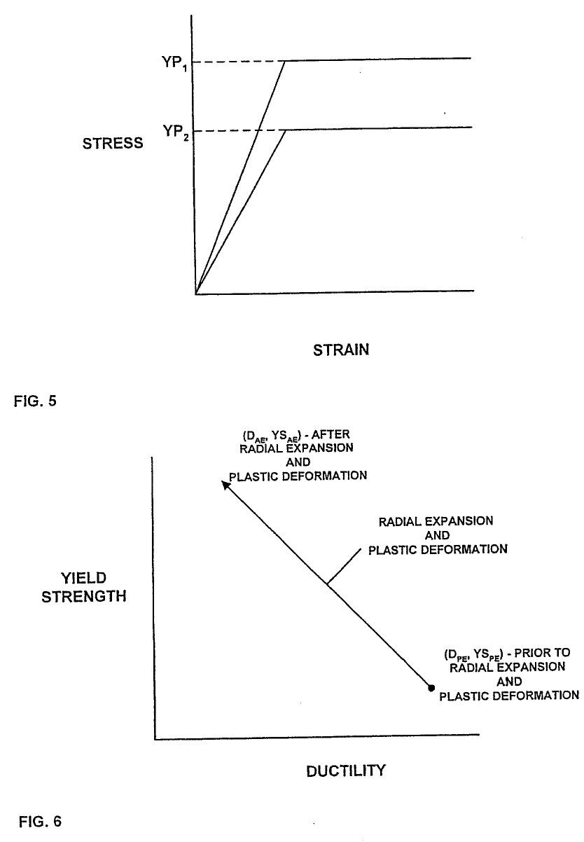

In an exemplary embodiment, as illustrated in FIG. 5, the plastic yield point YP1 is greater than the plastic yield point YP2 In this manner, in an exemplary embodiment, the amount of power and/or energy required to radially expand the second expandable tubular member 14 is less than the amount of power and/or energy required to radially expand the first expandable tubular member 12.

In an exemplary embodiment, as illustrated in FIG. 6, the first expandable tubular member 12 and/or the second expandable tubular member 14 have a ductility DPE and a yield strength YSPE prior to radial expansion and plastic deformation, and a ductility DAE and a yield strength YSAE after radial expansion and plastic deformation. In an exemplary embodiment, DPE is greater than DAE, and YSAE is greater than YSPE. In this manner, the first expandable tubular member 12 and/or the second expandable tubular member 14 are transformed during the radial expansion and plastic deformation process. Furthermore, in this manner, in an exemplary embodiment, the amount of power and/or energy required to radially expand each unit length of the first and/or second expandable tubular members, 12 and 14, is reduced. Furthermore, because the YSAE is greater than YSPE, the collapse strength of the first expandable tubular member 12 and/or the second expandable tubular member 14 is increased after the radial expansion and plastic deformation process.

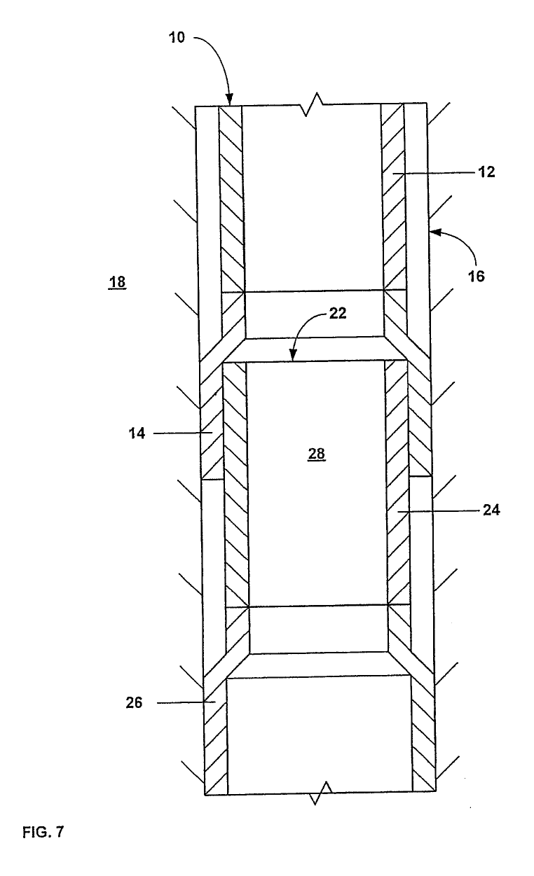

In an exemplary embodiment, as illustrated in FIG. 7, following the completion of the radial expansion and plastic deformation of the expandable tubular assembly 10 described above with reference to FIGS. 1-4, at least a portion of the second expandable tubular member 14 has an inside diameter the is greater than at least the inside diameter of the first expandable tubular member 12. In this manner a bell-shaped section is formed using at least a portion of the second expandable tubular member 14. Another expandable tubular assembly 22 that includes a first expandable tubular member 24 and a second expandable tubular member 26 may then be positioned in overlapping relation to the first expandable tubular assembly 10 and radially expanded and plastically deformed using the methods described above with reference to FIGS. 1-4. Furthermore, following the completion of the radial expansion and plastic deformation of the expandable tubular assembly 20, in an exemplary embodiment, at least a portion of the second expandable tubular member 26 has an inside diameter the is greater than at least the inside diameter of the first expandable tubular member 24. In this manner a bell-shaped section is formed using at least a portion of the second expandable tubular member 26. Furthermore, in this manner, a mono-diameter tubular assembly is formed that defines an internal passage 28 having a substantially constant cross-sectional area and/or inside diameter.

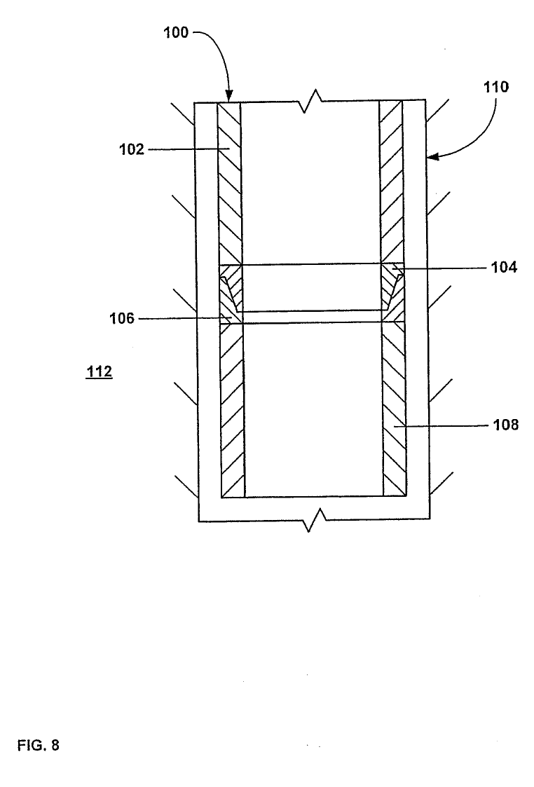

Referring to FIG. 8, an exemplary embodiment of an expandable tubular assembly 100 includes a first expandable tubular member 102 coupled to a tubular coupling 104. The tubular coupling 104 is coupled to a tubular coupling 106. The tubular coupling 106 is coupled to a second expandable tubular member 108. In several exemplary embodiments, the tubular couplings, 104 and 106, provide a tubular coupling assembly for coupling the first and second expandable tubular members, 102 and 108, together that may include, for example, a conventional mechanical coupling, a welded connection, a brazed connection, a threaded connection, and/or an interference fit connection. In an exemplary embodiment, the first and second expandable tubular members 12 have a plastic yield point YP1, and the tubular couplings, 104 and 106, have a plastic yield point YP2. In an exemplary embodiment, the expandable tubular assembly 100 is positioned within a preexisting structure such as, for example, a wellbore 110 that traverses a subterranean formation 112.

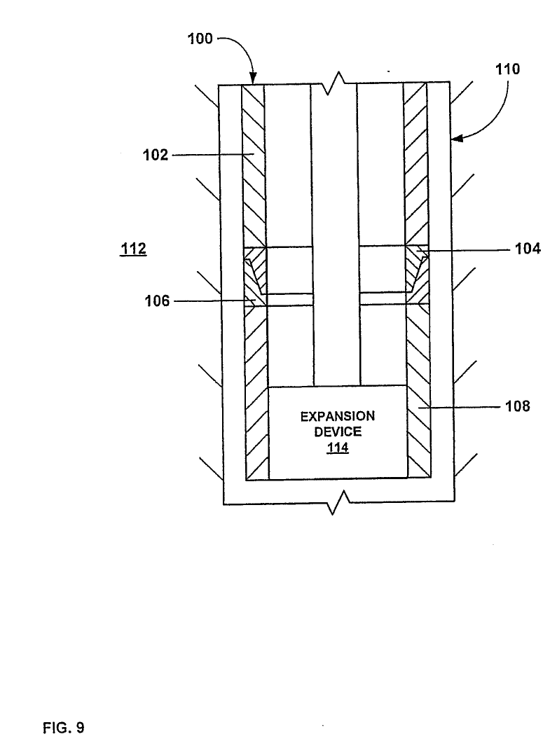

As illustrated in FIG. 9, an expansion device 114 may then be positioned within the second expandable tubular member 108. In several exemplary embodiments, the expansion device 114 may include, for example, one or more of the following conventional expansion devices: a) an expansion cone; b) a rotary expansion device; c) a hydroforming expansion device; d) an impulsive force expansion device; d) any one of the expansion devices commercially available from, or disclosed in any of the published patent applications or issued patents, of Weatherford International, Baker Hughes, Halliburton Energy Services, Shell Oil Co., Schlumberger, and/or Enventure Global Technology L.L.C. In several exemplary embodiments, the expansion device 114 is positioned within the second expandable tubular member 108 before, during, or after the placement of the expandable tubular assembly 100 within the preexisting structure 110.

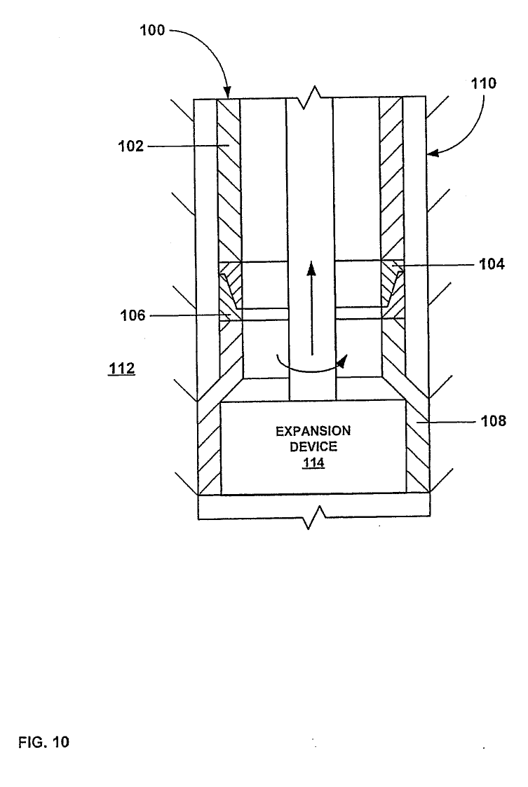

As illustrated in FIG. 10, the expansion device 114 may then be operated to radially expand and plastically deform at least a portion of the second expandable tubular member 108 to form a bell-shaped section.

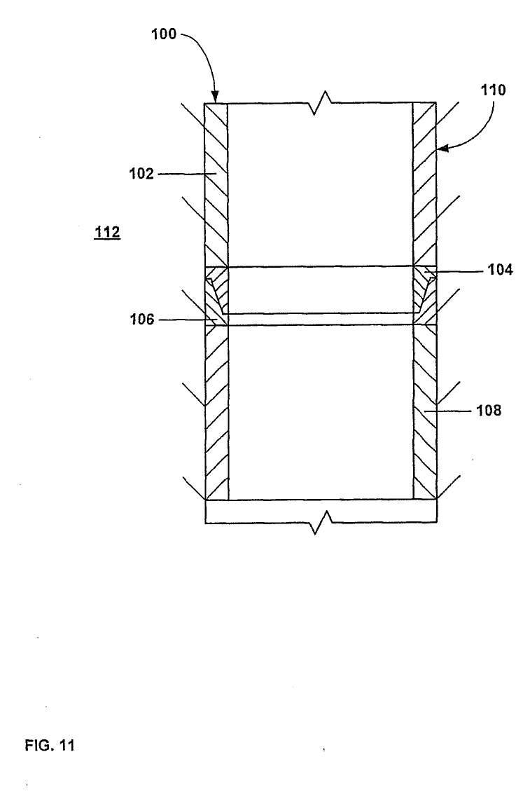

As illustrated in FIG. 11, the expansion device 114 may then be operated to radially expand and plastically deform the remaining portion of the second expandable tubular member 108, the tubular couplings, 104 and 106, and at least a portion of the first expandable tubular member 102.

In an exemplary embodiment, at least a portion of at least a portion of at least one of the first and second expandable tubular members, 102 and 108, are radially expanded into intimate contact with the interior surface of the preexisting structure 110.

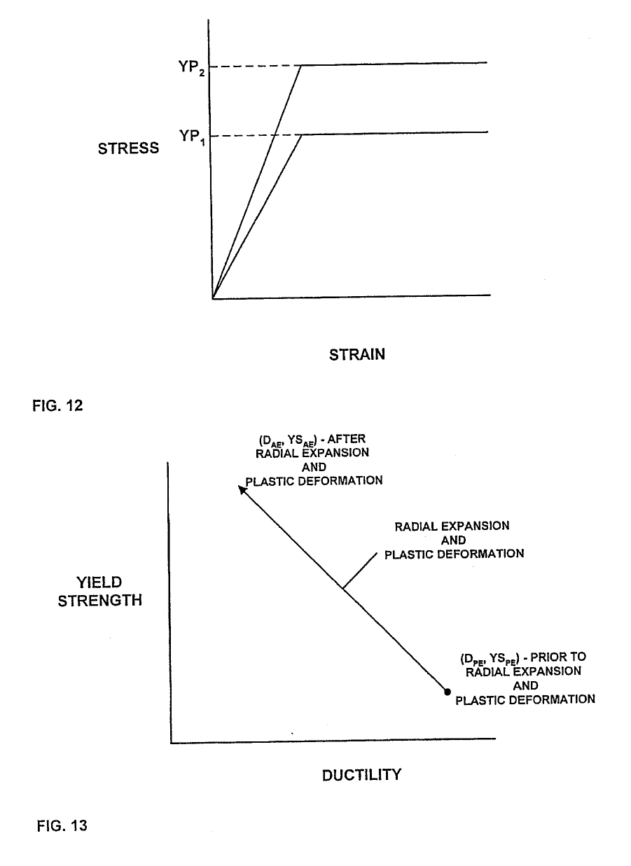

In an exemplary embodiment, as illustrated in FIG. 12, the plastic yield point YP1 is less than the plastic yield point YP2. In this manner, in an exemplary embodiment, the amount of power and/or energy required to radially expand each unit length of the first and second expandable tubular members, 102 and 108, is less than the amount of power and/or energy required to radially expand each unit length of the tubular couplings, 104 and 106.

In an exemplary embodiment, as illustrated in FIG. 13, the first expandable tubular member 12 and/or the second expandable tubular member 14 have a ductility DPE and a yield strength YSPE prior to radial expansion and plastic deformation, and a ductility DAE and a yield strength YSAE after radial expansion and plastic deformation. In an exemplary embodiment, DPE is greater than DAE, and YSAE is greater than YSPE. In this manner, the first expandable tubular member 12 and/or the second expandable tubular member 14 are transformed during the radial expansion and plastic deformation process. Furthermore, in this manner, in an exemplary embodiment, the amount of power and/or energy required to radially expand each unit length of the first and/or second expandable tubular members, 12 and 14, is reduced. Furthermore, because the YSAE is greater than YSPE, the collapse strength of the first expandable tubular member 12 and/or the second expandable tubular member 14 is increased after the radial expansion and plastic deformation process.

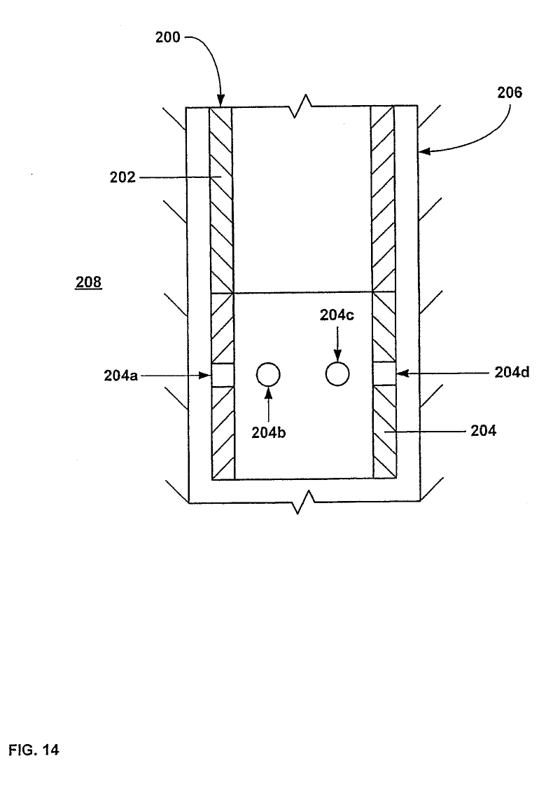

Referring to FIG. 14, an exemplary embodiment of an expandable tubular assembly 200 includes a first expandable tubular member 202 coupled to a second expandable tubular member 204 that defines radial openings 204a, 204b, 204c, and 204d. In several exemplary embodiments, the ends of the first and second expandable tubular members, 202 and 204, are coupled using, for example, a conventional mechanical coupling, a welded connection, a brazed connection, a threaded connection, and/or an interference fit connection. In an exemplary embodiment, one or more of the radial openings, 204a, 204b, 204c, and 204d, have circular, oval, square, and/or irregular cross sections and/or include portions that extend to and interrupt either end of the second expandable tubular member 204. In an exemplary embodiment, the expandable tubular assembly 200 is positioned within a preexisting structure such as, for example, a wellbore 206 that traverses a subterranean formation 208.

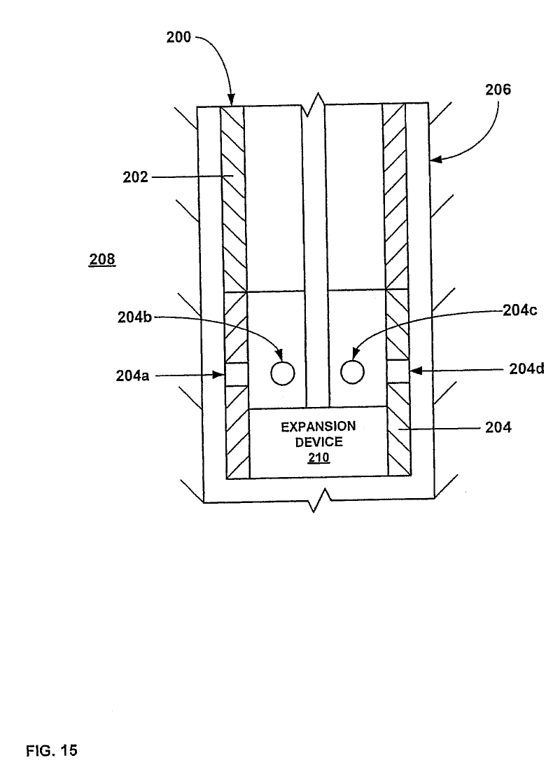

As illustrated in FIG. 15, an expansion device 210 may then be positioned within the second expandable tubular member 204. In several exemplary embodiments, the expansion device 210 may include, for example, one or more of the following conventional expansion devices: a) an expansion cone; b) a rotary expansion device; c) a hydroforming expansion device; d) an impulsive force expansion device; d) any one of the expansion devices commercially available from, or disclosed in any of the published patent applications or issued patents, of Weatherford International, Baker Hughes, Halliburton Energy Services, Shell Oil Co., Schlumberger, and/or Enventure Global Technology L.L.C. In several exemplary embodiments, the expansion device 210 is positioned within the second expandable tubular member 204 before, during, or after the placement of the expandable tubular assembly 200 within the preexisting structure 206.

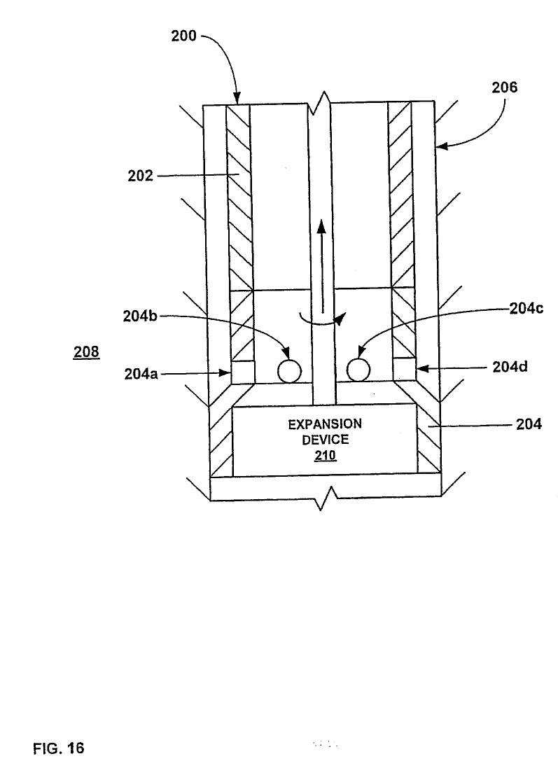

As illustrated in FIG. 16, the expansion device 210 may then be operated to radially expand and plastically deform at least a portion of the second expandable tubular member 204 to form a bell-shaped section.

As illustrated in FIG. 16, the expansion device 20 may then be operated to radially expand and plastically deform the remaining portion of the second expandable tubular member 204 and at least a portion of the first expandable tubular member 202.

In an exemplary embodiment, the anisotropy ratio AR for the first and second expandable tubular members is defined by the following equation:
AR=In(VWTf/WTo)/In(Df/Do);

where AR=anisotropy ratio;

where WTf=final wall thickness of the expandable tubular member following the radial expansion and plastic deformation of the expandable tubular member;

where WTi=initial wall thickness of the expandable tubular member prior to the radial expansion and plastic deformation of the expandable tubular member;

where Df=final inside diameter of the expandable tubular member following the radial expansion and plastic deformation of the expandable tubular member; and

where Di=initial inside diameter of the expandable tubular member prior to the radial expansion and plastic deformation of the expandable tubular member.

In an exemplary embodiment, the anisotropy ratio AR for the first and/or second expandable tubular members, 204 and 204, is greater than 1.

In an exemplary experimental embodiment, the second expandable tubular member 204 had an anisotropy ratio AR greater than 1, and the radial expansion and plastic deformation of the second expandable tubular member did not result in any of the openings, 204a, 204b, 204c, and 204d, splitting or otherwise fracturing the remaining portions of the second expandable tubular member. This was an unexpected result.

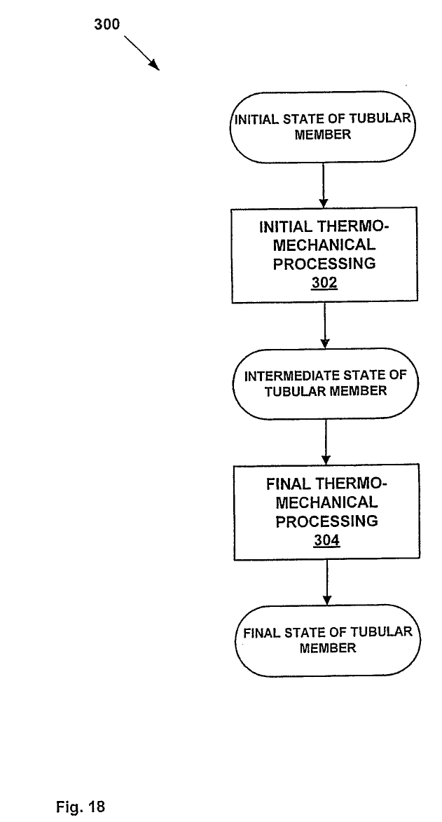

Referring to FIG. 18, in an exemplary embodiment, one or more of the expandable tubular members, 12, 14, 24, 26, 102, 104, 106, 108, 202 and/or 204 are processed using a method 300 in which a tubular member in an initial state is thermo-mechanically processed in step 302. In an exemplary embodiment, the thermo-mechanical processing 302 includes one or more heat treating and/or mechanical forming processes. As a result, of the thermo-mechanical processing 302, the tubular member is transformed to an intermediate state. The tubular member is then further thermo-mechanically processed in step 304. In an exemplary embodiment, the thermo-mechanical processing 304 includes one or more heat treating and/or mechanical forming processes. As a result, of the thermo-mechanical processing 304, the tubular member is transformed to a final state.

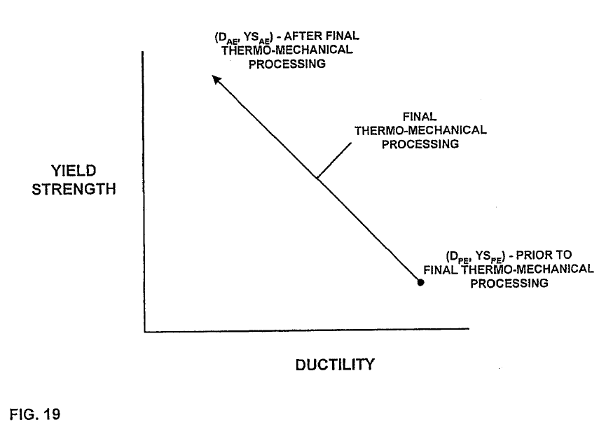

In an exemplary embodiment, as illustrated in FIG. 19, during the operation of the method 300, the tubular member has a ductility DPE and a yield strength YSPE prior to the final thermo-mechanical processing in step 304, and a ductility DAE and a yield strength YSAE after final thermo-mechanical processing. In an exemplary embodiment, DPE is greater than DAE, and YSAE is greater than YSPE. In this manner, the amount of energy and/or power required to transform the tubular member, using mechanical forming processes, during the final thermo-mechanical processing in step 304 is reduced. Furthermore, in this manner, because the YSAE is greater than YSPE, the collapse strength of the tubular member is increased after the final thermo-mechanical processing in step 304.

In an exemplary embodiment, one or more of the expandable tubular members, 12, 14, 24, 26, 102, 104, 106, 108, 202 and/or 204, have the following characteristics:

| Characteristic | Value |
|---|---|
| Tensile Strength | 60 to 120 ksi |
| Yield Strength | 50 to 100 ksi |
| Y/T Ratio | Maximum of 50/85% |
| Elongation During Radial Expansion | Minimum of 35% |
| and Plastic Deformation | |
| Width Reduction During Radial Expansion | Minimum of 40% |
| and Plastic Deformation | |
| Wall Thickness Reduction During Radial | Minimum of 30% |
| Expansion and Plastic Deformation | |
| Anisotropy | Minimum of 1.5 |
| Minimum Absorbed Energy at −4 F. (−20 C.) | 80 ft-lb |
| in the Longitudinal Direction | |
| Minimum Absorbed Energy at −4 F. (−20 C.) | 60 ft-lb |
| in the Transverse Direction | |
| Minimum Absorbed Energy at −4 F. (−20 C.) | 60 ft-lb |
| Transverse To A Weld Area | |
| Flare Expansion Testing | Minimum of 75% |
| | Without A Failure |
| Increase in Yield Strength Due To Radial | Greater than 5.4% |
| Expansion and Plastic Deformation | |

In an exemplary embodiment, one or more of the expandable tubular members, 12, 14, 24, 26, 102, 104, 106, 108, 202 and/or 204, are characterized by an expandability coefficient f:
i. f=r×n
ii. where f=expandability coefficient;
   1. r=anisotropy coefficient; and
   2. n=strain hardening exponent.

In an exemplary embodiment, the anisotropy coefficient for one or more of the expandable tubular members, 12,14, 24, 26,102,104, 106,108, 202 and/or 204 is greater than 1. In an exemplary embodiment, the strain hardening exponent for one or more of the expandable tubular members, 12, 14, 24, 26, 102, 104, 106, 108, 202 and/or 204 is greater than 0.12. In an exemplary embodiment, the expandability coefficient for one or more of the expandable tubular members, 12, 14, 24, 26, 102, 104, 106, 108, 202 and/or 204 is greater than 0.12.

In an exemplary embodiment, a tubular member having a higher expandability coefficient requires less power and/or energy to radially expand and plastically deform each unit length than a tubular member having a lower expandability coefficient. In an exemplary embodiment, a tubular member having a higher expandability coefficient requires less power and/or energy per unit length to radially expand and plastically deform than a tubular member having a lower expandability coefficient.

In several exemplary experimental embodiments, one or more of the expandable tubular members, 12, 14, 24, 26, 102, 104, 106, 108, 202 and/or 204, are steel alloys having one of the following compositions:

| Steel | Element and Percentage By Weight | | | | | | | |
|---|---|---|---|---|---|---|---|---|
| Alloy | C | Mn | P | S | Si | Cu | Ni | Cr |
| A | 0.065 | 1.44 | 0.01 | 0.002 | 0.24 | 0.01 | 0.01 | 0.02 |
| B | 0.18 | 1.28 | 0.017 | 0.004 | 0.29 | 0.01 | 0.01 | 0.03 |
| C | 0.08 | 0.82 | 0.006 | 0.003 | 0.30 | 0.16 | 0.05 | 0.05 |
| D | 0.02 | 1.31 | 0.02 | 0.001 | 0.45 | — | 9.1 | 18.7 |

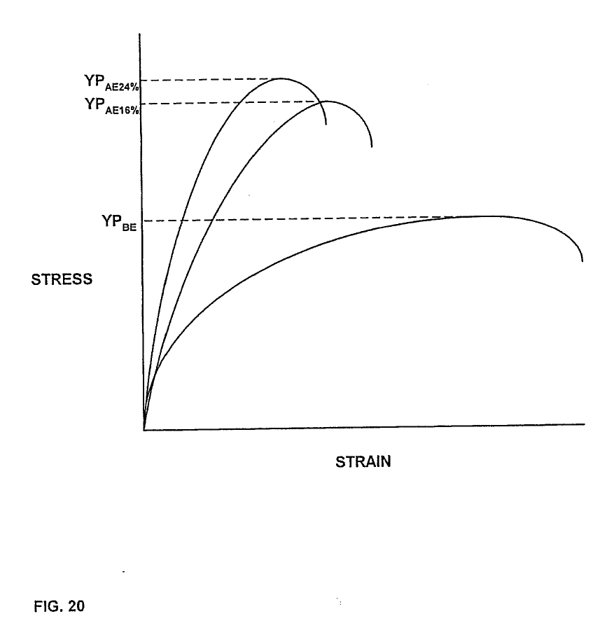

In exemplary experimental embodiment, as illustrated in FIG. 20, a sample of an expandable tubular member composed of Alloy A exhibited a yield point before radial expansion and plastic deformation YPBE, a yield point after radial expansion and plastic deformation of about 16% YPAE16%, and a yield point after radial expansion and plastic deformation of about 24% YPAE24%. In an exemplary experimental embodiment, YPAE24%>YPAE16%>YPBE. Furthermore, in an exemplary experimental embodiment, the ductility of the sample of the expandable tubular member composed of Alloy A also exhibited a higher ductility prior to radial expansion and plastic deformation than after radial expansion and plastic deformation. These were unexpected results.

In an exemplary experimental embodiment, a sample of an expandable tubular member composed of Alloy A exhibited the following tensile characteristics before and after radial expansion and plastic deformation:

| | | | | | Wall | |
|---|---|---|---|---|---|---|
| | Yield | Yield | | Width | Thickness | |
| | Point ksi | Ratio | Elongation % | Reduction % | Reduction % | Anisotropy |
| Before Radial | 46.9 | 0.69 | 53 | −52 | 55 | 0.93 |
| Expansion and | | | | | | |
| Plastic Deformation | | | | | | |
| After 16% Radial | 65.9 | 0.83 | 17 | 42 | 51 | 0.78 |
| Expansion | | | | | | |
| After 24% Radial | 68.5 | 0.83 | 5 | 44 | 54 | 0.76 |
| Expansion | | | | | | |

| | |
|---|---|
| % Increase | 40% for 16% radial |
| | expansion 46% for |
| | 24% radial expansion |

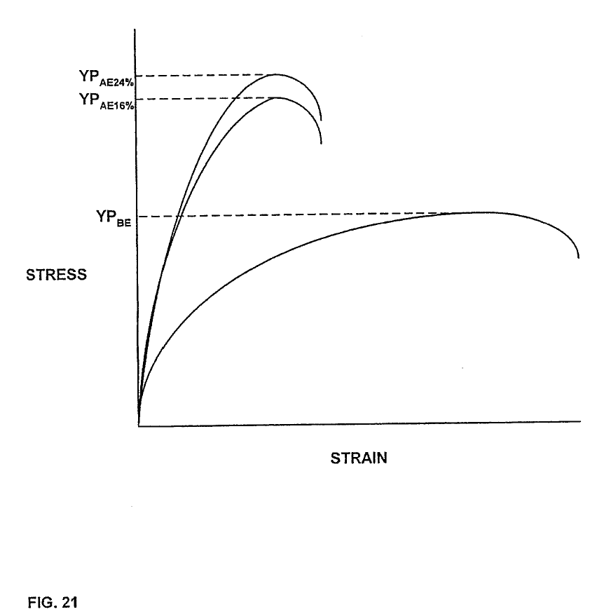

In exemplary experimental embodiment, as illustrated in FIG. 21, a sample of an expandable tubular member composed of Alloy B exhibited a yield point before radial expansion and plastic deformation YPBE, a yield point after radial expansion and plastic deformation of about 16% YPAE16%, and a yield point after radial expansion and plastic deformation of about 24% YPAE24%. In an exemplary embodiment, YPAE24%>YPAE16%>YPBE. Furthermore, in an exemplary experimental embodiment, the ductility of the sample of the expandable tubular member composed of Alloy B also exhibited a higher ductility prior to radial expansion and plastic deformation than after radial expansion and plastic deformation. These were unexpected results.

In an exemplary experimental embodiment, a sample of an expandable tubular member composed of Alloy B exhibited the following tensile characteristics before and after radial expansion and plastic deformation:

| | | | | | Wall | |
|---|---|---|---|---|---|---|
| | Yield | Yield | | Width | Thickness | |
| | Point ksi | Ratio | Elongation % | Reduction % | Reduction % | Anisotropy |
| Before Radial | 57.8 | 0.71 | 44 | 43 | 46 | 0.93 |
| Expansion and | | | | | | |
| Plastic Deformation | | | | | | |
| After 16% Radial | 74.4 | 0.84 | 16 | 38 | 42 | 0.87 |
| Expansion | | | | | | |
| After 24% Radial | 79.8 | 0.86 | 20 | 36 | 42 | 0.81 |
| Expansion | | | | | | |

| | |
|---|---|
| % Increase | 28.7% increase for |
| | 16% radial expansion |
| | 38% increase for |
| | 24% radial expansion |

In an exemplary experimental embodiment, samples of expandable tubulars composed of Alloys A, B, C, and D exhibited the following tensile characteristics prior to radial expansion and plastic deformation:

| | | | Elonga- | | Absorbed | |
|---|---|---|---|---|---|---|
| Steel | Yield | Yield | tion | Aniso- | Energy | Expandability |
| Alloy | ksi | Ratio | % | tropy | ft-lb | Coefficient |
| A | 47.6 | 0.71 | 44 | 1.48 | 145 | |
| B | 57.8 | 0.71 | 44 | 1.04 | 62.2 | |
| C | 61.7 | 0.80 | 39 | 1.92 | 268 | |
| D | 48 | 0.55 | 56 | 1.34 | — | |

In an exemplary embodiment, one or more of the expandable tubular members, 12, 14, 24, 26, 102, 104, 106, 108, 202 and/or 204 have a strain hardening exponent greater than 0.12, and a yield ratio is less than 0.85.

In an exemplary embodiment, the carbon equivalent Ce, for tubular members having a carbon content (by weight percentage) less than or equal to 0.12%, is given by the following expression:
Cₑ=C+Mn/6+(Cr+Mo+V+Ti+Nb)/5+(Ni+Cu)/15

where Cₑ=carbon equivalent value;

b. C=carbon percentage by weight;

c. Mn=manganese percentage by weight;

d. Cr=chromium percentage by weight;

e. Mo=molybdenum percentage by weight;

f. V=vanadium percentage by weight;

g. Ti=titanium percentage by weight;

h. Nb=niobium percentage by weight;

i. Ni=nickel percentage by weight; and

j. Cu=copper percentage by weight.

In an exemplary embodiment, the carbon equivalent value Ce, for tubular members having a carbon content less than or equal to 0.12% (by weight), for one or more of the expandable tubular members, 12, 14, 24, 26, 102, 104, 106, 108, 202 and/or 204 is less than 0.21.

In an exemplary embodiment, the carbon equivalent Ce, for tubular members having more than 0.12% carbon content (by weight), is given by the following expression:
Cₑ=C+Si/30+(Mn+C+Cr)/20+Ni/60+Mo/15+V/10+5*B
where Cₑ=carbon equivalent value;

k. C=carbon percentage by weight;

l. Si=silicon percentage by weight;

m. Mn=manganese percentage by weight;

n. Cu=copper percentage by weight;

o. Cr=chromium percentage by weight;

p. Ni=nickel percentage by weight;

q. Mo=molybdenum percentage by weight;

r. V=vanadium percentage by weight; and

s. B=boron percentage by weight.

In an exemplary embodiment, the carbon equivalent value Ce, for tubular members having greater than 0.12% carbon content (by weight), for one or more of the expandable tubular members, 12, 14, 24, 26, 102, 104, 106, 108, 202 and/or 204 is less than 0.36.

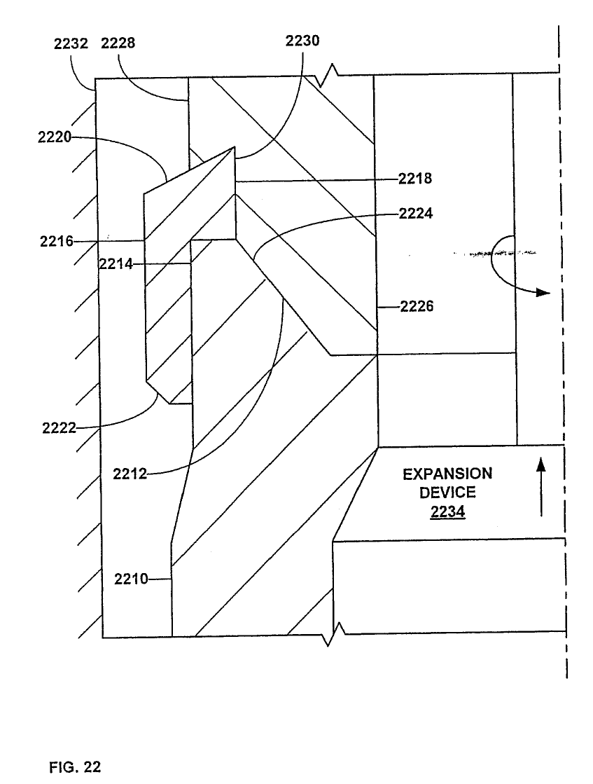

Referring to FIG. 22 in an exemplary embodiment, a first tubular member 2210 includes an internally threaded connection 2212 at an end portion 2214. A first end of a tubular sleeve 2216 that includes an internal flange 2218 having a tapered portion 2220, and a second end that includes a tapered portion 2222, is then mounted upon and receives the end portion 2214 of the first tubular member 2210. In an exemplary embodiment, the end portion 2214 of the first tubular member 2210 abuts one side of the internal flange 2218 of the tubular sleeve 2216, and the internal diameter of the internal flange 2218 of the tubular sleeve 2216 is substantially equal to or greater than the maximum internal diameter of the internally threaded connection 2212 of the end portion 2214 of the first tubular member 2210. An externally threaded connection 2224 of an end portion 2226 of a second tubular member 2228 having an annular recess 2230 is then positioned within the tubular sleeve 2216 and threadably coupled to the internally threaded connection 2212 of the end portion 2214 of the first tubular member 2210. In an exemplary embodiment, the internal flange 2218 of the tubular sleeve 2216 mates with and is received within the annular recess 2230 of the end portion 2226 of the second tubular member 2228. Thus, the tubular sleeve 2216 is coupled to and surrounds the external surfaces of the first and second tubular members, 2210 and 2228.

The internally threaded connection 2212 of the end portion 2214 of the first tubular member 2210 is a box connection, and the externally threaded connection 2224 of the end portion 2226 of the second tubular member 2228 is a pin connection. In an exemplary embodiment, the internal diameter of the tubular sleeve 2216 is at least approximately 0.020″ greater than the outside diameters of the first and second tubular members, 2210 and 2228. In this manner, during the threaded coupling of the first and second tubular members, 2210 and 2228, fluidic materials within the first and second tubular members may be vented from the tubular members.

As illustrated in FIG. 22, the first and second tubular members, 2210 and 2228, and the tubular sleeve 2216 may be positioned within another structure 2232 such as, for example, a cased or uncased wellbore, and radially expanded and plastically deformed, for example, by displacing and/or rotating a conventional expansion device 2234 within and/or through the interiors of the first and second tubular members. The tapered portions, 2220 and 2222, of the tubular sleeve 2216 facilitate the insertion and movement of the first and second tubular members within and through the structure 2232, and the movement of the expansion device 2234 through the interiors of the first and second tubular members, 2210 and 2228, may be, for example, from top to bottom or from bottom to top.

During the radial expansion and plastic deformation of the first and second tubular members, 2210 and 2228, the tubular sleeve 2216 is also radially expanded and plastically deformed. As a result, the tubular sleeve 2216 may be maintained in circumferential tension and the end portions, 2214 and 2226, of the first and second tubular members, 2210 and 2228, may be maintained in circumferential compression.

Sleeve 2216 increases the axial compression loading of the connection between tubular members 2210 and 2228 before and after expansion by the expansion device 2234. Sleeve 2216 may, for example, be secured to tubular members 2210 and 2228 by a heat shrink fit.

In several alternative embodiments, the first and second tubular members, 2210 and 2228, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 2216 during (a) the coupling of the first tubular member 2210 to the second tubular member 2228, (b) the placement of the first and second tubular members in the structure 2232, and (c) the radial expansion and plastic deformation of the first and second tubular members provides a number of significant benefits. For example, the tubular sleeve 2216 protects the exterior surfaces of the end portions, 2214 and 2226, of the first and second tubular members, 2210 and 2228, during handling and insertion of the tubular members within the structure 2232. In this manner, damage to the exterior surfaces of the end portions, 2214 and 2226, of the first and second tubular members, 2210 and 2228, is avoided that could otherwise result in stress concentrations that could cause a catastrophic failure during subsequent radial expansion operations. Furthermore, the tubular sleeve 2216 provides an alignment guide that facilitates the insertion and threaded coupling of the second tubular member 2228 to the first tubular member 2210. In this manner, misalignment that could result in damage to the threaded connections, 2212 and 2224, of the first and second tubular members, 2210 and 2228, may be avoided. In addition, during the relative rotation of the second tubular member with respect to the first tubular member, required during the threaded coupling of the first and second tubular members, the tubular sleeve 2216 provides an indication of to what degree the first and second tubular members are threadably coupled. For example, if the tubular sleeve 2216 can be easily rotated, that would indicate that the first and second tubular members, 2210 and 2228, are not fully threadably coupled and in intimate contact with the internal flange 2218 of the tubular sleeve. Furthermore, the tubular sleeve 2216 may prevent crack propagation during the radial expansion and plastic deformation of the first and second tubular members, 2210 and 2228. In this manner, failure modes such as, for example, longitudinal cracks in the end portions, 2214 and 2226, of the first and second tubular members may be limited in severity or eliminated all together. In addition, after completing the radial expansion and plastic deformation of the first and second tubular members, 2210 and 2228, the tubular sleeve 2216 may provide a fluid tight metal-to-metal seal between interior surface of the tubular sleeve 2216 and the exterior surfaces of the end portions, 2214 and 2226, of the first and second tubular members. In this manner, fluidic materials are prevented from passing through the threaded connections, 2212 and 2224, of the first and second tubular members, 2210 and 2228, into the annulus between the first and second tubular members and the structure 2232. Furthermore, because, following the radial expansion and plastic deformation of the first and second tubular members, 2210 and 2228, the tubular sleeve 2216 may be maintained in circumferential tension and the end portions, 2214 and 2226, of the first and second tubular members, 2210 and 2228, may be maintained in circumferential compression, axial loads and/or torque loads may be transmitted through the tubular sleeve.

In several exemplary embodiments, one or more portions of the first and second tubular members, 2210 and 2228, and the tubular sleeve 2216 have one or more of the material properties of one or more of the tubular members 12, 14, 24, 26, 102, 104, 106, 108, 202 and/or 204.

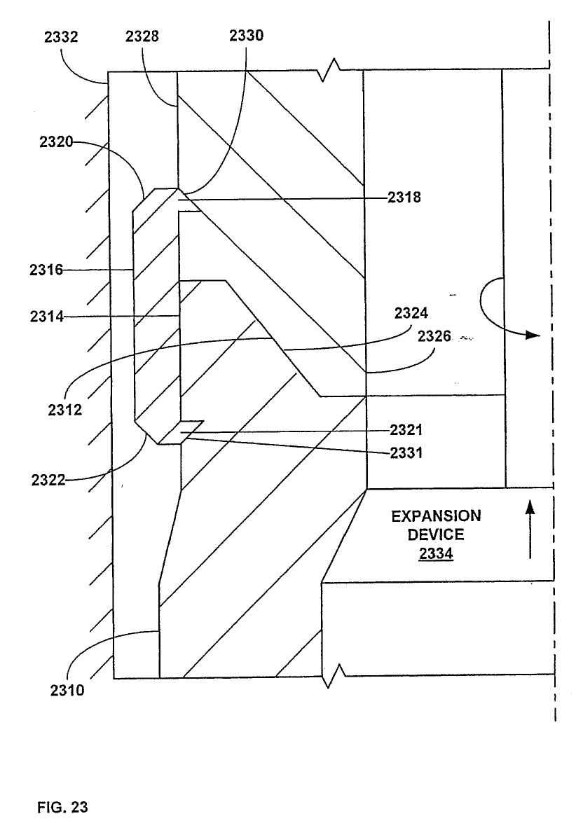

Referring to FIG. 23, in an exemplary embodiment, a first tubular member 210 includes an internally threaded connection 2312 at an end portion 2314. A first end of a tubular sleeve 2316 includes an internal flange 2318 and a tapered portion 2320. A second end of the sleeve 2316 includes an internal flange 2321 and a tapered portion 2322. An externally threaded connection 2324 of an end portion 2326 of a second tubular member 2328 having an annular recess 2330, is then positioned within the tubular sleeve 2316 and threadably coupled to the internally threaded connection 2312 of the end portion 2314 of the first tubular member 2310. The internal flange 2318 of the sleeve 2316 mates with and is received within the annular recess 2330.

The first tubular member 2310 includes a recess 2331. The internal flange 2321 mates with and is received within the annular recess 2331. Thus, the sleeve 2316 is coupled to and surrounds the external surfaces of the first and second tubular members 2310 and 2328.

The internally threaded connection 2312 of the end portion 2314 of the first tubular member 2310 is a box connection, and the externally threaded connection 2324 of the end portion 2326 of the second tubular member 2328 is a pin connection. In an exemplary embodiment, the internal diameter of the tubular sleeve 2316 is at least approximately 0.020″ greater than the outside diameters of the first and second tubular members 2310 and 2328. In this manner, during the threaded coupling of the first and second tubular members 2310 and 2328, fluidic materials within the first and second tubular members may be vented from the tubular members.

As illustrated in FIG. 23, the first and second tubular members 2310 and 2328, and the tubular sleeve 2316 may then be positioned within another structure 2332 such as, for example, a wellbore, and radially expanded and plastically deformed, for example, by displacing and/or rotating an expansion device 2334 through and/or within the interiors of the first and second tubular members. The tapered portions 2320 and 2322, of the tubular sleeve 2316 facilitates the insertion and movement of the first and second tubular members within and through the structure 2332, and the displacement of the expansion device 2334 through the interiors of the first and second tubular members 2310 and 2328, may be from top to bottom or from bottom to top.

During the radial expansion and plastic deformation of the first and second tubular members 2310 and 2328, the tubular sleeve 2316 is also radially expanded and plastically deformed. In an exemplary embodiment, as a result, the tubular sleeve 2316 may be maintained in circumferential tension and the end portions 2314 and 2326, of the first and second tubular members 2310 and 2328, may be maintained in circumferential compression.

Sleeve 2316 increases the axial tension loading of the connection between tubular members 2310 and 2328 before and after expansion by the expansion device 2334. Sleeve 2316 may be secured to tubular members 2310 and 2328 by a heat shrink fit.

In several exemplary embodiments, one or more portions of the first and second tubular members, 2310 and 2328, and the tubular sleeve 2316 have one or more of the material properties of one or more of the tubular members 12, 14, 24, 26, 102, 104, 106, 108, 202 and/or 204.

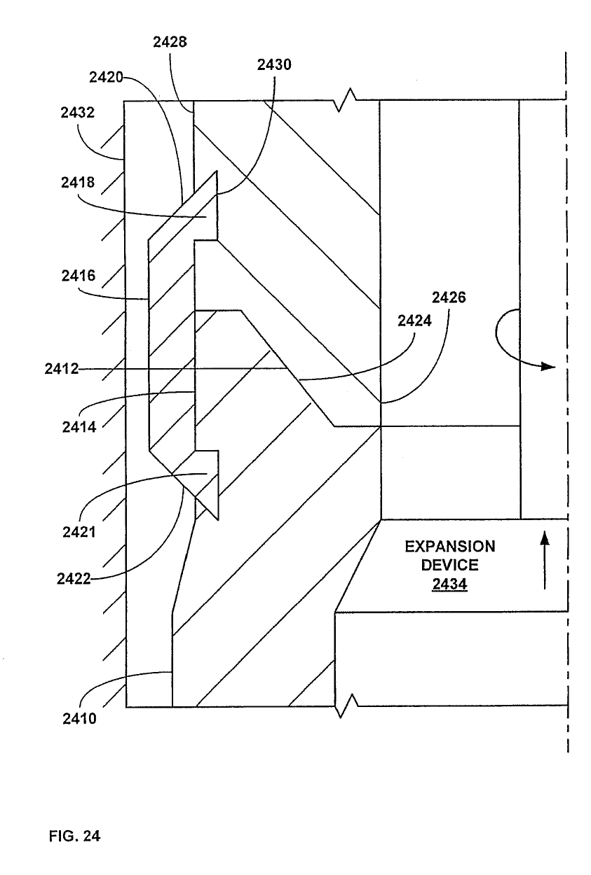

Referring to FIG. 24, in an exemplary embodiment, a first tubular member 2410 includes an internally threaded connection 2412 at an end portion 2414. A first end of a tubular sleeve 2416 includes an internal flange 2418 and a tapered portion 2420. A second end of the sleeve 2416 includes an internal flange 2421 and a tapered portion 2422. An externally threaded connection 2424 of an end portion 2426 of a second tubular member 2428 having an annular recess 2430, is then positioned within the tubular sleeve 2416 and threadably coupled to the internally threaded connection 2412 of the end portion 2414 of the first tubular member 2410. The internal flange 2418 of the sleeve 2416 mates with and is received within the annular recess 2430. The first tubular member 2410 includes a recess 2431. The internal flange 2421 mates with and is received within the annular recess 2431. Thus, the sleeve 2416 is coupled to and surrounds the external surfaces of the first and second tubular members 2410 and 2428.

The internally threaded connection 2412 of the end portion 2414 of the first tubular member 2410 is a box connection, and the externally threaded connection 2424 of the end portion 2426 of the second tubular member 2428 is a pin connection. In an exemplary embodiment, the internal diameter of the tubular sleeve 2416 is at least approximately 0.020″ greater than the outside diameters of the first and second tubular members 2410 and 2428. In this manner, during the threaded coupling of the first and second tubular members 2410 and 2428, fluidic materials within the first and second tubular members may be vented from the tubular members.

As illustrated in FIG. 24, the first and second tubular members 2410 and 2428, and the tubular sleeve 2416 may then be positioned within another structure 2432 such as, for example, a wellbore, and radially expanded and plastically deformed, for example, by displacing and/or rotating an expansion device 2434 through and/or within the interiors of the first and second tubular members. The tapered portions 2420 and 2422, of the tubular sleeve 2416 facilitate the insertion and movement of the first and second tubular members within and through the structure 2432, and the displacement of the expansion device 2434 through the interiors of the first and second tubular members, 2410 and 2428, may be from top to bottom or from bottom to top.

During the radial expansion and plastic deformation of the first and second tubular members, 2410 and 2428, the tubular sleeve 2416 is also radially expanded and plastically deformed. In an exemplary embodiment, as a result, the tubular sleeve 2416 may be maintained in circumferential tension and the end portions, 2414 and 2426, of the first and second tubular members, 2410 and 2428, may be maintained in circumferential compression.

The sleeve 2416 increases the axial compression and tension loading of the connection between tubular members 2410 and 2428 before and after expansion by expansion device 2424. Sleeve 2416 may be secured to tubular members 2410 and 2428 by a heat shrink fit.

In several exemplary embodiments, one or more portions of the first and second tubular members, 2410 and 2428, and the tubular sleeve 2416 have one or more of the material properties of one or more of the tubular members 12, 14, 24, 26, 102, 104, 106, 108, 202 and/or 204.

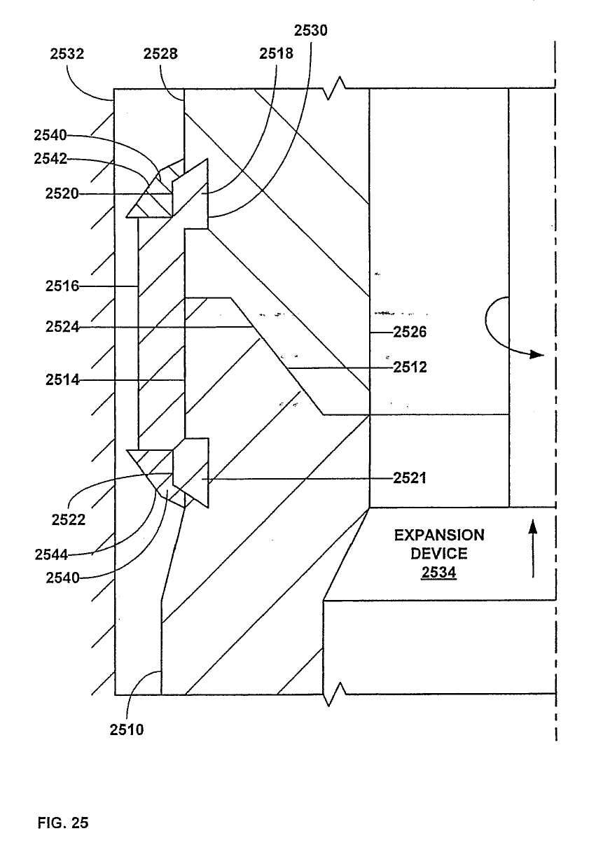

Referring to FIG. 25, in an exemplary embodiment, a first tubular member 2510 includes an internally threaded connection 2512 at an end portion 2514. A first end of a tubular sleeve 2516 includes an internal flange 2518 and a relief 2520. A second end of the sleeve 2516 includes an internal flange 2521 and a relief 2522. An externally threaded connection 2524 of an end portion 2526 of a second tubular member 2528 having an annular recess 2530, is then positioned within the tubular sleeve 2516 and threadably coupled to the internally threaded connection 2512 of the end portion 2514 of the first tubular member 2510. The internal flange 2518 of the sleeve 2516 mates with and is received within the annular recess 2530. The first tubular member 2510 includes a recess 2531. The internal flange 2521 mates with and is received within the annular recess 2531. Thus, the sleeve 2516 is coupled to and surrounds the external surfaces of the first and second tubular members 2510 and 2528.

The internally threaded connection 2512 of the end portion 2514 of the first tubular member 2510 is a box connection, and the externally threaded connection 2524 of the end portion 2526 of the second tubular member 2528 is a pin connection. In an exemplary embodiment, the internal diameter of the tubular sleeve 2516 is at least approximately 0.020″ greater than the outside diameters of the first and second tubular members 2510 and 2528. In this manner, during the threaded coupling of the first and second tubular members 2510 and 2528, fluidic materials within the first and second tubular members may be vented from the tubular members.

As illustrated in FIG. 25, the first and second tubular members 2510 and 2528, and the tubular sleeve 2516 may then be positioned within another structure 2532 such as, for example, a wellbore, and radially expanded and plastically deformed, for example, by displacing and/or rotating an expansion device 2534 through and/or within the interiors of the first and second tubular members. The reliefs 2520 and 2522 are each filled with a sacrificial material 2540 including a tapered surface 2542 and 2544, respectively. The material 2540 may be a metal or a synthetic, and is provided to facilitate the insertion and movement of the first and second tubular members 2510 and 2528, through the structure 2532. The displacement of the expansion device 2534 through the interiors of the first and second tubular members 2510 and 2528, may, for example, be from top to bottom or from bottom to top.

During the radial expansion and plastic deformation of the first and second tubular members 2510 and 2528, the tubular sleeve 2516 is also radially expanded and plastically deformed. In an exemplary embodiment, as a result, the tubular sleeve 2516 may be maintained in circumferential tension and the end portions 2514 and 2526, of the first and second tubular members, 2510 and 2528, may be maintained in circumferential compression.

The addition of the sacrificial material 2540, provided on sleeve 2516, avoids stress risers on the sleeve 2516 and the tubular member 2510. The tapered surfaces 2542 and 2544 are intended to wear or even become damaged, thus incurring such wear or damage which would otherwise be borne by sleeve 2516. Sleeve 2516 may be secured to tubular members 2510 and 2528 by a heat shrink fit.

In several exemplary embodiments, one or more portions of the first and second tubular members, 2510 and 2528, and the tubular sleeve 2516 have one or more of the material properties of one or more of the tubular members 12, 14, 24, 26, 102, 104, 106, 108, 202 and/or 204.

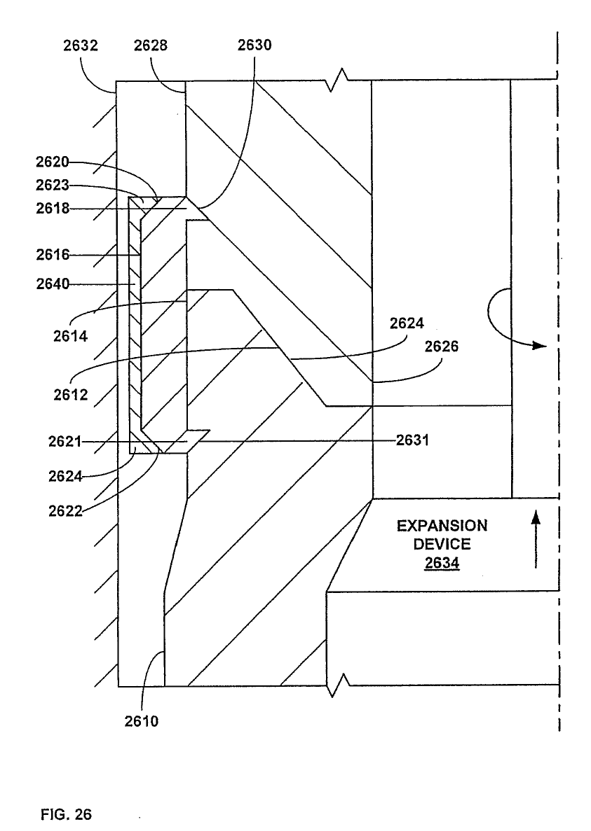

Referring to FIG. 26, in an exemplary embodiment, a first tubular member 2610 includes an internally threaded connection 2612 at an end portion 2614. A first end of a tubular sleeve 2616 includes an internal flange 2618 and a tapered portion 2620. A second end of the sleeve 2616 includes an internal flange 2621 and a tapered portion 2622. An externally threaded connection 2624 of an end portion 2626 of a second tubular member 2628 having an annular recess 2630, is then positioned within the tubular sleeve 2616 and threadably coupled to the internally threaded connection 2612 of the end portion 2614 of the first tubular member 2610. The internal flange 2618 of the sleeve 2616 mates with and is received within the annular recess 2630.

The first tubular member 2610 includes a recess 2631. The internal flange 2621 mates with and is received within the annular recess 2631. Thus, the sleeve 2616 is coupled to and surrounds the external surfaces of the first and second tubular members 2610 and 2628.

The internally threaded connection 2612 of the end portion 2614 of the first tubular member 2610 is a box connection, and the externally threaded connection 2624 of the end portion 2626 of the second tubular member 2628 is a pin connection. In an exemplary embodiment, the internal diameter of the tubular sleeve 2616 is at least approximately 0.020″ greater than the outside diameters of the first and second tubular members 2610 and 2628. In this manner, during the threaded coupling of the first and second tubular members 2610 and 2628, fluidic materials within the first and second tubular members may be vented from the tubular members.

As illustrated in FIG. 26, the first and second tubular members 2610 and 2628, and the tubular sleeve 2616 may then be positioned within another structure 2632 such as, for example, a wellbore, and radially expanded and plastically deformed, for example, by displacing and/or rotating an expansion device 2634 through and/or within the interiors of the first and second tubular members. The tapered portions 2620 and 2622, of the tubular sleeve 2616 facilitates the insertion and movement of the first and second tubular members within and through the structure 2632, and the displacement of the expansion device 2634 through the interiors of the first and second tubular members 2610 and 2628, may, for example, be from top to bottom or from bottom to top.

During the radial expansion and plastic deformation of the first and second tubular members 2610 and 2628, the tubular sleeve 2616 is also radially expanded and plastically deformed. In an exemplary embodiment, as a result, the tubular sleeve 2616 may be maintained in circumferential tension and the end portions 2614 and 2626, of the first and second tubular members 2610 and 2628, may be maintained in circumferential compression.

Sleeve 2616 is covered by a thin walled cylinder of sacrificial material 2640. Spaces 2623 and 2624, adjacent tapered portions 2620 and 2622, respectively, are also filled with an excess of the sacrificial material 2640. The material may be a metal or a synthetic, and is provided to facilitate the insertion and movement of the first and second tubular members 2610 and 2628, through the structure 2632.

The addition of the sacrificial material 2640, provided on sleeve 2616, avoids stress risers on the sleeve 2616 and the tubular member 2610. The excess of the sacrificial material 2640 adjacent tapered portions 2620 and 2622 are intended to wear or even become damaged, thus incurring such wear or damage which would otherwise be borne by sleeve 2616. Sleeve 2616 may be secured to tubular members 2610 and 2628 by a heat shrink fit.

In several exemplary embodiments, one or more portions of the first and second tubular members, 2610 and 2628, and the tubular sleeve 2616 have one or more of the material properties of one or more of the tubular members 12, 14, 24, 26, 102, 104, 106, 108, 202 and/or 204.

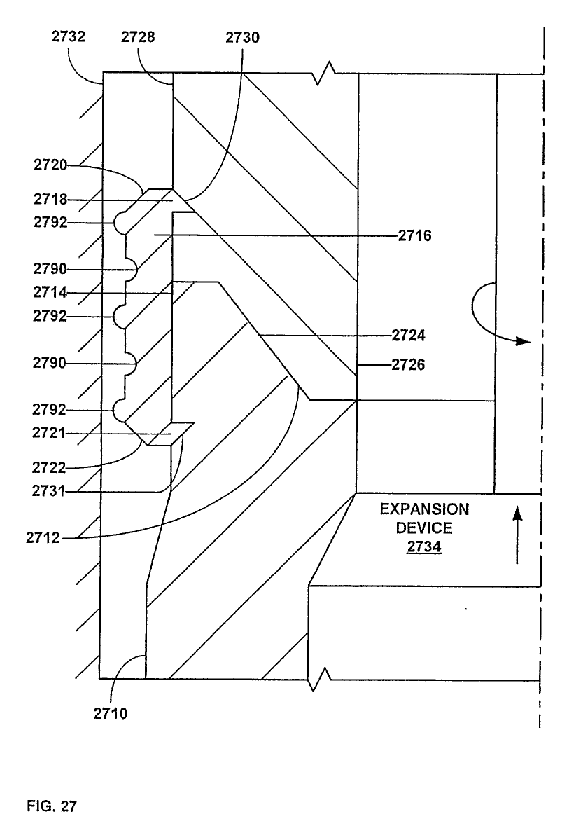

Referring to FIG. 27, in an exemplary embodiment, a first tubular member 2710 includes an internally threaded connection 2712 at an end portion 2714. A first end of a tubular sleeve 2716 includes an internal flange 2718 and a tapered portion 2720. A second end of the sleeve 2716 includes an internal flange 2721 and a tapered portion 2722. An externally threaded connection 2724 of an end portion 2726 of a second tubular member 2728 having an annular recess 2730, is then positioned within the tubular sleeve 2716 and threadably coupled to the internally threaded connection 2712 of the end portion 2714 of the first tubular member 2710. The internal flange 2718 of the sleeve 2716 mates with and is received within the annular recess 2730.

The first tubular member 2710 includes a recess 2731. The internal flange 2721 mates with and is received within the annular recess 2731. Thus, the sleeve 2716 is coupled to and surrounds the external surfaces of the first and second tubular members 2710 and 2728.

The internally threaded connection 2712 of the end portion 2714 of the first tubular member 2710 is a box connection, and the externally threaded connection 2724 of the end portion 2726 of the second tubular member 2728 is a pin connection. In an exemplary embodiment, the internal diameter of the tubular sleeve 2716 is at least approximately 0.020″ greater than the outside diameters of the first and second tubular members 2710 and 2728. In this manner, during the threaded coupling of the first and second tubular members 2710 and 2728, fluidic materials within the first and second tubular members may be vented from the tubular members.

As illustrated in FIG. 27, the first and second tubular members 2710 and 2728, and the tubular sleeve 2716 may then be positioned within another structure 2732 such as, for example, a wellbore, and radially expanded and plastically deformed, for example, by displacing and/or rotating an expansion device 2734 through and/or within the interiors of the first and second tubular members. The tapered portions 2720 and 2722, of the tubular sleeve 2716 facilitates the insertion and movement of the first and second tubular members within and through the structure 2732, and the displacement of the expansion device 2734 through the interiors of the first and second tubular members 2710 and 2728, may be from top to bottom or from bottom to top.

During the radial expansion and plastic deformation of the first and second tubular members 2710 and 2728, the tubular sleeve 2716 is also radially expanded and plastically deformed. In an exemplary embodiment, as a result, the tubular sleeve 2716 may be maintained in circumferential tension and the end portions 2714 and 2726, of the first and second tubular members 2710 and 2728, may be maintained in circumferential compression.

Sleeve 2716 has a variable thickness due to one or more reduced thickness portions 2790 and/or increased thickness portions 2792.

Varying the thickness of sleeve 2716 provides the ability to control or induce stresses at selected positions along the length of sleeve 2716 and the end portions 2724 and 2726. Sleeve 2716 may be secured to tubular members 2710 and 2728 by a heat shrink fit.

In several exemplary embodiments, one or more portions of the first and second tubular members, 2710 and 2728, and the tubular sleeve 2716 have one or more of the material properties of one or more of the tubular members 12, 14, 24, 26, 102, 104, 106, 108, 202 and/or 204.

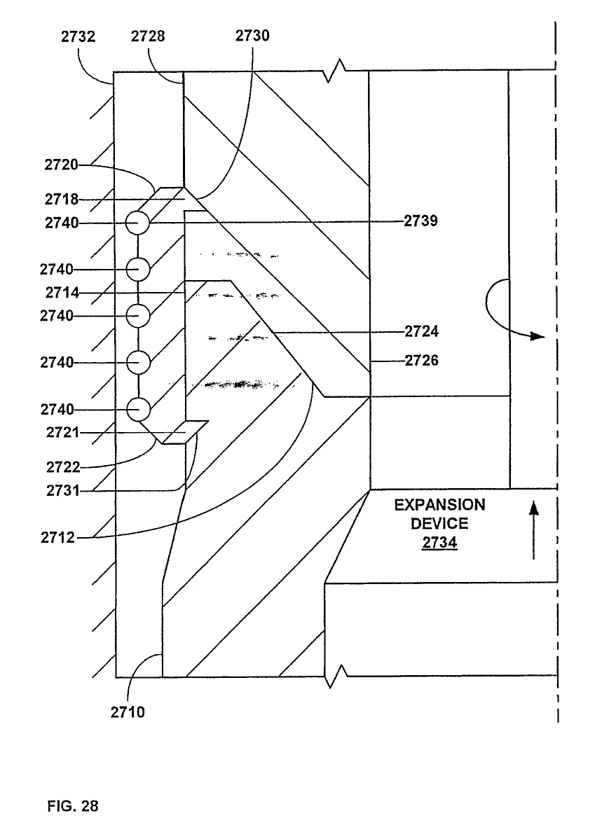

Referring to FIG. 28, in an alternative embodiment, instead of varying the thickness of sleeve 2716, the same result described above with reference to FIG. 27, may be achieved by adding a member 2740 which may be coiled onto the grooves 2739 formed in sleeve 2716, thus varying the thickness along the length of sleeve 2716.

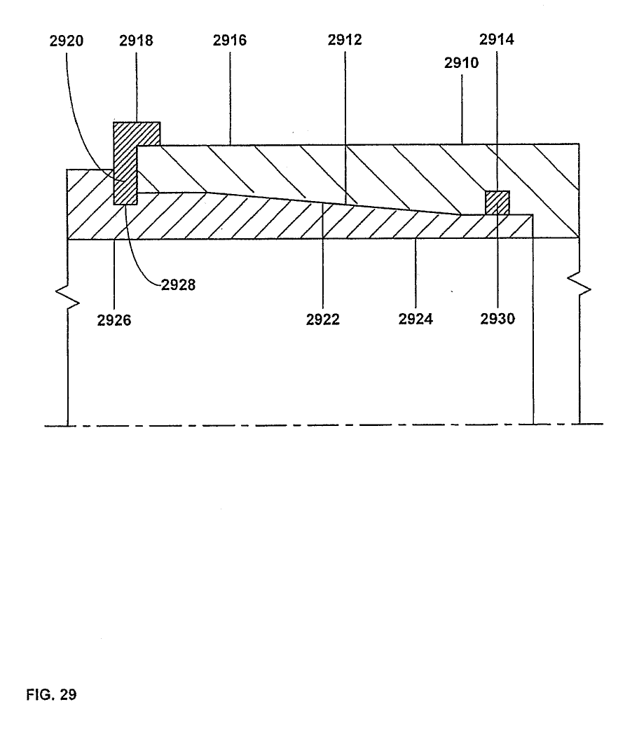

Referring to FIG. 29, in an exemplary embodiment, a first tubular member 2910 includes an internally threaded connection 2912 and an internal annular recess 2914 at an end portion 2916. A first end of a tubular sleeve 2918 includes an internal flange 2920, and a second end of the sleeve 2916 mates with and receives the end portion 2916 of the first tubular member 2910. An externally threaded connection 2922 of an end portion 2924 of a second tubular member 2926 having an annular recess 2928, is then positioned within the tubular sleeve 2918 and threadably coupled to the internally threaded connection 2912 of the end portion 2916 of the first tubular member 2910. The internal flange 2920 of the sleeve 2918 mates with and is received within the annular recess 2928. A sealing element 2930 is received within the internal annular recess 2914 of the end portion 2916 of the first tubular member 2910.

The internally threaded connection 2912 of the end portion 2916 of the first tubular member 2910 is a box connection, and the externally threaded connection 2922 of the end portion 2924 of the second tubular member 2926 is a pin connection. In an exemplary embodiment, the internal diameter of the tubular sleeve 2918 is at least approximately 0.020″ greater than the outside diameters of the first tubular member 2910. In this manner, during the threaded coupling of the first and second tubular members 2910 and 2926, fluidic materials within the first and second tubular members may be vented from the tubular members.

The first and second tubular members 2910 and 2926, and the tubular sleeve 2918 may be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 2910 and 2926, the tubular sleeve 2918 is also radially expanded and plastically deformed. In an exemplary embodiment, as a result, the tubular sleeve 2918 may be maintained in circumferential tension and the end portions 2916 and 2924, of the first and second tubular members 2910 and 2926, respectively, may be maintained in circumferential compression.

In an exemplary embodiment, before, during, and after the radial expansion and plastic deformation of the first and second tubular members 2910 and 2926, and the tubular sleeve 2918, the sealing element 2930 seals the interface between the first and second tubular members. In an exemplary embodiment, during and after the radial expansion and plastic deformation of the first and second tubular members 2910 and 2926, and the tubular sleeve 2918, a metal to metal seal is formed between at least one of: the first and second tubular members 2910 and 2926, the first tubular member and the tubular sleeve 2918, and/or the second tubular member and the tubular sleeve. In an exemplary embodiment, the metal to metal seal is both fluid tight and gas tight.

In several exemplary embodiments, one or more portions of the first and second tubular members, 2910 and 2926, the tubular sleeve 2918, and the sealing element 2930 have one or more of the material properties of one or more of the tubular members 12, 14, 24, 26, 102, 104, 106, 108, 202 and/or 204.

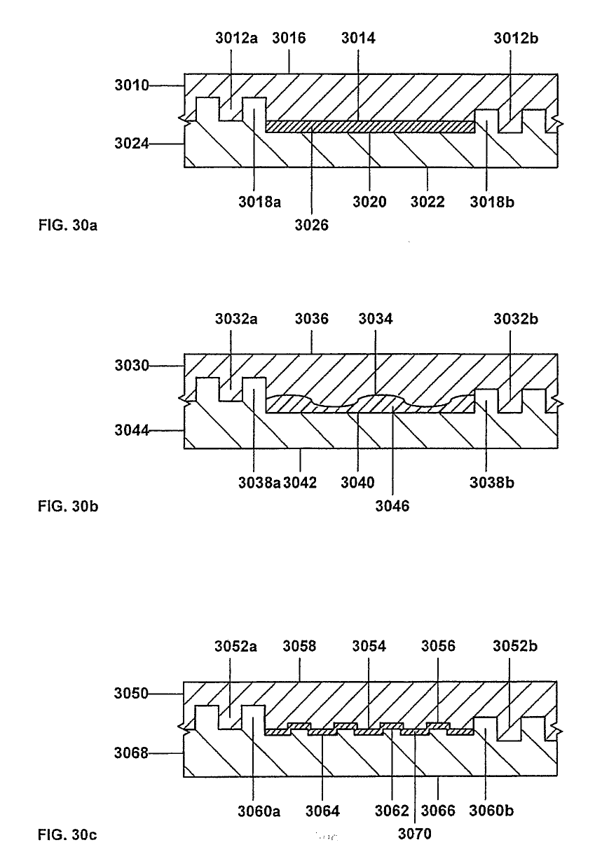

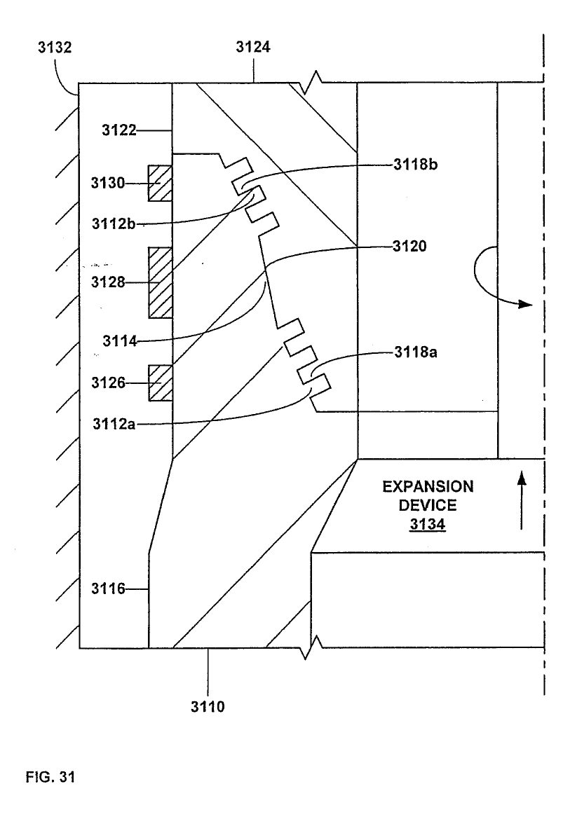

Referring to FIG. 30a, in an exemplary embodiment, a first tubular member 3010 includes internally threaded connections 3012a and 3012b, spaced apart by a cylindrical internal surface 3014, at an end portion 3016. Externally threaded connections 3018a and 3018b, spaced apart by a cylindrical external surface 3020, of an end portion 3022 of a second tubular member 3024 are threadably coupled to the internally threaded connections, 3012a and 3012b, respectively, of the end portion 3016 of the first tubular member 3010. A sealing element 3026 is received within an annulus defined between the internal cylindrical surface 3014 of the first tubular member 3010 and the external cylindrical surface 3020 of the second tubular member 3024.

The internally threaded connections, 3012a and 3012b, of the end portion 3016 of the first tubular member 3010 are box connections, and the externally threaded connections, 3018a and 3018b, of the end portion 3022 of the second tubular member 3024 are pin connections. In an exemplary embodiment, the sealing element 3026 is an elastomeric and/or metallic sealing element.

The first and second tubular members 3010 and 3024 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3010 and 3024, the sealing element 3026 seals the interface between the first and second tubular members. In an exemplary embodiment, before, during and/or after the radial expansion and plastic deformation of the first and second tubular members 3010 and 3024, a metal to metal seal is formed between at least one of: the first and second tubular members 3010 and 3024, the first tubular member and the sealing element 3026, and/or the second tubular member and the sealing element. In an exemplary embodiment, the metal to metal seal is both fluid tight and gas tight.

In an alternative embodiment, the sealing element 3026 is omitted, and during and/or after the radial expansion and plastic deformation of the first and second tubular members 3010 and 3024, a metal to metal seal is formed between the first and second tubular members.

In several exemplary embodiments, one or more portions of the first and second tubular members, 3010 and 3024, the sealing element 3026 have one or more of the material properties of one or more of the tubular members 12,14, 24, 26,102,104,106, 108, 202 and/or 204.

Referring to FIG. 30b, in an exemplary embodiment, a first tubular member 3030 includes internally threaded connections 3032a and 3032b, spaced apart by an undulating approximately cylindrical internal surface 3034, at an end portion 3036. Externally threaded connections 3038a and 3038b, spaced apart by a cylindrical external surface 3040, of an end portion 3042 of a second tubular member 3044 are threadably coupled to the internally threaded connections, 3032a and 3032b, respectively, of the end portion 3036 of the first tubular member 3030. A sealing element 3046 is received within an annulus defined between the undulating approximately cylindrical internal surface 3034 of the first tubular member 3030 and the external cylindrical surface 3040 of the second tubular member 3044.

The internally threaded connections, 3032a and 3032b, of the end portion 3036 of the first tubular member 3030 are box connections, and the externally threaded connections, 3038a and 3038b, of the end portion 3042 of the second tubular member 3044 are pin connections. In an exemplary embodiment, the sealing element 3046 is an elastomeric and/or metallic sealing element.

The first and second tubular members 3030 and 3044 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3030 and 3044, the sealing element 3046 seals the interface between the first and second tubular members. In an exemplary embodiment, before, during and/or after the radial expansion and plastic deformation of the first and second tubular members 3030 and 3044, a metal to metal seal is formed between at least one of: the first and second tubular members 3030 and 3044, the first tubular member and the sealing element 3046, and/or the second tubular member and the sealing element. In an exemplary embodiment, the metal to metal seal is both fluid tight and gas tight.

In an alternative embodiment, the sealing element 3046 is omitted, and during and/or after the radial expansion and plastic deformation of the first and second tubular members 3030 and 3044, a metal to metal seal is formed between the first and second tubular members.

In several exemplary embodiments, one or more portions of the first and second tubular members, 3030 and 3044, the sealing element 3046 have one or more of the material properties of one or more of the tubular members 12, 14, 24, 26, 102, 104, 106, 108, 202 and/or 204.

Referring to FIG. 30c, in an exemplary embodiment, a first tubular member 3050 includes internally threaded connections 3052a and 3052b, spaced apart by a cylindrical internal surface 3054 including one or more square grooves 3056, at an end portion 3058. Externally threaded connections 3060a and 3060b, spaced apart by a cylindrical external surface 3062 including one or more square grooves 3064, of an end portion 3066 of a second tubular member 3068 are threadably coupled to the internally threaded connections, 3052a and 3052b, respectively, of the end portion 3058 of the first tubular member 3050. A sealing element 3070 is received within an annulus defined between the cylindrical internal surface 3054 of the first tubular member 3050 and the external cylindrical surface 3062 of the second tubular member 3068.

The internally threaded connections, 3052a and 3052b, of the end portion 3058 of the first tubular member 3050 are box connections, and the externally threaded connections, 3060a and 3060b, of the end portion 3066 of the second tubular member 3068 are pin connections. In an exemplary embodiment, the sealing element 3070 is an elastomeric and/or metallic sealing element.

The first and second tubular members 3050 and 3068 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3050 and 3068, the sealing element 3070 seals the interface between the first and second tubular members. In an exemplary embodiment, before, during and/or after the radial expansion and plastic deformation of the first and second tubular members, 3050 and 3068, a metal to metal seal is formed between at least one of: the first and second tubular members, the first tubular member and the sealing element 3070, and/or the second tubular member and the sealing element. In an exemplary embodiment, the metal to metal seal is both fluid tight and gas tight.

In an alternative embodiment, the sealing element 3070 is omitted, and during and/or after the radial expansion and plastic deformation of the first and second tubular members 950 and 968, a metal to metal seal is formed between the first and second tubular members.

In several exemplary embodiments, one or more portions of the first and second tubular members, 3050 and 3068, the sealing element 3070 have one or more of the material properties of one or more of the tubular members 12, 14, 24, 26, 102, 104, 106, 108, 202 and/or 204.

Referring to FIG. 31, in an exemplary embodiment, a first tubular member 3110 includes internally threaded connections, 3112a and 3112b, spaced apart by a non-threaded internal surface 3114, at an end portion 3116. Externally threaded connections, 3118a and 3118b, spaced apart by a non-threaded external surface 3120, of an end portion 3122 of a second tubular member 3124 are threadably coupled to the internally threaded connections, 3112a and 3112b, respectively, of the end portion 3122 of the first tubular member 3124.

First, second, and/or third tubular sleeves, 3126, 3128, and 3130, are coupled the external surface of the first tubular member 3110 in opposing relation to the threaded connection formed by the internal and external threads, 3112a and 3118a, the interface between the non-threaded surfaces, 3114 and 3120, and the threaded connection formed by the internal and external threads, 3112b and 3118b, respectively.

The internally threaded connections, 3112a and 3112b, of the end portion 3116 of the first tubular member 3110 are box connections, and the externally threaded connections, 3118a and 3118b, of the end portion 3122 of the second tubular member 3124 are pin connections.

The first and second tubular members 3110 and 3124, and the tubular sleeves 3126, 3128, and/or 3130, may then be positioned within another structure 3132 such as, for example, a wellbore, and radially expanded and plastically deformed, for example, by displacing and/or rotating an expansion device 3134 through and/or within the interiors of the first and second tubular members.

During the radial expansion and plastic deformation of the first and second tubular members 3110 and 3124, the tubular sleeves 3126, 3128 and/or 3130 are also radially expanded and plastically deformed. In an exemplary embodiment, as a result, the tubular sleeves 3126, 3128, and/or 3130 are maintained in circumferential tension and the end portions 3116 and 3122, of the first and second tubular members 3110 and 3124, may be maintained in circumferential compression.

The sleeves 3126, 3128, and/or 3130 may, for example, be secured to the first tubular member 3110 by a heat shrink fit.

In several exemplary embodiments, one or more portions of the first and second tubular members, 3110 and 3124, and the sleeves, 3126, 3128, and 3130, have one or more of the material properties of one or more of the tubular members 12, 14, 24, 26, 102, 104, 106, 108, 202 and/or 204.

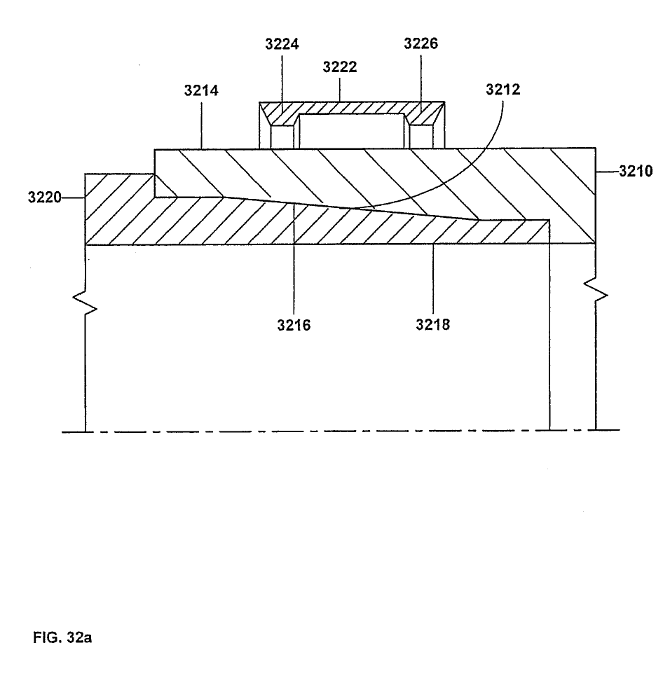

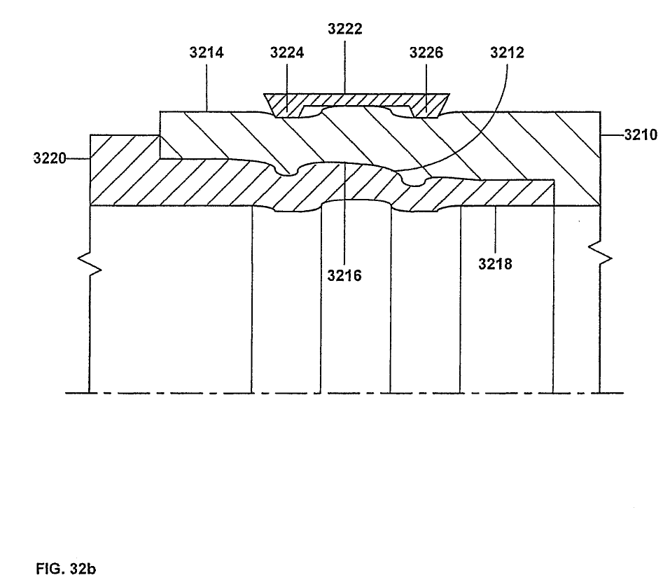

Referring to FIG. 32a, in an exemplary embodiment, a first tubular member 3210 includes an internally threaded connection 3212 at an end portion 3214. An externally threaded connection 3216 of an end portion 3218 of a second tubular member 3220 are threadably coupled to the internally threaded connection 3212 of the end portion 3214 of the first tubular member 3210.

The internally threaded connection 3212 of the end portion 3214 of the first tubular member 3210 is a box connection, and the externally threaded connection 3216 of the end portion 3218 of the second tubular member 3220 is a pin connection.

A tubular sleeve 3222 including internal flanges 3224 and 3226 is positioned proximate and surrounding the end portion 3214 of the first tubular member 3210. As illustrated in FIG. 32b, the tubular sleeve 3222 is then forced into engagement with the external surface of the end portion 3214 of the first tubular member 3210 in a conventional manner. As a result, the end portions, 3214 and 3218, of the first and second tubular members, 3210 and 3220, are upset in an undulating fashion.

The first and second tubular members 3210 and 3220, and the tubular sleeve 3222, may then be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 3210 and 3220, the tubular sleeve 3222 is also radially expanded and plastically deformed. In an exemplary embodiment, as a result, the tubular sleeve 3222 is maintained in circumferential tension and the end portions 3214 and 3218, of the first and second tubular members 3210 and 3220, may be maintained in circumferential compression.

In several exemplary embodiments, one or more portions of the first and second tubular members, 3210 and 3220, and the sleeve 3222 have one or more of the material properties of one or more of the tubular members 12, 14, 24, 26, 102, 104,106,108, 202 and/or 204.

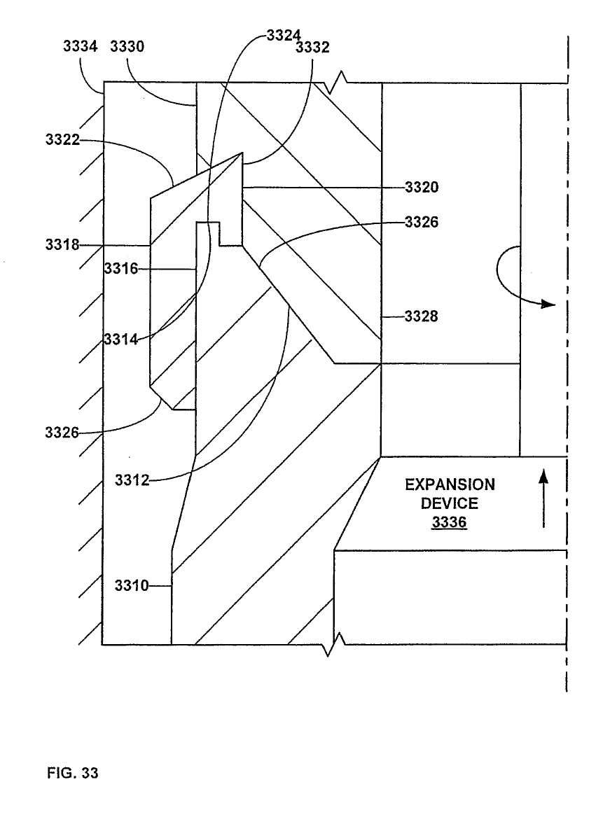

Referring to FIG. 33, in an exemplary embodiment, a first tubular member 3310 includes an internally threaded connection 3312 and an annular projection 3314 at an end portion 3316.

A first end of a tubular sleeve 3318 that includes an internal flange 3320 having a tapered portion 3322 and an annular recess 3324 for receiving the annular projection 3314 of the first tubular member 3310, and a second end that includes a tapered portion 3326, is then mounted upon and receives the end portion 3316 of the first tubular member 3310.

In an exemplary embodiment, the end portion 3316 of the first tubular member 3310 abuts one side of the internal flange 3320 of the tubular sleeve 3318 and the annular projection 3314 of the end portion of the first tubular member mates with and is received within the annular recess 3324 of the internal flange of the tubular sleeve, and the internal diameter of the internal flange 3320 of the tubular sleeve 3318 is substantially equal to or greater than the maximum internal diameter of the internally threaded connection 3312 of the end portion 3316 of the first tubular member 3310. An externally threaded connection 3326 of an end portion 3328 of a second tubular member 3330 having an annular recess 3332 is then positioned within the tubular sleeve 3318 and threadably coupled to the internally threaded connection 3312 of the end portion 3316 of the first tubular member 3310. In an exemplary embodiment, the internal flange 3332 of the tubular sleeve 3318 mates with and is received within the annular recess 3332 of the end portion 3328 of the second tubular member 3330. Thus, the tubular sleeve 3318 is coupled to and surrounds the external surfaces of the first and second tubular members, 3310 and 3328.

The internally threaded connection 3312 of the end portion 3316 of the first tubular member 3310 is a box connection, and the externally threaded connection 3326 of the end portion 3328 of the second tubular member 3330 is a pin connection. In an exemplary embodiment, the internal diameter of the tubular sleeve 3318 is at least approximately 0.020″ greater than the outside diameters of the first and second tubular members, 3310 and 3330. In this manner, during the threaded coupling of the first and second tubular members, 3310 and 3330, fluidic materials within the first and second tubular members may be vented from the tubular members.

As illustrated in FIG. 33, the first and second tubular members, 3310 and 3330, and the tubular sleeve 3318 may be positioned within another structure 3334 such as, for example, a cased or uncased wellbore, and radially expanded and plastically deformed, for example, by displacing and/or rotating a conventional expansion device 3336 within and/or through the interiors of the first and second tubular members. The tapered portions, 3322 and 3326, of the tubular sleeve 3318 facilitate the insertion and movement of the first and second tubular members within and through the structure 3334, and the movement of the expansion device 3336 through the interiors of the first and second tubular members, 3310 and 3330, may, for example, be from top to bottom or from bottom to top.

During the radial expansion and plastic deformation of the first and second tubular members, 3310 and 3330, the tubular sleeve 3318 is also radially expanded and plastically deformed. As a result, the tubular sleeve 3318 may be maintained in circumferential tension and the end portions, 3316 and 3328, of the first and second tubular members, 3310 and 3330, may be maintained in circumferential compression.

Sleeve 3316 increases the axial compression loading of the connection between tubular members 3310 and 3330 before and after expansion by the expansion device 3336. Sleeve 3316 may be secured to tubular members 3310 and 3330, for example, by a heat shrink fit.

In several alternative embodiments, the first and second tubular members, 3310 and 3330, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 3318 during (a) the coupling of the first tubular member 3310 to the second tubular member 3330, (b) the placement of the first and second tubular members in the structure 3334, and (c) the radial expansion and plastic deformation of the first and second tubular members provides a number of significant benefits. For example, the tubular sleeve 3318 protects the exterior surfaces of the end portions, 3316 and 3328, of the first and second tubular members, 3310 and 3330, during handling and insertion of the tubular members within the structure 3334. In this manner, damage to the exterior surfaces of the end portions, 3316 and 3328, of the first and second tubular members, 3310 and 3330, is avoided that could otherwise result in stress concentrations that could cause a catastrophic failure during subsequent radial expansion operations. Furthermore, the tubular sleeve 3318 provides an alignment guide that facilitates the insertion and threaded coupling of the second tubular member 3330 to the first tubular member 3310. In this manner, misalignment that could result in damage to the threaded connections, 3312 and 3326, of the first and second tubular members, 3310 and 3330, may be avoided. In addition, during the relative rotation of the second tubular member with respect to the first tubular member, required during the threaded coupling of the first and second tubular members, the tubular sleeve 3318 provides an indication of to what degree the first and second tubular members are threadably coupled. For example, if the tubular sleeve 3318 can be easily rotated, that would indicate that the first and second tubular members, 3310 and 3330, are not fully threadably coupled and in intimate contact with the internal flange 3320 of the tubular sleeve. Furthermore, the tubular sleeve 3318 may prevent crack propagation during the radial expansion and plastic deformation of the first and second tubular members, 3310 and 3330. In this manner, failure modes such as, for example, longitudinal cracks in the end portions, 3316 and 3328, of the first and second tubular members may be limited in severity or eliminated all together. In addition, after completing the radial expansion and plastic deformation of the first and second tubular members, 3310 and 3330, the tubular sleeve 3318 may provide a fluid tight metal-to-metal seal between interior surface of the tubular sleeve 3318 and the exterior surfaces of the end portions, 3316 and 3328, of the first and second tubular members. In this manner, fluidic materials are prevented from passing through the threaded connections, 3312 and 3326, of the first and second tubular members, 3310 and 3330, into the annulus between the first and second tubular members and the structure 3334. Furthermore, because, following the radial expansion and plastic deformation of the first and second tubular members, 3310 and 3330, the tubular sleeve 3318 may be maintained in circumferential tension and the end portions, 3316 and 3328, of the first and second tubular members, 3310 and 3330, may be maintained in circumferential compression, axial loads and/or torque loads may be transmitted through the tubular sleeve.

In several exemplary embodiments, one or more portions of the first and second tubular members, 3310 and 3330, and the sleeve 3318 have one or more of the material properties of one or more of the tubular members 12, 14, 24, 26, 102, 104, 106, 108, 202 and/or 204.

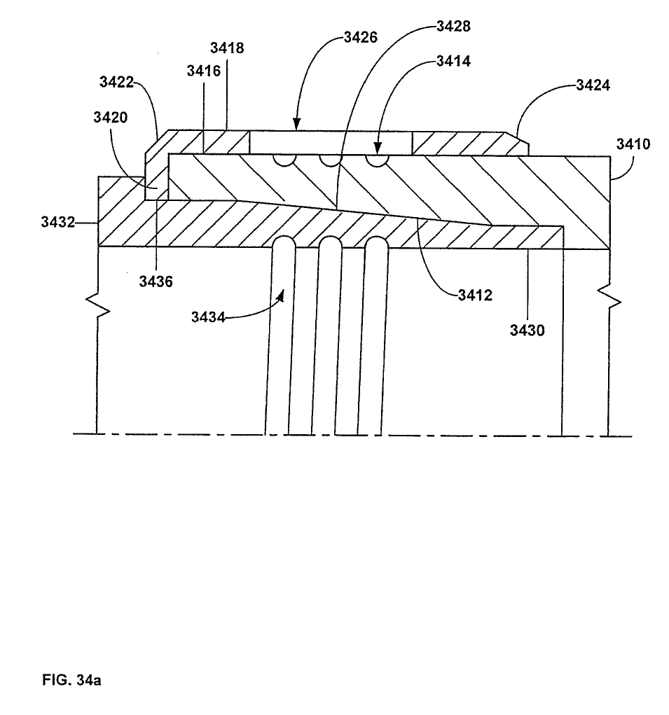

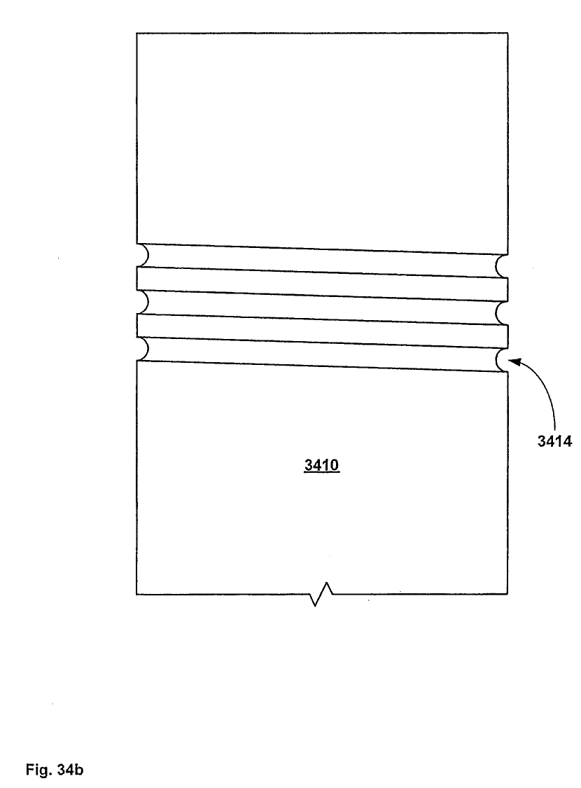

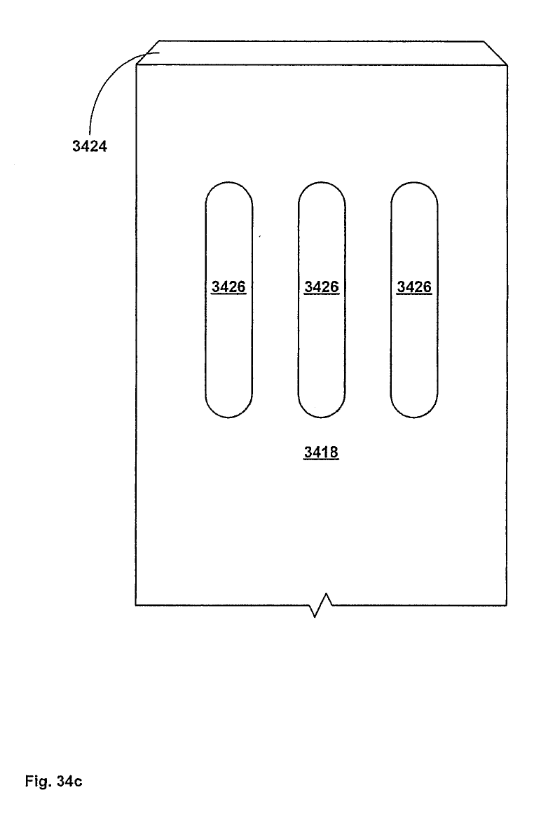

Referring to FIGS. 34a, 34b, and 34c, in an exemplary embodiment, a first tubular member 3410 includes an internally threaded connection 1312 and one or more external grooves 3414 at an end portion 3416.

A first end of a tubular sleeve 3418 that includes an internal flange 3420 and a tapered portion 3422, a second end that includes a tapered portion 3424, and an intermediate portion that includes one or more longitudinally aligned openings 3426, is then mounted upon and receives the end portion 3416 of the first tubular member 3410.

In an exemplary embodiment, the end portion 3416 of the first tubular member 3410 abuts one side of the internal flange 3420 of the tubular sleeve 3418, and the internal diameter of the internal flange 3420 of the tubular sleeve 3416 is substantially equal to or greater than the maximum internal diameter of the internally threaded connection 3412 of the end portion 3416 of the first tubular member 3410. An externally threaded connection 3428 of an end portion 3430 of a second tubular member 3432 that includes one or more internal grooves 3434 is then positioned within the tubular sleeve 3418 and threadably coupled to the internally threaded connection 3412 of the end portion 3416 of the first tubular member 3410. In an exemplary embodiment, the internal flange 3420 of the tubular sleeve 3418 mates with and is received within an annular recess 3436 defined in the end portion 3430 of the second tubular member 3432. Thus, the tubular sleeve 3418 is coupled to and surrounds the external surfaces of the first and second tubular members, 3410 and 3432.

The first and second tubular members, 3410 and 3432, and the tubular sleeve 3418 may be positioned within another structure such as, for example, a cased or uncased wellbore, and radially expanded and plastically deformed, for example, by displacing and/or rotating a conventional expansion device within and/or through the interiors of the first and second tubular members. The tapered portions, 3422 and 3424, of the tubular sleeve 3418 facilitate the insertion and movement of the first and second tubular members within and through the structure, and the movement of the expansion device through the interiors of the first and second tubular members, 3410 and 3432, may be from top to bottom or from bottom to top.

During the radial expansion and plastic deformation of the first and second tubular members, 3410 and 3432, the tubular sleeve 3418 is also radially expanded and plastically deformed. As a result, the tubular sleeve 3418 may be maintained in circumferential tension and the end portions, 3416 and 3430, of the first and second tubular members, 3410 and 3432, may be maintained in circumferential compression.

Sleeve 3416 increases the axial compression loading of the connection between tubular members 3410 and 3432 before and after expansion by the expansion device. The sleeve 3418 may be secured to tubular members 3410 and 3432, for example, by a heat shrink fit.

During the radial expansion and plastic deformation of the first and second tubular members, 3410 and 3432, the grooves 3414 and/or 3434 and/or the openings 3426 provide stress concentrations that in turn apply added stress forces to the mating threads of the threaded connections, 3412 and 3428. As a result, during and after the radial expansion and plastic deformation of the first and second tubular members, 3410 and 3432, the mating threads of the threaded connections, 3412 and 3428, are maintained in metal to metal contact thereby providing a fluid and gas tight connection. In an exemplary embodiment, the orientations of the grooves 3414 and/or 3434 and the openings 3426 are orthogonal to one another. In an exemplary embodiment, the grooves 3414 and/or 3434 are helical grooves.

In several alternative embodiments, the first and second tubular members, 3410 and 3432, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 3418 during (a) the coupling of the first tubular member 3410 to the second tubular member 3432, (b) the placement of the first and second tubular members in the structure, and (c) the radial expansion and plastic deformation of the first and second tubular members provides a number of significant benefits. For example, the tubular sleeve 3418 protects the exterior surfaces of the end portions, 3416 and 3430, of the first and second tubular members, 3410 and 3432, during handling and insertion of the tubular members within the structure. In this manner, damage to the exterior surfaces of the end portions, 3416 and 3430, of the first and second tubular members, 3410 and 3432, is avoided that could otherwise result in stress concentrations that could cause a catastrophic failure during subsequent radial expansion operations. Furthermore, the tubular sleeve 3418 provides an alignment guide that facilitates the insertion and threaded coupling of the second tubular member 3432 to the first tubular member 3410. In this manner, misalignment that could result in damage to the threaded connections, 3412 and 3428, of the first and second tubular members, 3410 and 3432, may be avoided. In addition, during the relative rotation of the second tubular member with respect to the first tubular member, required during the threaded coupling of the first and second tubular members, the tubular sleeve 3416 provides an indication of to what degree the first and second tubular members are threadably coupled. For example, if the tubular sleeve 3418 can be easily rotated, that would indicate that the first and second tubular members, 3410 and 3432, are not fully threadably coupled and in intimate contact with the internal flange 3420 of the tubular sleeve. Furthermore, the tubular sleeve 3418 may prevent crack propagation during the radial expansion and plastic deformation of the first and second tubular members, 3410 and 3432. In this manner, failure modes such as, for example, longitudinal cracks in the end portions, 3416 and 3430, of the first and second tubular members may be limited in severity or eliminated all together. In addition, after completing the radial expansion and plastic deformation of the first and second tubular members, 3410 and 3432, the tubular sleeve 3418 may provide a fluid and gas tight metal-to-metal seal between interior surface of the tubular sleeve 3418 and the exterior surfaces of the end portions, 3416 and 3430, of the first and second tubular members. In this manner, fluidic materials are prevented from passing through the threaded connections, 3412 and 3430, of the first and second tubular members, 3410 and 3432, into the annulus between the first and second tubular members and the structure. Furthermore, because, following the radial expansion and plastic deformation of the first and second tubular members, 3410 and 3432, the tubular sleeve 3418 may be maintained in circumferential tension and the end portions, 3416 and 3430, of the first and second tubular members, 3410 and 3432, may be maintained in circumferential compression, axial loads and/or torque loads may be transmitted through the tubular sleeve.

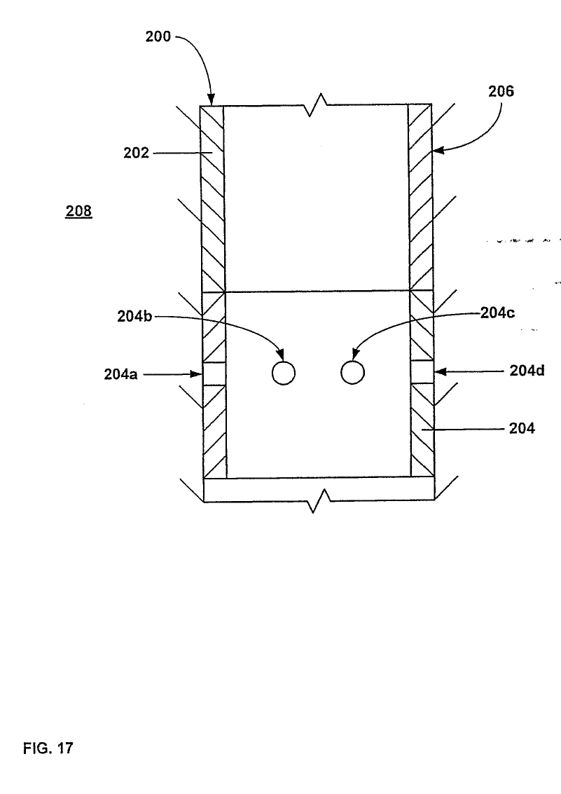

In several exemplary embodiments, the first and second tubular members described above with reference to FIGS. 1 to 34c are radially expanded and plastically deformed using the expansion device in a conventional manner and/or using one or more of the methods and apparatus disclosed in one or more of the following: The present application is related to the following: (1) U.S. patent application Ser. No. 09/454,139, attorney docket no. 25791.03.02, filed on Dec. 3, 1999, (2) U.S. patent application Ser. No. 09/510,913, attorney docket no. 25791.7.02, filed on Feb. 23, 2000, (3) U.S. patent application Ser. No. 09/502,350, attorney docket no. 25791.8.02, filed on Feb. 10, 2000, (4) U.S. patent application Ser. No. 09/440,338, attorney docket no. 25791.9.02, filed on Nov. 15, 1999, (5) U.S. patent application Ser. No. 09/523,460, attorney docket no. 25791.11.02, filed on Mar. 10, 2000, (6) U.S. patent application Ser. No. 09/512,895, attorney docket no. 25791.12.02, filed on Feb. 24, 2000, (7) U.S. patent application Ser. No. 09/511,941, attorney docket no. 25791.16.02, filed on Feb. 24, 2000, (8) U.S. patent application Ser. No. 09/588,946, attorney docket no. 25791.17.02, filed on Jun. 7, 2000, (9) U.S. patent application Ser. No. 09/559,122, attorney docket no. 25791.23.02, filed on Apr. 26, 2000, (10) PCT patent application serial no. PCT/US00/18635, attorney docket no. 25791.25.02, filed on Jul. 9, 2000, (11) U.S. provisional patent application Ser. No. 60/162,671, attorney docket no. 25791.27, filed on Nov. 1, 1999, (12) U.S. provisional patent application Ser. No. 60/154,047, attorney docket no. 25791.29, filed on Sep. 16, 1999, (13) U.S. provisional patent application Ser. No. 60/159,082, attorney docket no. 25791.34, filed on Oct. 12, 1999, (14) U.S. provisional patent application Ser. No. 60/159,039, attorney docket no. 25791.36, filed on Oct. 12, 1999, (15) U.S. provisional patent application Ser. No. 60/159,033, attorney docket no. 25791.37, filed on Oct. 12, 1999, (16) U.S. provisional patent application Ser. No. 60/212,359, attorney docket no. 25791.38, filed on Jun. 19, 2000, (17) U.S. provisional patent application Ser. No. 60/165,228, attorney docket no. 25791.39, filed on Nov. 12, 1999, (18) U.S. provisional patent application Ser. No. 60/221,443, attorney docket no. 25791.45, filed on Jul. 28, 2000, (19) U.S. provisional patent application Ser. No. 60/221,645, attorney docket no. 25791.46, filed on Jul. 28, 2000, (20) U.S. provisional patent application Ser. No. 60/233,638, attorney docket no. 25791.47, filed on Sep. 18, 2000, (21) U.S. provisional patent application Ser. No. 60/237,334, attorney docket no. 25791.48, filed on Oct. 2, 2000, (22) U.S. provisional patent application Ser. No. 60/270,007, attorney docket no. 25791.50, filed on Feb. 20, 2001, (23) U.S. provisional patent application Ser. No. 60/262,434, attorney docket no. 25791.51, filed on Jan. 17, 2001, (24) U.S, provisional patent application Ser. No. 60/259,486, attorney docket no. 25791.52, filed on Jan. 3, 2001, (25) U.S. provisional patent application Ser. No. 60/303,740, attorney docket no. 25791.61, filed on Jul. 6, 2001, (26) U.S. provisional patent application Ser. No. 60/313,453, attorney docket no. 25791.59, filed on Aug. 20, 2001, (27) U.S. provisional patent application Ser. No. 60/317,985, attorney docket no. 25791.67, filed on Sep. 6, 2001, (28) U.S. provisional patent application Ser. No. 60/3318,386, attorney docket no. 25791.67.02, filed on Sep. 10, 2001, (29) U.S. utility patent application Ser. No. 09/969,922, attorney docket no. 25791.69, filed on Oct. 3, 2001, (30) U.S. utility patent application Ser. No. 10/016,467, attorney docket no. 25791.70, filed on Dec. 10, 2001, (31) U.S. provisional patent application Ser. No. 60/343,674, attorney docket no. 25791.68, filed on Dec. 27, 2001; and (32) U.S. provisional patent application Ser. No. 60/346,309, attorney docket no. 25791.92, filed on Jan. 7, 2002, the disclosures of which are incorporated herein by reference.

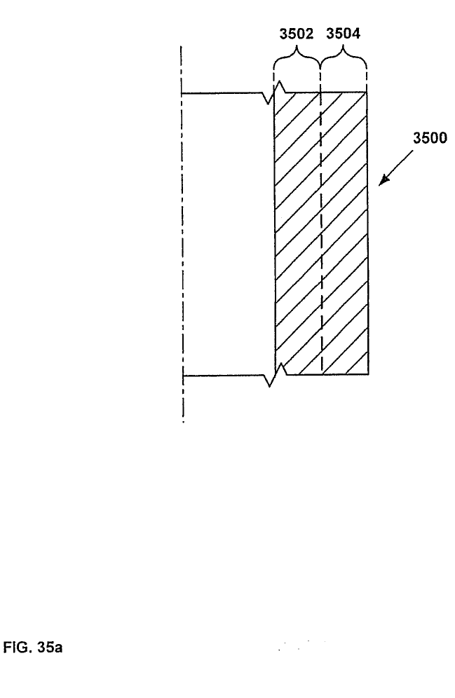

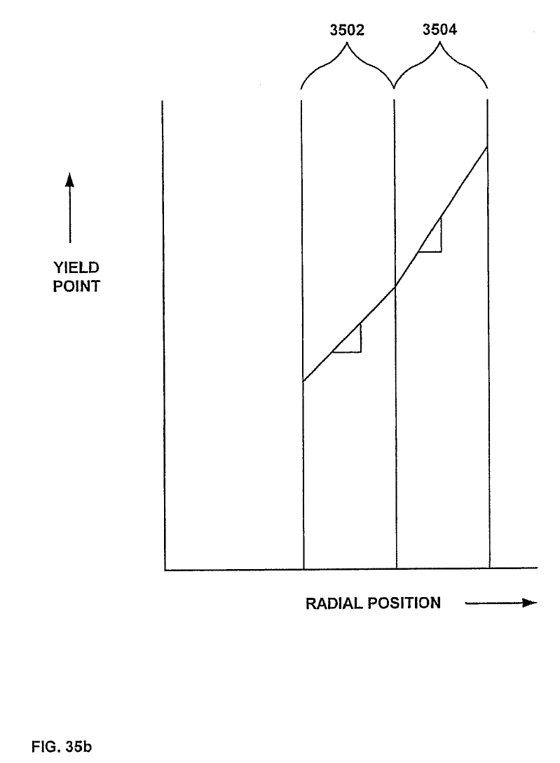

Referring to FIG. 35a an exemplary embodiment of an expandable tubular member 3500 includes a first tubular region 3502 and a second tubular portion 3504. In an exemplary embodiment, the material properties of the first and second tubular regions, 3502 and 3504, are different. In an exemplary embodiment, the yield points of the first and second tubular regions, 3502 and 3504, are different. In an exemplary embodiment, the yield point of the first tubular region 3502 is less than the yield point of the second tubular region 3504. In several exemplary embodiments, one or more of the expandable tubular members, 12, 14, 24, 26, 102, 104, 106, 108, 202 and/or 204 incorporate the tubular member 3500.

Referring to FIG. 35b, in an exemplary embodiment, the yield point within the first and second tubular regions, 3502a and 3502b, of the expandable tubular member 3502 vary as a function of the radial position within the expandable tubular member. In an exemplary embodiment, the yield point increases as a function of the radial position within the expandable tubular member 3502. In an exemplary embodiment, the relationship between the yield point and the radial position within the expandable tubular member 3502 is a linear relationship. In an exemplary embodiment, the relationship between the yield point and the radial position within the expandable tubular member 3502 is a non-linear relationship. In an exemplary embodiment, the yield point increases at different rates within the first and second tubular regions, 3502a and 3502b, as a function of the radial position within the expandable tubular member 3502. In an exemplary embodiment, the functional relationship, and value, of the yield points within the first and second tubular regions, 3502a and 3502b, of the expandable tubular member 3502 are modified by the radial expansion and plastic deformation of the expandable tubular member.

In several exemplary embodiments, one or more of the expandable tubular members, 12, 14, 24, 26, 102, 104, 106, 108, 202, 204 and/or 3502, prior to a radial expansion and plastic deformation, include a microstructure the is a combination of a hard phase, such as martensite, a soft phase, such as ferrite, and a transitionary phase, such as retained austentite. In this manner, the hard phase provides high strength, the soft phase provides ductility, and the transitionary phase transitions to a hard phase, such as martensite, during a radial expansion and plastic deformation. Furthermore, in this manner, the yield point of the tubular member increases as a result of the radial expansion and plastic deformation. Further, in this manner, the tubular member is ductile, prior to the radial expansion and plastic deformation, thereby facilitating the radial expansion and plastic deformation. In an exemplary embodiment, the composition of a dual-phase expandable tubular member includes (weight percentages): about 0.1% C, 1.2% Mn, and 0.3% Si.

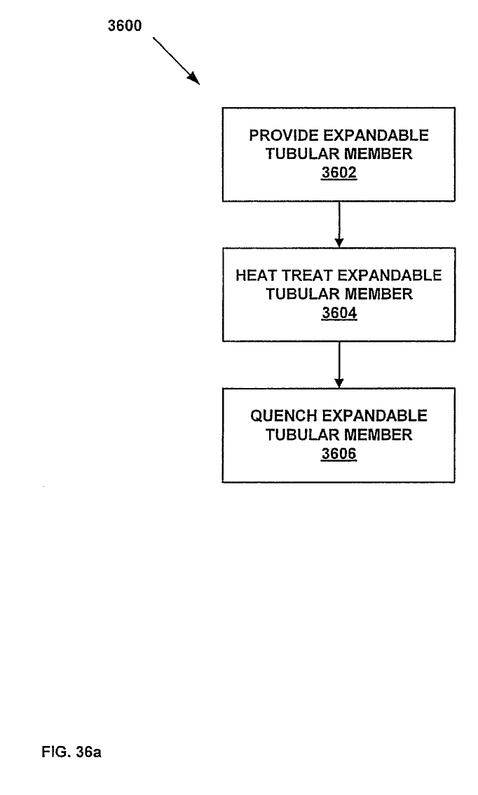

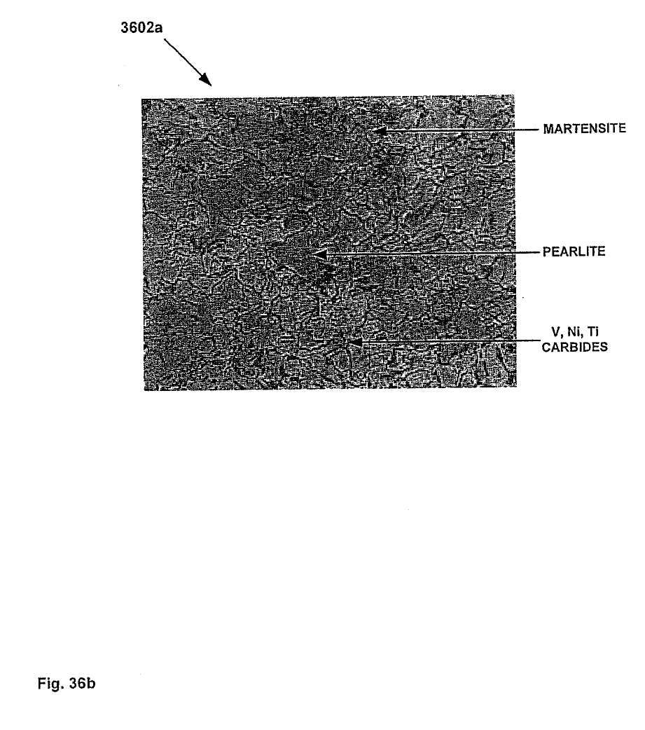

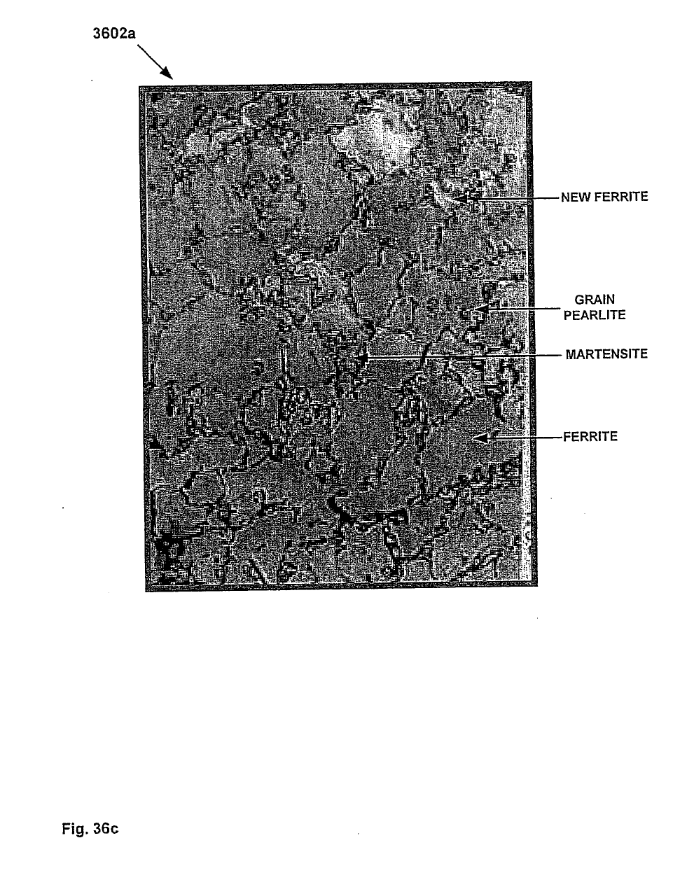

In an exemplary experimental embodiment, as illustrated in FIGS. 36a-36c, one or more of the expandable tubular members, 12, 14, 24, 26, 102, 104, 106, 108, 202, 204 and/or 3502 are processed in accordance with a method 3600, in which, in step 3602, an expandable tubular member 3602a is provided the is a steel alloy having following material composition (by weight percentage): 0.065% C, 1.44% Mn, 0.01% P, 0.002% S, 0.24% Si, 0.01% Cu, 0.01% Ni, 0.02% Cr, 0.05% V, 0.01% Mo, 0.01% Nb, and 0.01% Ti. In an exemplary experimental embodiment, the expandable tubular member 3602a provided in step 3602 has a yield strength of 45 ksi, and a tensile strength of 69 ksi.

In an exemplary experimental embodiment, as illustrated in FIG. 36b, in step 3602, the expandable tubular member 3602a includes a microstructure that includes martensite, pearlite, and V, Ni, and/or Ti carbides.

In an exemplary embodiment, the expandable tubular member 3602a is then heated at a temperature of 790° C. for about 10 minutes in step 3604.

In an exemplary embodiment, the expandable tubular member 3602a is then quenched in water in step 3606.

In an exemplary experimental embodiment, as illustrated in FIG. 36c, following the completion of step 3606, the expandable tubular member 3602a includes a microstructure that includes new ferrite, grain pearlite, martensite, and ferrite. In an exemplary experimental embodiment, following the completion of step 3606, the expandable tubular member 3602a has a yield strength of 67 ksi, and a tensile strength of 95 ksi.

In an exemplary embodiment, the expandable tubular member 3602a is then radially expanded and plastically deformed using one or more of the methods and apparatus described above. In an exemplary embodiment, following the radial expansion and plastic deformation of the expandable tubular member 3602a, the yield strength of the expandable tubular member is about 95 ksi.

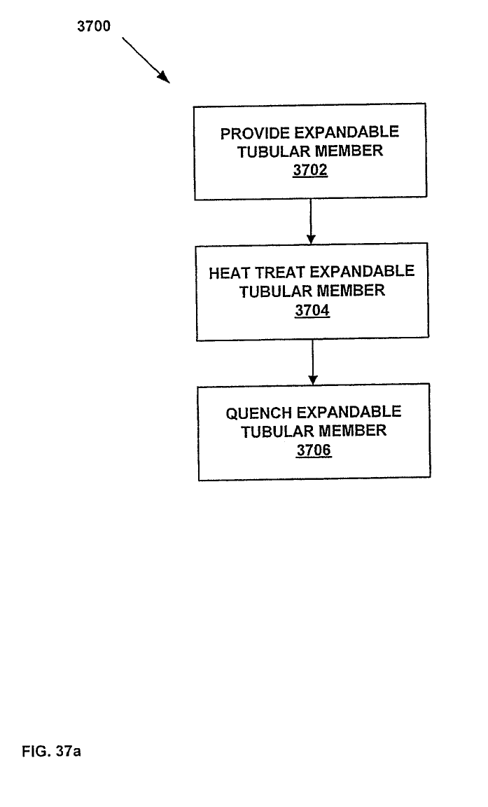

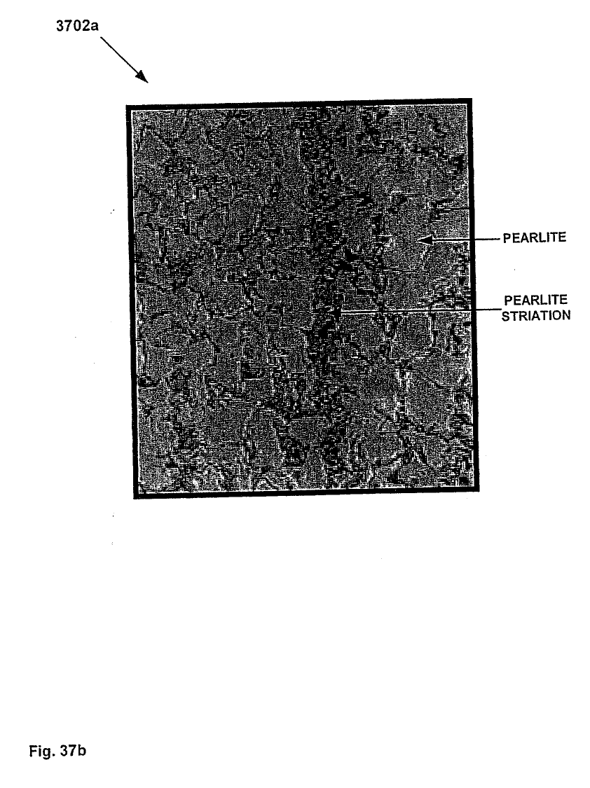

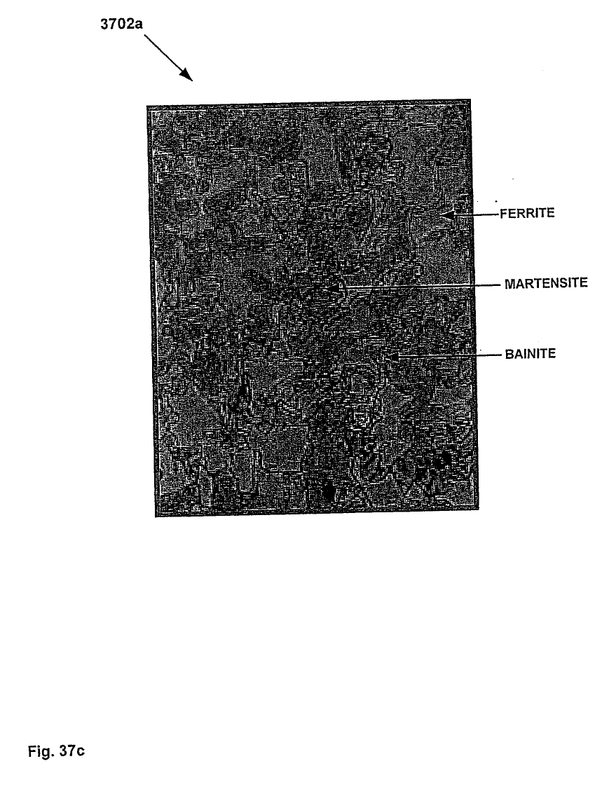

In an exemplary experimental embodiment, as illustrated in FIGS. 37a-37c, one or more of the expandable tubular members, 12, 14, 24, 26, 102, 104, 106, 108, 202, 204 and/or 3502 are processed in accordance with a method 3700, in which, in step 3702, an expandable tubular member 3702a is provided the is a steel alloy having following material composition (by weight percentage): 0.18% C, 1.28% Mn, 0.017% P, 0.004% S, 0.29% Si, 0.01% Cu, 0.01% Ni, 0.03% Cr, 0.04% V, 0.01% Mo, 0.03% Nb, and 0.01% Ti. In an exemplary experimental embodiment, the expandable tubular member 3702a provided in step 3702 has a yield strength of 60 ksi, and a tensile strength of 80 ksi.

In an exemplary experimental embodiment, as illustrated in FIG. 37b, in step 3702, the expandable tubular member 3702a includes a microstructure that includes pearlite and pearlite striation.

In an exemplary embodiment, the expandable tubular member 3702a is then heated at a temperature of 790° C. for about 10 minutes in step 3704.

In an exemplary embodiment, the expandable tubular member 3702a is then quenched in water in step 3706.

In an exemplary experimental embodiment, as illustrated in FIG. 37c, following the completion of step 3706, the expandable tubular member 3702a includes a microstructure that includes ferrite, martensite, and bainite. In an exemplary experimental embodiment, following the completion of step 3706, the expandable tubular member 3702a has a yield strength of 82 ksi, and a tensile strength of 130 ksi.

In an exemplary embodiment, the expandable tubular member 3702a is then radially expanded and plastically deformed using one or more of the methods and apparatus described above. In an exemplary embodiment, following the radial expansion and plastic deformation of the expandable tubular member 3702a, the yield strength of the expandable tubular member is about 130 ksi.

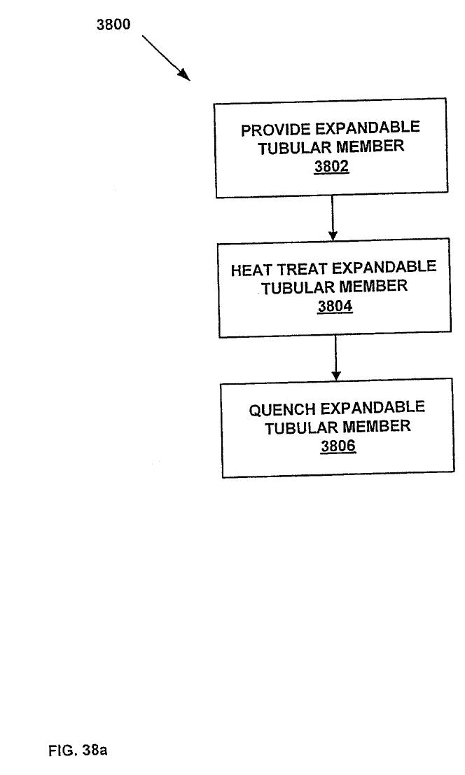

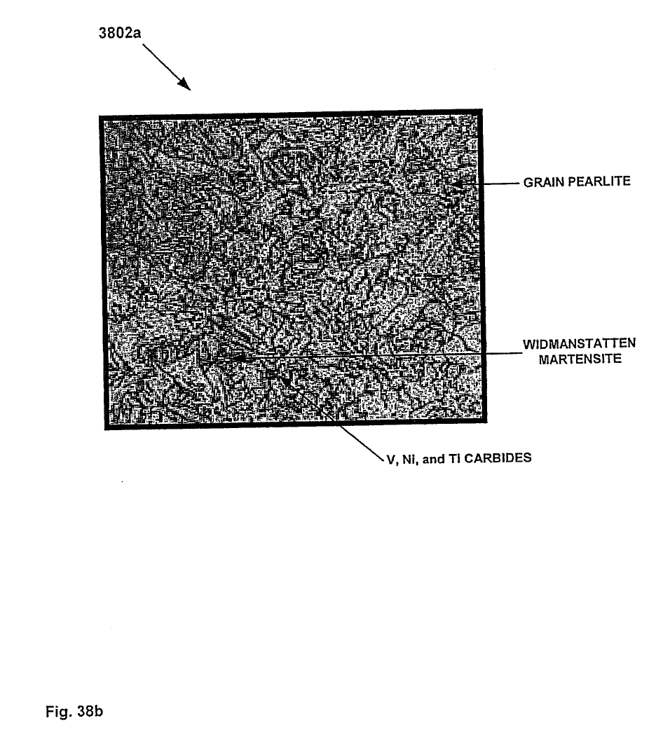

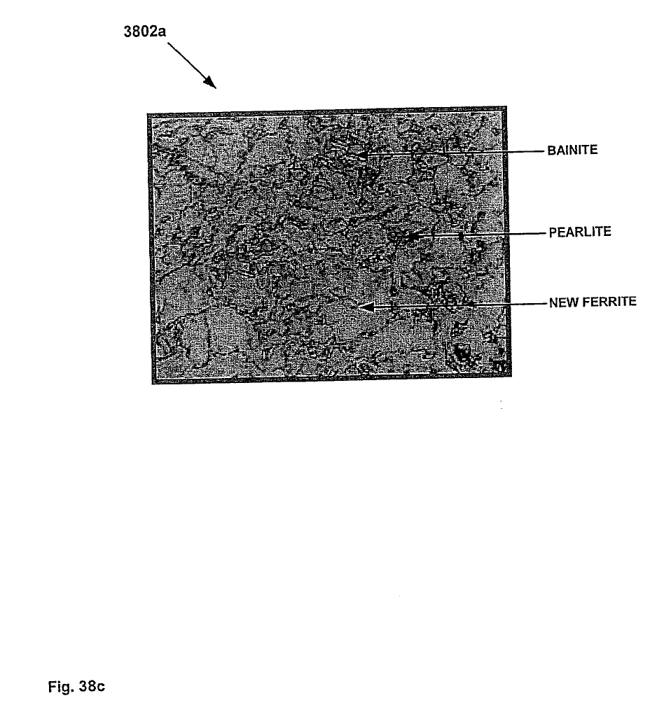

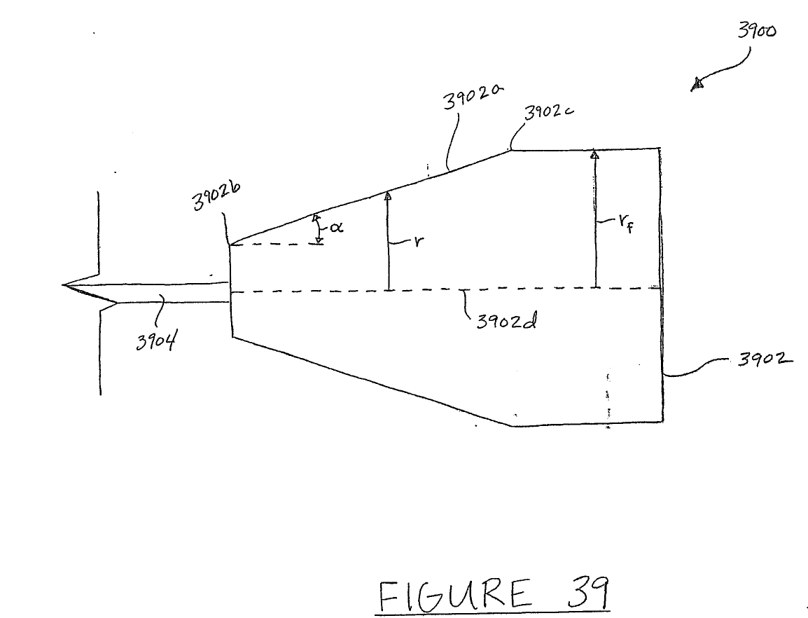

In an exemplary experimental embodiment, as illustrated in FIGS. 38a-38c, one or more of the expandable tubular members, 12, 14, 24, 26, 102, 104, 106, 108, 202, 204 and/or 3502 are processed in accordance with a method 3800, in which, in step 3802, an expandable tubular member 3802a is provided the is a steel alloy having following material composition (by weight percentage): 0.08% C, 0.82% Mn, 0.006% P, 0.003% S, 0.30% Si, 0.06% Cu, 0.05% Ni, 0.05% Cr, 0.03% V, 0.03% Mo, 0.01% Nb, and 0.01% Ti. In an exemplary experimental embodiment, the expandable tubular member 3802a provided in step 3802 has a yield strength of 56 ksi, and a tensile strength of 75 ksi.

In an exemplary experimental embodiment, as illustrated in FIG. 38b, in step 3802, the expandable tubular member 3802a includes a microstructure that includes grain pearlite, widmanstatten martensite and carbides of V, Ni, and/or Ti.

In an exemplary embodiment, the expandable tubular member 3802a is then heated at a temperature of 790° C. for about 10 minutes in step 3804.

In an exemplary embodiment, the expandable tubular member 3802a is then quenched in water in step 3806.

In an exemplary experimental embodiment, as illustrated in FIG. 38c, following the completion of step 3806, the expandable tubular member 3802a includes a microstructure that includes bainite, pearlite, and new ferrite. In an exemplary experimental embodiment, following the completion of step 3806, the expandable tubular member 3802a has a yield strength of 60 ksi, and a tensile strength of 97 ksi.

In an exemplary embodiment, the expandable tubular member 3802a is then radially expanded and plastically deformed using one or more of the methods and apparatus described above. In an exemplary embodiment, following the radial expansion and plastic deformation of the expandable tubular member 3802a, the yield strength of the expandable tubular member is about 97 ksi.

In several exemplary embodiments, the teachings of the present disclosure are combined with one or more of the teachings disclosed in FR 2 841 626, filed on Jun. 28, 2002, and published on Jan. 2, 2004, the disclosure of which is incorporated herein by reference.

In an exemplary embodiment, the tubular members include one or more of the following characteristics: high burst and collapse, the ability to be radially expanded more than about 40%, high fracture toughness, defect tolerance, strain recovery @ 150 F, good bending fatigue, optimal residual stresses, and corrosion resistance to H₂S in order to provide optimal characteristics during and after radial expansion and plastic deformation.

In an exemplary embodiment, the tubular members are fabricated from a steel alloy having a charpy energy of at least about 90 ft-lbs in order to provided enhanced characteristics during and after radial expansion and plastic deformation of the expandable tubular member.

In an exemplary embodiment, the tubular members are fabricated from a steel alloy having a weight percentage of carbon of less than about 0.08% in order to provide enhanced characteristics during and after radial expansion and plastic deformation of the tubular members.

In an exemplary embodiment, the tubular members are fabricated from a steel alloy having reduced sulfur content in order to minimize hydrogen induced cracking.

In an exemplary embodiment, the tubular members are fabricated from a steel alloy having a weight percentage of carbon of less than about 0.20% and a charpy-V-notch impact toughness of at least about 6 joules in order to provide enhanced characteristics during and after radial expansion and plastic deformation of the tubular members.

In an exemplary embodiment, the tubular members are fabricated from a steel alloy having a low weight percentage of carbon in order to enhance toughness, ductility, weldability, shelf energy, and hydrogen induced cracking resistance.

In several exemplary embodiments, the tubular members are fabricated from a steel alloy having the following percentage compositions in order to provide enhanced characteristics during and after radial expansion and plastic deformation of the tubular members:

| | C | Si | Mn | P | S | Al | N | Cu | Cr | Ni | Nb | Ti | Co | Mo |
|---|---|---|---|---|---|---|---|---|---|---|---|---|---|---|
| EXAMPLE A | 0.030 | 0.22 | 1.74 | 0.005 | 0.0005 | 0.028 | 0.0037 | 0.30 | 0.26 | 0.15 | 0.095 | 0.014 | 0.0034 | |
| EXAMPLE B MIN | 0.020 | 0.23 | 1.70 | 0.004 | 0.0005 | 0.026 | 0.0030 | 0.27 | 0.26 | 0.16 | 0.096 | 0.012 | 0.0021 | |
| EXAMPLE B MAX | 0.032 | 0.26 | 1.92 | 0.009 | 0.0010 | 0.035 | 0.0047 | 0.32 | 0.29 | 0.18 | 0.120 | 0.016 | 0.0050 | |
| EXAMPLE C | 0.028 | 0.24 | 1.77 | 0.007 | 0.0008 | 0.030 | 0.0035 | 0.29 | 0.27 | 0.17 | 0.101 | 0.014 | 0.0028 | 0.0020 |
| EXAMPLE D | 0.08 | 0.30 | 0.5 | 0.07 | 0.005 | | 0.010 | 0.10 | 0.50 | 0.10 | | | | |
| EXAMPLE E | 0.0028 | 0.009 | 0.17 | 0.011 | 0.006 | 0.027 | 0.0029 | | 0.029 | 0.014 | 0.035 | 0.007 | | |
| EXAMPLE F | 0.03 | 0.1 | 0.1 | 0.015 | 0.005 | | | | | 18.0 | | 0.6 | 9 | 5 |
| EXAMPLE G | 0.002 | 0.01 | 0.15 | 0.07 | 0.005 | 0.04 | 0.0025 | | | | 0.015 | 0.010 | | |

In an exemplary embodiment, the ratio of the outside diameter D of the tubular members to the wall thickness t of the tubular members range from about 12 to 22 in order to enhance the collapse strength of the radially expanded and plastically deformed tubular members.

In an exemplary embodiment, the outer portion of the wall thickness of the radially expanded and plastically deformed tubular members includes tensile residual stresses in order to enhance the collapse strength following radial expansion and plastic deformation.

In several exemplary experimental embodiments, reducing residual stresses in samples of the tubular members prior to radial expansion and plastic deformation increased the collapse strength of the radially expanded and plastically deformed tubular members.

In several exemplary experimental embodiments, the collapse strength of radially expanded and plastically deformed samples of the tubulars were determined on an as-received basis, after strain aging at 250 F for 5 hours to reduce residual stresses, and after strain aging at 350 F for 14 days to reduce residual stresses as follows:

| | Collapse Strength |
|---|---|
| | After 10% Radial |
| Tubular Sample | Expansion |
| Tubular Sample 1 - as received from | 4000 psi |
| manufacturer | |
| Tubular Sample 1 - strain aged at 250 F. | 4800 psi |
| for 5 hours to reduce residual stresses | |
| Tubular Sample 1 - strain aged at 350 F. | 5000 psi |
| for 14 days to reduce residual stresses | |

As indicated by the above table, reducing residual stresses in the tubular members, prior to radial expansion and plastic deformation, significantly increased the resulting collapse strength—post expansion.

Referring now to FIG. 39, an expansion device 3900 is illustrated. In an exemplary embodiment, the expansion device 3900 may be, for example, the expansion devices 20, 114, 210, 2234, 2434, 2534, 2634, 2734, 3134, and/or 3336 described above with reference to FIGS. 2, 3, 9, 10, 15, 16, 22, 23, 24, 25, 26, 27, 28, 31, and 33 and/or any conventional expansion device such as, for example, the expansion devices commercially available from Weatherford International or Baker Hughes. The expansion device 3900 includes a expansion member 3902 having an expansion surface 3902a located between a front end 3902b of the expansion member 3902 and a point 3902c located along the length of the expansion member 3902. An expansion member axis 3902d runs through the center of the expansion member 3902. A drill string 3904 is coupled to the front end 3902b of the expansion member 3902. The expansion device 3900 also includes an expansion surface angle α which is defined as the angle between a line which is parallel to the expansion member axis 3902d and the expansion surface 3902a. An expansion surface radius r is defined as the distance between the expansion surface axis 3902d and the expansion surface 3902a, which varies between the front end 3902b and the point 3902c on the expansion member 3902. A final expansion radius r_{f} is defined as the distance between the expansion surface axis 3902d and the surface on the expansion member with the maximum radius, which begins at point 3902c.

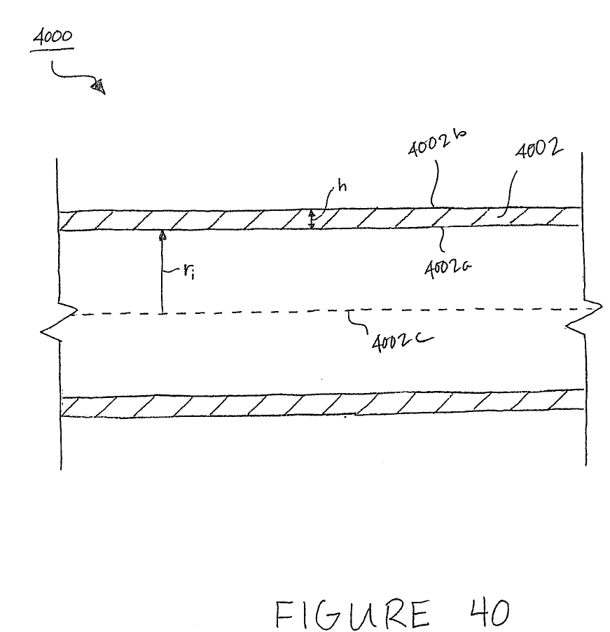

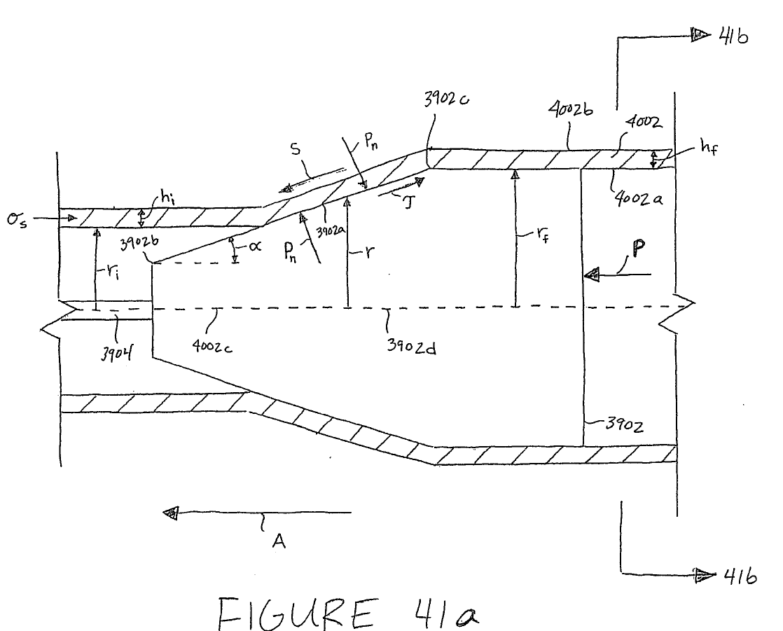

Referring now to FIG. 40, an expandable tubular member 4000 is illustrated. In an exemplary embodiment, the expandable tubular member 4000 may be the expandable tubular members 12, 14, 24, 26, 102, 108, 202, 204, 2210, 2228, 2310, 2328, 2410, 2428, 2510, 2528, 2610, 2628, 2710, 2728, 2910, 2926, 3010, 3024, 3030, 3044, 3050, 3068, 3110, 3124, 3210, 3220, 3310, 3330, 3410, 3432, 3418, and/or 3500, described above with reference to FIGS. 1, 2, 3, 4, 7, 8, 9, 10, 11,14,15,16,17, 22, 23, 24, 25, 26, 27, 28, 29, 30a, 30b, 30c, 31, 32a, 32b, 33, 34a, 34b, 34c, and 35a. The expandable tubular member 4000 has a tubular base 4002 having an inner surface 4002a and an outer surface 4002b located opposite the inner surface 4002a. An expandable tubular member axis 4002c is centrally located along the length of the expandable tubular member 4000. An expandable tubular member thickness h is defined as the distance between the inner surface 4002a and the outer surface 4002b of the tubular base 4002. An initial radius rᵢ is defined as the distance between the expandable tubular member axis 4002c and the inner surface 4002a of the base 4002.

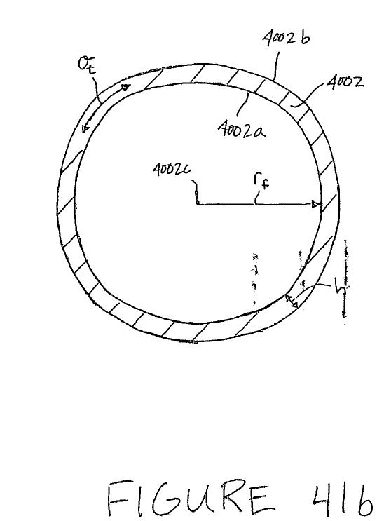

Referring now to FIGS. 41a and 41b, in operation, the expansion device 3900 is positioned in the expandable tubular member 4000 and moved through the expandable tubular member 4000 in a direction A by providing a pressure differential p across the expandable tubular member 400, as illustrated in FIG. 41a, radially expanding and plastically deforming the expandable tubular member 4000. The radial expansion and plastic deformation of the expandable tubular member 4000 increases the radius of the expandable tubular member 4000 from the initial radius rᵢ of the expandable tubular member 4000 to the final expansion radius r_{f} of the expansion device 3900 and decreases the expandable tubular member thickness h from an initial thickness hᵢ to a final thickness h_{f}. The expansion surface radius r of the expansion device 3900 is equal to the radius r of the expandable tubular member 4000 during the expansion of the expandable tubular member 4000 from the initial radius rᵢ to the final expansion radius r_{f}. This radial expansion and plastic deformation also creates a number of stresses and forces in and on the expandable tubular member 4000 and the expansion device 3900: a stress σₛ, which is defined as the longitudinal stress in the expandable tubular member 4000; a stress σₜ, which is defined as the circumferential stress in the expandable tubular member 4000, a shear stress τ, which is defined as the shear stress on the expansion surface 3902a of the expansion device 3900 and is a function of the expansion surface radius r, a shear stress s, which is defined as the shear stress on the inner surface 4002a of the expandable tubular member 4000; and a normal force Pₙ, which is defined as the force on the expansion surface 3902a of the expansion device 3900 and the inner surface 4002a of the expandable tubular member 4000, which are equal and opposite forces and which are a function of the expansion surface radius r.

Assuming that the expansion device 3900 is solid, the equilibrium equation for the expansion device 3900 given by the following equation:

$$π \cdot {r}_{f}^{2} \cdot p = 2 \cdot π \cdot {\int }_{{r}_{i}}^{{r}_{f}} ( {p}_{n} ( r ) \cdot sin ( α ) + τ ( r ) \cdot cos ( α ) ) \cdot \frac{r}{sin ( α ) \cdot cos ( α )} ⅆ r \qquad ( equation 1 )$$

wherein,
r_{f} is the final expansion radius of the expansion device 3900,
p is the propagation pressure for the expansion device 3900,
pₙ(r) is the normal force on the expansion device 3900 and is a function of the expansion surface radius r of the expansion device 3900,
α is the expansion surface angle of the expansion device 3900
τ is the shear stress on the expansion device 3900,
r is the expansion surface radius of the expansion device 3900, and
dr is the incremental change in the expansion surface radius of the expansion device 3900.

A coefficient of friction is defined as p and may be used with the following equations to determine the coefficient of friction necessary for the expansion of the expandable tubular member 4000 by the expansion device 3900. In addition, the coefficient of friction p may be used to select a lubricant for facilitating the radial expansion and plastic deformation of the expandable tubular member 4000 by the expansion device 3900. If the coefficient of friction is defined as μ, then the shear stress T is given by the following equation:
τ=μ·pₙ (equation 2)
wherein,
τ is the shear stress on the expansion device 3900,
μ is the coefficient of friction between the expansion device 3900 and the expandable tubular member 4000, and
pₙ is the normal force on the expansion device 3900.

Equation 1 and equation 2 result in the following equation:

$$p = \frac{2}{{r}_{f}^{2}} \cdot ( 1 + μ \cdot cot ( α ) ) \cdot {\int }_{{r}_{i}}^{{r}_{f}} {p}_{n} ( r ) \cdot r ⅆ r \qquad ( equation 3 )$$

wherein,
p is the propagation pressure for the expansion device 3900,
r_{f} is the final expansion radius of the expansion device 3900,
p is the coefficient of friction between the expansion device 3900 and the expandable tubular member 4000,
α is the expansion surface angle of the expansion device 3900,
r; is the initial radius of the expandable tubular member 4000,
pₙ(r) is the normal force on the expansion device 3900 and is a function of the expansion surface radius r of the expansion device 3900,
r is the expansion surface radius of the expansion device 3900, and
dr is the incremental change in the expansion surface: radius of the expansion device 3900.

Assuming the expandable tubular member 4000 is a thin wall tube, then the expandable tubular member thickness h is small enough to use a membrane approximation for bending stiffness. The equilibrium equations for the expandable tubular member 4000 will then have the form of the following equations:

$$\frac{ⅆ}{ⅆ r} ( {σ}_{S} \cdot r \cdot h ) - {σ}_{t} \cdot h - \frac{τ \cdot r}{sin ( α )} = 0 \qquad ( equation 4 )$$

wherein,
σₛ is a longitudinal stress in the expandable tubular member 4000,
r is the radius of the expandable tubular member 4000,
h is the thickness of the expandable tubular member 4000,
σₜ is a tangential stress in the expandable tubular member 4000,
τ is the shear stress on the expansion device 3900,
α is the expansion surface angle of the expansion device 3900, and
dr is the incremental change in the radius of the expandable tubular member.
and

$$\frac{{σ}_{t} \cdot cos ( α )}{r} = \frac{{p}_{n}}{h} \qquad ( equation 5 )$$
wherein,
σₜ is a tangential stress in the expandable tubular member 4000,
α is the expansion surface angle of the expansion device 3900,
r is the radius of the expandable tubular member 4000,
pₙ is the normal force on the expandable tubular member 4000 and is a function of the expansion surface radius r of the expansion device 3900, and
h is the thickness of the expandable tubular member 4000.

Substituting equation 5 and equation 2 into equation 4 results in the following equation:

$$\frac{ⅆ}{ⅆ r} ( {σ}_{S} \cdot r \cdot h ) - {σ}_{t} \cdot h + μ \cdot {σ}_{t} \cdot cot ( α ) \cdot h = 0 \qquad ( equation 6.1 )$$

wherein,
σₛ is a longitudinal stress in the expandable tubular member 4000,
r is the radius of the expandable tubular member 4000,
h is the thickness of the expandable tubular member 4000,
σₜ is a tangential stress in the expandable tubular member 4000,
μ is the coefficient of friction between the expansion device 3900 and the expandable tubular member 4000,
α is the expansion surface angle of the expansion device 3900, and
dr is the incremental change in the radius of the expandable tubular member.

Equation 6.1 simplifies to the following equation:

$$\frac{ⅆ}{ⅆ r} ( {σ}_{S} \cdot r \cdot h ) - {σ}_{t} \cdot h ( 1 + μ \cdot cot ( α ) ) = 0 \qquad ( equation 6.2 )$$

wherein,
σₛ is a longitudinal stress in the expandable tubular member 4000,
r is the radius of the expandable tubular member 4000,
h is the thickness of the expandable tubular member 4000,
σₜ is a tangential stress in the expandable tubular member 4000,
μ is the coefficient of friction between the expansion device 3900 and the expandable tubular member 4000,
α is the expansion surface angle of the expansion device 3900, and
dr is the incremental change in the radius of the expandable tubular member 4000.

A variable k is defined by the following equation:
k=1+μ·cot(α) (equation 6.3)
wherein,
μ is the coefficient of friction between the expansion device 3900 and the expandable tubular member 4000, and
α is the expansion surface angle of the expansion device 3900.

Equations 6.2 and 6.3 result in the following equation:

$$r \cdot \frac{ⅆ}{ⅆ r} {σ}_{S} ( r ) + \frac{r}{h ( r )} \cdot {σ}_{S} ( r ) \cdot \frac{ⅆ}{ⅆ r} h ( r ) + {σ}_{S} ( r ) - k \cdot {σ}_{t} = 0 \qquad ( equation 6.4 )$$

wherein,
r is the radius of the expandable tubular member 4000,
σₛ(r) is a longitudinal stress in the expandable tubular member 4000 and is a function of the radius of the expandable tubular member 4000,
h(r) is the thickness of the expandable tubular member 4000 and is a function of the radius of the expandable tubular member 4000,
σₜ is a tangential stress in the expandable tubular member 4000,
dr is the incremental change in the radius of the expandable tubular member 4000, and
k=1+μcot(α), where μ is the coefficient of friction between the expansion device 3900 and the expandable tubular member 4000 and α is the expansion surface angle of the expansion device 3900.

The strain increments in the normal/radial and circumferential directions in the expandable tubular member 4000 are given by the following equations:

$$d {ɛ}_{r} = \frac{dh}{h} \qquad ( equation 7.1 )$$

wherein,

dεᵣ is the incremental change in the radial strain in the expandable tubular member 4000,

dh is the incremental change in the thickness of the expandable tubular member 4000, and

h is the thickness of the expandable tubular member 4000.
and

$$d {ɛ}_{t} = \frac{dr}{r} \qquad ( equation 7.2 )$$

wherein,
dεₜ is the incremental change in the tangential strain in the expandable tubular member 4000,
dr is the incremental change in the radius of the expandable tubular member 4000, and
r is the radius of the expandable tubular member 4000.

Substituting equation 7.1 and equation 7.2 into equation 6.4 results in the following equation:

$$r \cdot \frac{ⅆ}{ⅆ r} {σ}_{S} ( r ) + \frac{ⅆ {ɛ}_{r}}{ⅆ {ɛ}_{t}} \cdot {σ}_{S} ( r ) + {σ}_{S} ( r ) - k \cdot {σ}_{t} = 0 \qquad ( equation 8 )$$

wherein,

r is the radius of the expandable tubular member 4000,

dr is the incremental change in the radius of the expandable tubular member 4000,

σₛ(r) is a longitudinal stress in the expandable tubular member 4000 and is a function of the radius of the expandable tubular member 4000,

dεᵣ is the incremental change in the radial strain in the expandable tubular member 4000,

dεₜ is the incremental change in the tangential strain in the expandable tubular member 4000,

σₜ is a tangential stress in the expandable tubular member 4000, and

k=1+μcot(α), where μ is the coefficient of friction between the expansion device 3900 and the expandable tubular member 4000 and α is the expansion surface angle of the expansion device 3900.

The associated flow rule is give by the following equation:

$$d {ɛ}_{ij}^{< p >} = \frac{3}{2} \cdot \frac{{( \overline{d {ɛ}_{i}} )}^{< p >}}{{σ}_{i}} \cdot {s}_{ij} \qquad ( equation 9 )$$

which, in coordinate form, is the following equation:

$$d {ɛ}_{m} = \frac{\overline{d {ɛ}_{i}}}{2 \cdot {σ}_{i}} \cdot ( 2 \cdot {σ}_{S} - {σ}_{t} ) \qquad ( equation 10.1 )$$

wherein,
dεₘ is the incremental change in the axial strain in the expandable tubular member 4000,
dεᵢ is the incremental change in the mean value of the strain in the expandable tubular member 4000,
σᵢ is a mean stress in the expandable tubular member 4000,
σₛ is a longitudinal stress in the expandable tubular member 4000, and
σₜ is a tangential stress in the expandable tubular member 4000.
and the following equation:

$$d {ɛ}_{t} = \frac{\overline{d {ɛ}_{i}}}{2 \cdot {σ}_{i}} \cdot ( 2 \cdot {σ}_{t} - {σ}_{S} ) \qquad ( equation 10.2 )$$
wherein,
dεₜ is the incremental change in the tangential strain in the expandable tubular member 4000,
dε₁ is the incremental change in the mean value of the strain in the expandable tubular member 4000,
σᵢ is a mean stress in the expandable tubular member 4000,
σₛ is a longitudinal stress in the expandable tubular member 4000, and
σₜ is a tangential stress in the expandable tubular member 4000.
and the following equation:

$$d {ɛ}_{r} = - \frac{\overline{d {ɛ}_{i}}}{2 \cdot {σ}_{i}} \cdot ( {σ}_{S} + {σ}_{t} ) \qquad ( equation 10.3 )$$
wherein,
dεᵣ is the incremental change in the radial strain in the expandable tubular member 4000,
dεᵢ is the incremental change in the mean value of the strain in the expandable tubular member 4000,
σᵢ is a mean stress in the expandable tubular member 4000,
σₛ is a longitudinal stress in the expandable tubular member 4000, and
σₜ is a tangential stress in the expandable tubular member 4000.

Using equation 10.2 and equation 10.3 results in the following equation:

$$\frac{ⅆ {ɛ}_{r}}{ⅆ {ɛ}_{t}} = - \frac{{σ}_{S} + {σ}_{t}}{( 2 \cdot {σ}_{t} - {σ}_{S} )} \qquad ( equation 11 )$$

wherein,
dεᵣ is the incremental change in the radial strain in the expandable tubular member 4000,
dεₜ is the incremental change in the tangential strain in the expandable tubular member 4000,
σₛ is a longitudinal stress in the expandable tubular member 4000, and
σₜ is a tangential stress in the expandable tubular member 4000.

Substituting equation 11 into equation 8 results in the following equation:

$$r \cdot \frac{ⅆ}{ⅆ r} {σ}_{S} ( r ) - \frac{{σ}_{S} ( r ) + {σ}_{t} ( r )}{2 \cdot {σ}_{t} ( r ) - {σ}_{S} ( r )} \cdot {σ}_{S} ( r ) + {σ}_{S} ( r ) - k \cdot {σ}_{t} ( r ) = 0 \qquad ( equation 12 )$$

wherein,
r is the radius of the expandable tubular member 4000,
dr is the incremental change in the radius of the expandable tubular member 4000,
σₛ(r) is a longitudinal stress in the expandable tubular member 4000 and is a function of the radius of the expandable tubular member 4000,
σₜ(r) is a tangential stress in the expandable tubular member 4000 and is a function of the radius of the expandable tubular member 4000, and
k=1+μcot(α), where μ is the coefficient of friction between the expansion device 3900 and the expandable tubular member 4000 and α is the expansion surface angle of the expansion device 3900.

Von Mises condition has the form of the following equation:
σ_{S}²−σ_{S}·σₜ+σₜ²=σ_{T}² (equation 13)
wherein,
σₛ is a longitudinal stress in the expandable tubular member 4000, and
σₜ(r) is a tangential stress in the expandable tubular member 4000.

We seek a solution in the form:

$${σ}_{S} ( r ) = \frac{2}{\sqrt{3}} \cdot {σ}_{T} \cdot cos ( ψ ( r ) ) \qquad ( equation 14.1 )$$

wherein,
σₛ(r) is a longitudinal stress in the expandable tubular member 4000 and is a function of the radius of the expandable tubular member 4000,
σ_{T} is a tangential stress in the expandable tubular member 4000 given by the Von Mises condition in equation 13 and is a function of stresses in the expandable tubular member 4000, and
ψ(r) is a function which is a function of the radius of the expandable tubular member 4000.
and

$${σ}_{t} ( r ) = \frac{2}{\sqrt{3}} \cdot {σ}_{T} \cdot cos ( ψ ( r ) - \frac{π}{3} ) \qquad ( equation 14.2 )$$
wherein,
σₜ(r) is a tangential stress in the expandable tubular member 4000 and is a function of the radius of the expandable tubular member 4000,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.

Substituting equation 14.1 and equation 14.2 into equation 13 to check gives us the following equation:

$${( \frac{2}{\sqrt{3}} \cdot {σ}_{T} \cdot cos ( ψ ) )}^{2} - \frac{2}{\sqrt{3}} \cdot {σ}_{T} \cdot cos ( ψ ) \cdot ( \frac{2}{\sqrt{3}} \cdot {σ}_{T} \cdot cos ( ψ - \frac{π}{3} ) ) + {( \frac{2}{\sqrt{3}} \cdot {σ}_{T} \cdot cos ( ψ - \frac{π}{3} ) )}^{2} = • \qquad ( equation 14.3 )$$

wherein,
σ_{T} is a stress in the expandable tubular member 4000 given by the Von Mises condition in equation 13 and is a function of stresses in the expandable tubular member 4000, and
ψ is a function which is a function of the radius of the expandable tubular member 4000.

Equation 14.3 simplifies to following equation, confirming we seek the correct form:
σ_{T}²·cos(Ψ)+σ_{T}²·sin(ψ)²=σ_{T}² (equation 14.4)
wherein,
σ_{T} is a stress in the expandable tubular member 4000 given by the Von Mises condition in equation 13 and is a function of stresses in the expandable tubular member 4000, and
ψ is a function which is a function of the radius of the expandable tubular member 4000.

Assuming the expandable tubular member 4000 is a weightless hanging tube results in the following equations:
σ_{S}(r)≧0 (equation 15.1)
wherein,
σₛ(r) is a longitudinal stress in the expandable tubular member 4000 and is a function of the radius of the expandable tubular member 4000.
   and
   σₜ(r)≧0 (equation 15.2)
wherein,
σₜ(r) is a tangential stress in the expandable tubular member 4000 and is a function of the radius of the expandable tubular member 4000.
and

$$\frac{π}{2} \leq ψ ( r ) \leq \frac{5 \cdot π}{6} \qquad ( equation 15.3 )$$
wherein,
ψ(r) is a function which is a function of the radius of the expandable tubular member 4000.

Substituting equation 14.1 and equation 14.2 into equation 12 results in the following equation:

$$r \cdot \frac{ⅆ}{ⅆ r} ( \frac{2}{\sqrt{3}} \cdot {σ}_{T} \cdot cos ( ψ ( r ) ) ) = \frac{- 2}{\sqrt{3}} \cdot r \cdot {σ}_{T} \cdot sin ( ψ ( r ) ) \cdot \frac{ⅆ}{ⅆ r} ψ ( r ) \qquad ( equation 16.1 )$$

which is the [r*(d/dr)*σₛ(r)] of equation 12, and wherein,
r is the radius of the expandable tubular member 4000,
dr is the incremental change in the radius of the expandable tubular member 4000,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.
and

$$\frac{\begin{matrix}\frac{2}{\sqrt{3}} \cdot {σ}_{T} \cdot cos ( ψ ( r ) ) + \\ \frac{2}{ \sqrt{3}} \cdot {σ}_{ T} \cdot cos ( ψ ( r ) - \frac{π}{ 3} )\end{matrix}}{\begin{matrix}2 \cdot \frac{2}{\sqrt{3}} \cdot {σ}_{T} \cdot cos ( ψ ( r ) - \frac{π}{3} ) - \\ \frac{2}{\sqrt{3}} \cdot {σ}_{T} \cdot cos ( ψ ( r ) )\end{matrix}} = \frac{\sqrt{3} \cdot cos ( ψ ( r ) ) + sin ( ψ ( r ) )}{2 \cdot sin ( ψ ( r ) )} \qquad ( equation 16.2 )$$
which is the [(σₛ(r)+σₜ(r))/(2 σₜ(r)−σₛ(r))] of equation 12, and wherein,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.

Equations 16.1 and 16.2 and the rest of equation 12 simplify to the following equation:

$$[ \begin{matrix}\begin{matrix}\begin{matrix}\frac{- 2}{\sqrt{3}} \cdot r \cdot {σ}_{T} \cdot sin ( ψ ( r ) ) \cdot \frac{ⅆ ψ}{ⅆ r} + \\ \frac{ \sqrt{3} \cdot cos ( ψ ( r ) ) + sin ( ψ ( r ) )}{2 \cdot sin ( ψ ( r ) )} \cdot \end{matrix} \\ ( \frac{2}{\sqrt{3}} \cdot {σ}_{T} \cdot cos ( ψ ( r ) ) ) + • … +\end{matrix} \\ \frac{2}{\sqrt{3}} \cdot {σ}_{T} \cdot cos ( ψ ( r ) ) - k \cdot \frac{2}{\sqrt{3}} \cdot {σ}_{T} \cdot cos ( ψ ( r ) - \frac{π}{3} )\end{matrix} ] 0 \qquad ( equation 16.3 )$$

wherein,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.

Equation 16.3 simplifies to the following equation:

$$\frac{d r}{r} = \frac{2 \cdot {tan ( ψ ( r ) )}^{2} \cdot d ψ}{\begin{matrix}- \sqrt{3} + ( 1 - k ) \cdot tan ( ψ ( r ) ) - \\ \sqrt{3} \cdot k \cdot {tan ( ψ ( r ) )}^{2}\end{matrix}} \qquad ( equation 16.4 )$$

wherein,
r is the radius of the expandable tubular member 4000,
dr is the incremental change in the radius of the expandable tubular member 4000,
ψ(r) is a function which is a function of the radius of the expandable tubular member 4000,
   and
dψ is the incremental change in the function ψ(r).

Boundary conditions given by the following equations:
r=r_{f} (equation 17.1)
wherein,
r is the radius of the expandable tubular member 4000, and
r_{f} is the final expanded radius of the expandable tubular member 4000.
   and
   σ_{S}(r_{f})=0 (equation 17.2)
wherein,
σₛ(r_{f}) is a longitudinal stress in the expandable tubular member 4000 and is a function of the final expanded radius of the expandable tubular member 4000.
and

$$ψ ( {r}_{f} ) = \frac{π}{2} \qquad ( equation 17.3 )$$
wherein,
ψ(r) is a function which is a function of the final expanded radius of the expandable tubular member 4000.
and

$$\frac{ {σ}_{t} ( r )}{ {σ}_{T}} = 1 \qquad ( equation 17.4 )$$
wherein,
σₜ(r) is a tangential stress in the expandable tubular member 4000 and is a function of the radius of the expandable tubular member 4000, and
σ_{T} is a stress in the expandable tubular member 4000 given by the Von Mises condition in equation 13 and is a function of stresses in the expandable tubular member 4000.

A finite difference scheme can be used to solve equation 16.4 and results in the following equation:

$$\frac{{r}_{i 1} - {r}_{i}}{{r}_{i}} = \frac{2 \cdot {tan ( {ψ}_{i} )}^{2} \cdot ( {ψ}_{i 1} - {ψ}_{i} )}{- \sqrt{3} + ( 1 - k ) \cdot tan ( {ψ}_{i} ) - \sqrt{3} \cdot k \cdot {tan ( {ψ}_{i} )}^{2}} \qquad ( equation 18 )$$

wherein,
k=1+μcot(α), where μ is the coefficient of friction between the expansion device 3900 and the expandable tubular member 4000 and α is the expansion surface angle of the expansion device 3900.

ψᵢ₁ is given by the following equation:

$${ψ}_{i 1} = {ψ}_{i} + \frac{1}{2} \cdot \frac{( \frac{ {r}_{ i 1}}{ {r}_{ i}} - 1 )}{ {tan ( {ψ}_{ i} )}^{2}} \cdot ( \begin{matrix}- \sqrt{3} + tan ( {ψ}_{i} ) - tan ( {ψ}_{i} ) \cdot \\ k - \sqrt{3} \cdot k \cdot {tan ( {ψ}_{i} )}^{2}\end{matrix} ) \qquad ( equation 19 )$$

wherein,
k=1+μcot(α), where μ is the coefficient of friction between the expansion device 3900 and the expandable tubular member 4000 and α is the expansion surface angle of the expansion device 3900.

Introducing the following equations:

$${S}_{s} = \frac{{σ}_{s}}{{σ}_{T}}$$

(equation 20.1)
wherein,
σₛ is a longitudinal stress in the expandable tubular member 4000, and
σ_{T} is a stress in the expandable tubular member 4000 given by the Von Mises condition in equation 13 and is a function of stresses in the expandable tubular member 4000.
and

$${S}_{t} = \frac{{σ}_{t}}{{σ}_{T}} \qquad ( equation 20.2 )$$
wherein,
σₜ is a tangential stress in the expandable tubular member 4000, and
σ_{T} is a stress in the expandable tubular member 4000 given by the Von Mises condition in equation 13 and is a function of stresses in the expandable tubular member 4000.
and

$$R = \frac{r}{{r}_{f}} \qquad ( equation 20.3 )$$
wherein,
r is the radius of the expandable tubular member 4000, and
r_{f} is the final expanded radius of the expandable tubular member 4000.

Using the following data:

friction coefficient μ=0.1

expansion surface angle α=22.5 degrees

initial radius rᵢ=90.10/2 mm

final radius r_{f}=115/2 mm

exp=r_{f}/rᵢ=1.276

R_{f}=1

Rᵢ=R_{f}/exp=0.783

N=100

and k was defined by the following equation:
k(α):=1+μ·cot(α) (equation 21.1)
wherein,
μ is the coefficient of friction between the expansion device 3900 and the expandable tubular member 4000, and
α is the expansion surface angle of the expansion device 3900.

The following values of i result in the following equation:
i: 0 . . . N−1

$${ψ}_{i + 1} := {ψ}_{i} + \frac{1}{2} \cdot \frac{( \frac{{R}_{i + 1}}{{R}_{i}} - 1 )}{tan {( {ψ}_{i} )}^{2}} \cdot ( - \sqrt{3} + tan ( {ψ}_{i} ) - tan ( {ψ}_{i} ) \cdot k ( α ) - \sqrt{3} \cdot k ( α ) \cdot tan {( {ψ}_{i} )}^{2} ) \qquad ( equation 21.2 )$$

wherein,
k=1+μcot(α), where μ is the coefficient of friction between the expansion device 3900 and the expandable tubular member 4000 and α is the expansion surface angle of the expansion device 3900, and
Rᵢ is a function of the variable radius of the expandable tubular member 4000 and the final expanded radius of the expandable tubular member 4000a.

The following values of i result in the following equation:

$$i := 0 … N \\ {R}_{i} := {R}_{f} - i \cdot \frac{{R}_{f} - {R}_{i}}{N} \qquad ( equation 21.3 )$$

when ψ₀=π/2, and wherein,

Rᵢ is a function of the variable radius of the expandable tubular member 4000 and the final expanded radius of the expandable tubular member 4000.

The following values of i result in the following equation:
i:=0 . . . N

$${S}_{{s}_{i}} := \frac{2}{\sqrt{3}} \cdot cos ( {ψ}_{i} ) \qquad ( equation 21.4 )$$

wherein,

ψᵢ is a function which is a function of the final expanded radius of the expandable tubular member 4000.
and

$${S}_{{t}_{i}} := \frac{2}{\sqrt{3}} \cdot cos ( {ψ}_{i} - \frac{π}{3} ) \qquad ( equation 21.5 )$$

wherein,

ψᵢ is a function which is a function of the final expanded radius of the expandable tubular member 4000.

The distribution of normalized meridional and circumferential stresses in the expandable tubular member 4000 is given by the following graph: [image]
wherein,
Sₛᵢ is a function given by equation 21.4, Sₜᵢ is a function given by equation 21.5, and
Rᵢ is a function of the variable radius of the expandable tubular member 4000 and the final expanded radius of the expandable tubular member 4000.

We can now determine the change in the expandable tubular member thickness h upon radial expansion and plastic deformation by the expansion device 3900 using the following equation:

$$r \cdot \frac{ⅆ {σ}_{s}}{ⅆ r} + \frac{r}{h} \cdot {σ}_{s} \cdot \frac{ⅆ h}{ⅆ r} + {σ}_{s} - k \cdot {σ}_{t} = 0 \qquad ( equation 22.1 )$$

wherein,
r is the radius of the expandable tubular member 4000,
dσₛ is the incremental change in the longitudinal stress σₛ in the expandable tubular member 4000,
dr is the incremental change in the radius of the expandable tubular member 4000,
h is the thickness of the expandable tubular member,
σₛ is a longitudinal stress in the expandable tubular member 4000,
dh is the incremental change in the thickness of the expandable tubular member 4000,
k=1+μcot(α), where μ is the coefficient of friction between the expansion device 3900 and the expandable tubular member 4000 and α is the expansion surface angle of the expansion device 3900, and
σₜ is a tangential stress in the expandable tubular member 4000.

Equation 22.1 may be modified get the following equation:

$$r \cdot \frac{ⅆ {σ}_{s}}{ⅆ h} \cdot \frac{ⅆ h}{ⅆ r} + \frac{r}{h} \cdot {σ}_{s} \cdot \frac{ⅆ h}{ⅆ r} + {σ}_{s} - k \cdot {σ}_{t} = 0 \qquad ( equation 22.2 )$$

wherein,
r is the radius of the expandable tubular member 4000,
dσₛ is the incremental change in the longitudinal stress σₛ in the expandable tubular member 4000,
dr is the incremental change in the radius of the expandable tubular member 4000,
h is the thickness of the expandable tubular member,
σₛ is a longitudinal stress in the expandable tubular member 4000,
dh is the incremental change in the thickness of the expandable tubular member 4000, and
k=1+μcot(α), where μ is the coefficient of friction between the expansion device 3900 and the expandable tubular member 4000 and α is the expansion surface angle of the expansion device 3900, and σₜ is a stress in the expandable tubular member 4000.

Equation 22.2 may be modified to get the following equation:

$$\frac{r}{dr} \cdot \frac{dh}{h} \cdot \frac{ⅆ {σ}_{s}}{ⅆ h} \cdot h + \frac{r}{dr} \cdot \frac{dh}{h} \cdot {σ}_{s} + {σ}_{s} - k \cdot {σ}_{t} = 0 \qquad ( equation 22.3 )$$

wherein,
r is the radius of the expandable tubular member 4000,
dσₛ is the incremental change in the longitudinal stress σₛ in the expandable tubular member 4000,
dr is the incremental change in the radius of the expandable tubular member 4000,
h is the thickness of the expandable tubular member,
σₛ is a longitudinal stress in the expandable tubular member 4000,
dh is the incremental change in the thickness of the expandable tubular member 4000,
k=1+μcot(α), where μ is the coefficient of friction between the expansion device 3900 and the expandable tubular member 4000 and α is the expansion surface angle of the expansion device 3900, and
σₜ is a tangential stress in the expandable tubular member 4000.

Using equation 7.1, equation 7.2, equation 10.1, equation 10.2, equation 10.3, and equation 11 results in following equation:

$$\frac{r}{dr} \cdot \frac{dh}{h} = \frac{{σ}_{s} + {σ}_{t}}{( 2 \cdot {σ}_{t} - {σ}_{s} )} \qquad ( equation 22.4 )$$

wherein,
r is the radius of the expandable tubular member 4000,
dr is the incremental change in the radius of the expandable tubular member 4000,
h is the thickness of the expandable tubular member,
σₛ is a longitudinal stress in the expandable tubular member 4000,
dh is the incremental change in the thickness of the expandable tubular member 4000, and
σₜ is a tangential stress in the expandable tubular member 4000.

Equation 22.4 can be expanded to give the following equation:

$$\begin{matrix}[ - 1 \cdot \frac{{σ}_{s} + {σ}_{t}}{( 2 \cdot {σ}_{t} - {σ}_{s} )} \cdot \frac{ⅆ {σ}_{s}}{ⅆ h} \cdot h - \frac{{σ}_{s} + {σ}_{t}}{( 2 \cdot {σ}_{t} - {σ}_{s} )} \cdot {σ}_{s} ] + \\ {σ}_{s} - k \cdot {σ}_{t} = 0\end{matrix} cos ( ψ - \frac{π}{3} ) \qquad ( equation 22.5 )$$

wherein,
dσₛ is the incremental change in the longitudinal stress σₛ in the expandable tubular member 4000,
h is the thickness of the expandable tubular member,
σₛ is a longitudinal stress in the expandable tubular member 4000,
dh is the incremental change in the thickness of the expandable tubular member 4000,
k=1+μcot(α), where μ is the coefficient of friction between the expansion device 3900 and the expandable tubular member 4000 and α is the expansion surface angle of the expansion device 3900, and
σₜ is a tangential stress in the expandable tubular member 4000.

Equation 22.5 may be simplified to give the following equation:

$$- 1 \cdot \frac{{σ}_{s} + {σ}_{t}}{( 2 \cdot {σ}_{t} - {σ}_{s} )} \cdot \frac{ⅆ {σ}_{s}}{ⅆ h} \cdot h - \frac{{σ}_{s} + {σ}_{t}}{( 2 \cdot {σ}_{t} - {σ}_{s} )} \cdot {σ}_{s} + {σ}_{s} - k \cdot {σ}_{t} = 0 \qquad ( equation 22.6 )$$

wherein,
dσₛ is the incremental change in the longitudinal stress σₛ in the expandable tubular member 4000,
h is the thickness of the expandable tubular member,
σₛ is a longitudinal stress in the expandable tubular member 4000,
dh is the incremental change in the thickness of the expandable tubular member 4000,
k=1+μcot(α), where μ is the coefficient of friction between the expansion device 3900 and the expandable tubular member 4000 and α is the expansion surface angle of the expansion device 3900, and
σₜ is a tangential stress in the expandable tubular member 4000.

Equation 22.6 may be expanded to give the following equation:

$$\begin{matrix}[ \frac{( cos ( ψ ) + sin ( ψ + \frac{1}{6} \cdot π ) )}{( 2 \cdot sin ( ψ + \frac{1}{6} \cdot π ) - cos ( ψ ) )} \cdot sin ( ψ ) \cdot \frac{ⅆ ψ}{ⅆ h} \cdot h - \\ \frac{( cos ( ψ ) + sin ( ψ + \frac{1}{6} \cdot π ) )}{( 2 \cdot sin ( ψ + \frac{1}{6} \cdot π ) - cos ( ψ ) )} \cdot cos ( ψ ) ] … = 0\end{matrix} \\ + cos ( ψ ) - k \cdot sin ( ψ + \frac{1}{6} \cdot π ) \qquad ( equation 22.7 )$$

wherein,
h is the thickness of the expandable tubular member,
ψ is a function which is a function of the final expanded radius of the expandable tubular member 4000,
dψ is the incremental change in the function ψ,
dh is the incremental change in the thickness of the expandable tubular member 4000, and
k=1+μcot(α), where μ is the coefficient of friction between the expansion device 3900 and the expandable tubular member 4000 and α is the expansion surface angle of the expansion device 3900.

Equation 22.7 may be simplified to give the following equation:

$$\frac{dh}{h} = \frac{( - \sqrt{3} \cdot cos ( ψ ) \cdot sin ( ψ ) - {sin ( ψ )}^{2} )}{\begin{matrix}( - \sqrt{3} \cdot {cos ( ψ )}^{2} + cos ( ψ ) \cdot sin ( ψ ) - \\ k \cdot {sin ( ψ )}^{2} \cdot \sqrt{3} - k cos ( ψ ) \cdot sin ( ψ ) )\end{matrix}} \cdot d ψ \qquad ( equation 22.8 )$$

wherein,
h is the thickness of the expandable tubular member,
ψ is a function which is a function of the final expanded radius of the expandable tubular member 4000,
dψ is the incremental change in the function ψ,
dh is the incremental change in the thickness of the expandable tubular member 4000, and
k=1+μcot(α), where μ is the coefficient of friction between the expansion device 3900 and the expandable tubular member 4000 and α is the expansion surface angle of the expansion device 3900.

Equation 22.8 may be simplified to give the following equation:

$$\frac{dh}{h} = - 1 \cdot \frac{tan ( ψ ( r ) ) \cdot ( tan ( ψ ( r ) ) + \sqrt{3} ) \cdot d ψ}{\begin{matrix}- \sqrt{3} + ( 1 - k ( α ) ) \cdot tan ( ψ ( r ) ) - \\ \sqrt{3} \cdot k ( α ) \cdot {tan ( ψ ( r ) )}^{2}\end{matrix}} \qquad ( equation 22.9 )$$

wherein,
h is the thickness of the expandable tubular member,
ψ is a function which is a function of the final expanded radius of the expandable tubular member 4000,
dψ is the incremental change in the function ψ,
dh is the incremental change in the thickness of the expandable tubular member 4000, and
k=1+μcot(α), where μ is the coefficient of friction between the expansion device 3900 and the expandable tubular member 4000 and α is the expansion surface angle of the expansion device 3900.

Boundary conditions result in the following equations:
h(r_{f})=hᵢ (equation 23.1)
wherein,
h(r_{f}) is the thickness of the expandable tubular member 4000 at the final expansion radius of the expandable tubular member 4000.
and

$$H = \frac{h}{{h}_{i}} \qquad ( equation 23.2 )$$
wherein,
h is the thickness of the expandable tubular member 4000, and
hᵢ is the thickness of the expandable tubular member 4000 given by equation 23.1.
   and

Hᵢ=1 (equation 23.3)
wherein,
Hᵢ is a combination of equations 23.1 and 23.2.
   and
   H₀:=1 (equation 23.4)

Ranging values of i as follows:
i:=0 . . . N−1
results in the following equation:

$${H}_{i + 1} := {H}_{i} - {H}_{i} \cdot \frac{tan ( {ψ}_{i} ) \cdot ( tan ( {ψ}_{i} ) + \sqrt{3} ) \cdot ( {ψ}_{i + 1} - {ψ}_{i} )}{\begin{matrix}- \sqrt{3} + ( 1 - k ( α ) ) \cdot tan ( {ψ}_{i} ) - \\ \sqrt{3} \cdot k ( α ) \cdot {tan ( {ψ}_{i} )}^{2}\end{matrix}} \qquad ( equation 23.5 )$$

wherein,
ψ is a function which is a function of the final expanded radius of the expandable tubular member 4000,
α is the expansion surface angle of the expansion device 3900, and
k=1+μcot(α), where μ is the coefficient of friction between the expansion device 3900 and the expandable tubular member 4000 and α is the expansion surface angle of the expansion device 3900.

Equation 23.5 results in the following graph: [image]
wherein
Hᵢ is given by equation 23.5 and Rᵢ is given by equation 21.3.

We can now determine the pressure needed for the expansion device 3900 to have steady state radial expansion and plastic deformation of the expandable tubular member 4000 using the following equation:

$$P = \frac{[ {( {r}_{pig} + {h}_{f} )}^{2} - {r}_{pig}^{2} ] \cdot {σ}_{s}}{{r}_{pig}^{2}} \qquad ( equation 24.1 )$$

wherein,
P is the pressure needed for steady state radial expansion and plastic deformation of the expandable tubular member 4000,
r_{pig} is defined as the radius of the expansion device 3900,
h_{f} is the final thickness of the expanded expandable tubular member 4000, and
σₛ is a longitudinal stress in the expandable tubular member 4000.

Using the following experimental data, where OD is defined as the outside diameter of the expandable tubular member 4000 an ID is defined as the inside diameter of the expandable tubular member 4000, we can estimate the pressure to propagate the expandable tubular member 4000:

| | |
|---|---|
| OD: = 50.8 · 2 · mm | OD = 4 · in |

wherein,
OD is the outside diameter of the expandable tubular member 4000.

and

| | |
|---|---|
| ID: = 90.10 · mm | ID = 3.547 · in |

wherein,
ID is the inside diameter of the expandable tubular member 4000.
and

$$\begin{matrix}{h}_{i} := \frac{OD - ID}{2} & {h}_{i} = 0.226 \cdot in & {h}_{i} = 5.75 \cdot mm \\ {σ}_{T} := 46500 \cdot psi & {σ}_{T} = 320.606 \cdot \frac{newton}{{mm}^{2}} & \end{matrix}$$
wherein,
σ_{T} is a stress in the expandable tubular member 4000 given by the Von Mises condition in equation 13 and is a function of stresses in the expandable tubular member 4000.
   and
   D_{pig}:=115·mm
wherein,
D_{pig} is the diameter of the expansion device 3900.

Determining the pressure to propagate the expansion device 3900 may be accomplished with the following equation:

$$p = \frac{P}{{σ}_{T}} \qquad ( equation 24.2 )$$

wherein,
P is the pressure needed for steady state radial expansion and plastic deformation of the expandable tubular member 4000, and
σ_{T} is a stress in the expandable tubular member 4000 given by the Von Mises condition in equation 13 and is a function of stresses in the expandable tubular member 4000.

The propagation pressure may then be determined with the following equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}} \\ p = - 0.07 \qquad ( equation 24.3 )$$

wherein,
p is the pressure needed to propagate the expansion device 3900 and D_{pig} is the diameter of the expansion device 3900.

The formula for the burst pressure is given by the following equation:

$${P}_{bur} = \frac{1.75 \cdot {h}_{f} \cdot {σ}_{T}}{{OD}_{f}} \qquad ( equation 25.1 )$$

wherein,
P_{bur} is the burst pressure of the expandable tubular member 4000,
h_{f} is the thickness of the expandable tubular member 4000 upon burst,
σ_{T} is a stress in the expandable tubular member 4000 given by the Von Mises condition in equation 13 and is a function of stresses in the expandable tubular member 4000, and
OD_{f} is the final outside diameter of the expandable tubular member 4000.

The burst pressure may also be determined by the following equation:

$${p}_{bur} = \frac{{P}_{bur}}{{σ}_{T}} \qquad ( equation 25.2 )$$

wherein,
P_{bur} is the burst pressure of the expandable tubular member 4000, and
σ_{T} is a stress in the expandable tubular member 4000 given by the Von Mises condition in equation 13 and is a function of stresses in the expandable tubular member 4000.

Estimating the burst pressure gives us the following equation:

$${p}_{bur} := \frac{1.75 \cdot {h}_{i} \cdot {H}_{100}}{( {D}_{pig} + 2 \cdot {h}_{i} \cdot {H}_{100} )} \\ {p}_{bur} = 0.087 \qquad ( equation 25.3 )$$

wherein,
P_{bur} is the burst pressure of the expandable tubular member 4000, and
D_{pig} is the diameter of the expansion device 3900.

The design coefficient for burst is given by the following equation:

$${c}_{bur} := \frac{{P}_{bur}}{p} \\ {c}_{bur} = - 1.245 \qquad ( equation 26 )$$

wherein,
p_{bur} is the burst pressure of the expandable tubular member 4000, and
p is the pressure needed to propagate the expansion device 3900.

The force required to radially expand and plastically deform the expandable tubular member 4000 with the expansion device 3900 may be determined by using the following equation:

$${F}_{exp} := p \cdot {σ}_{T} \cdot \frac{π \cdot {( {D}_{pig} )}^{2}}{4} \\ {F}_{exp} = - 231.782 \cdot kN \qquad ( equation 27.1 )$$

wherein,
Fₑₓₚ is the expansion force needed to radially expand and plastically deform the expandable tubular member 4000,
p is the pressure needed to propagate the expansion device 3900,
σ_{T} is a stress in the expandable tubular member 4000 given by the Von Mises condition in equation 13 and is a function of stresses in the expandable tubular member 4000, and
D_{pig} is the diameter of the expansion device 3900.

The pressure required to radially expand and plastically deform the expandable tubular member 4000 with the expansion device 3900 may be determined by the following equation:

$$π \cdot {r}_{f}^{2} \cdot p = 2 \cdot π \cdot {\int }_{{r}_{i}}^{{r}_{f}} ( {p}_{n} ( r ) \cdot sin ( α ) + τ ( r ) \cdot cos ( α ) ) \cdot \frac{r}{sin ( α ) \cdot cos ( α )} ⅆ r \qquad ( equation 27.2 )$$

wherein,
rᵢ is the initial radius of the expandable tubular member 4000,
p is the pressure needed to propagate the expansion device 3900,
r is the radius of the expandable tubular member 4000,
r_{f} is the final expanded radius of the expandable tubular member 4000,
pₙ(r) is the normal force on the expandable tubular member 4000 and is a function of the radius r of the expandable tubular member 4000,
τ is the shear stress on the expansion device 3900 and is a function of the radius r of the expandable tubular member 4000,
α is the expansion surface angle of the expansion device 3900, and
dr is the incremental change in the radius of the expandable tubular member 4000.

The shear stress can be determined by the following equation:
τ=μ·pₙ (equation 27.3)
wherein,
τ is the shear stress on the expansion device 3900,
pₙ is the normal force on the expandable tubular member 4000, and
μ is the coefficient of friction between the expansion device 3900 and the expandable tubular member 4000.

The force needed to radially expand and plastically deform the expandable tubular member 4000 with the expansion device 3900 is given by the following equation:

$$F = 2 \cdot π \cdot {\int }_{{r}_{i}}^{{r}_{f}} ( {p}_{n} \cdot sin ( α ) + μ \cdot {p}_{n} \cdot cos ( α ) ) \cdot \frac{r}{sin ( α ) \cdot cos ( α )} ⅆ r \qquad ( equation 27.4 )$$

wherein,
rᵢ is the initial radius of the expandable tubular member 4000,
r_{f} is the final expanded radius of the expandable tubular member 4000,
pₙ is the normal force on the expandable tubular member 4000,
μ is the coefficient of friction between the expansion device 3900 and the expandable tubular member 4000,
α is the expansion surface angle of the expansion device 3900,
r is the radius of the expandable tubular member 4000, and
dr is the incremental change in the radius of the expandable tubular member 4000.

Equation 27.4 may be simplified to give the following equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} {p}_{n} \cdot r ⅆ r \qquad ( equation 27.5 )$$

wherein,
α is the expansion surface angle of the expansion device 3900,
μ is the coefficient of friction between the expansion device 3900 and the expandable tubular member 4000,
rᵢ is the initial radius of the expandable tubular member 4000,
r_{f} is the final expanded radius of the expandable tubular member 4000, pₙ is the normal force on the expandable tubular member 4000,
r is the radius of the expandable tubular member 4000, and
dr is the incremental change in the radius of the expandable tubular member 4000.

The normal force is given by the following equation:

$${p}_{n} = \frac{{σ}_{t} \cdot cos ( α )}{r} \cdot h \qquad ( equation 27.6 )$$

wherein,
pₙ is the normal force on the expandable tubular member 4000,
α is the expansion surface angle of the expansion device 3900,
r is the radius of the expandable tubular member 4000,
h is the thickness of the expandable tubular member 4000, and
σₜ is a tangential stress in the expandable tubular member 4000.

The force required to radially expand and plastically deform the expandable tubular member 4000 with the expansion device 3900 may be determined by using the following equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} \frac{{σ}_{t} \cdot cos ( α )}{r} \cdot h \cdot r ⅆ r \qquad ( equation 27.7 )$$

wherein,
α is the expansion surface angle of the expansion device 3900,
μ is the coefficient of friction between the expansion device 3900 and the expandable tubular member 4000,
rᵢ is the initial radius of the expandable tubular member 4000,
r_{f} is the final expanded radius of the expandable tubular member 4000,
σₜ is a tangential stress in the expandable tubular member 4000,
r is the radius of the expandable tubular member 4000,
h is the thickness of the expandable tubular member 4000, and
dr is the incremental change in the radius of the expandable tubular member 4000.

Equation 27.7 may be simplified to give the following equation:

$$F = 2 \cdot π \cdot \frac{sin ( α ) + μ \cdot cos ( α )}{sin ( α )} \cdot {\int }_{{r}_{i}}^{{r}_{f}} {σ}_{t} \cdot h ⅆ r \qquad ( equation 27.8 )$$

wherein,
α is the expansion surface angle of the expansion device 3900,
μ is the coefficient of friction between the expansion device 3900 and the expandable tubular member 4000,
rᵢ is the initial radius of the expandable tubular member 4000,
r_{f} is the final expanded radius of the expandable tubular member 4000,
σₜ is a tangential stress in the expandable tubular member 4000,
h is the thickness of the expandable tubular member 4000, and
dr is the incremental change in the radius of the expandable tubular member 4000.

Ranging i as follows results in the following equation:

$${F}_{0} := 0 \cdot newton \\ i := 0 … N - 1 \\ \begin{matrix}{F}_{i + 1} := {F}_{i} + 2 \cdot π \cdot \frac{sin ( α ) + μ \cdot cos ( α )}{sin ( α )} \cdot \frac{1}{2} \cdot {σ}_{T} \cdot {h}_{i} \cdot \\ \frac{ID}{2} \cdot ( {S}_{{t}_{i + 1}} \cdot {H}_{i + 1} \cdot {S}_{{t}_{i}} \cdot {H}_{i} ) \cdot ( {R}_{i + 1} - {R}_{i} )\end{matrix} \qquad ( equation 27.9 )$$

wherein,
α is the expansion surface angle of the expansion device 3900,
ID is the inside diameter of the expandable tubular member 4000, and
σ_{T} is a stress in the expandable tubular member 4000 given by the Von Mises condition in equation 13 and is a function of stresses in the expandable tubular member 4000.
   and the following result:
   F_{N}=−1.351·10⁵·kg·m·sec⁻² ID·R_{N}=70.591 ·mm

The propagation pressure burst design factor as a function of wall thickness may be determined given the following parameters:

M:=40 j:=0 . . . M

h₀:=0.1·in h_{M}:=0.8·in

Thicknesses of the expandable tubular member 4000 are given by the following equation:

$${h}_{j} := {h}_{0} + j \cdot \frac{{h}_{M} - {h}_{0}}{M} \qquad ( equation 28.1 )$$

The propagation pressure to radially expand and plastically deform the expandable tubular member may them be determined using the following equation:

$${p}_{j} := \frac{[ {( {D}_{pig} + 2 \cdot {h}_{j} \cdot {H}_{100} )}^{2} - {D}_{pig}^{2} ] \cdot {S}_{{s}_{100}}}{{D}_{pig}^{2}} \cdot {σ}_{T} \qquad ( equation 28.2 )$$

wherein,
p is the pressure needed to propagate the expansion device 3900,
D_{pig} is the diameter of the expansion device 3900, and
σ_{T} is a stress in the expandable tubular member 4000 given by the Von Mises condition in equation 13 and is a function of stresses in the expandable tubular member 4000.

The burst pressure of the expandable tubular member 4000 is given by the following equation:

$${p}_{{bur}_{j}} := \frac{1.75 \cdot {h}_{j} \cdot {H}_{100}}{( {D}_{pig} + 2 \cdot {h}_{j} \cdot {H}_{100} )} \cdot {σ}_{T} \qquad ( equation 28.3 )$$

wherein,
P_{burj} is the burst pressure of the expandable tubular member 4000,
D_{pig} is the diameter of the expansion device 3900, and
σ_{T} is a stress in the expandable tubular member 4000 given by the Von Mises condition in equation 13 and is a function of stresses in the expandable tubular member 4000.

Thus, the design coefficient for burst is given by the following equation:

$${c}_{{bur}_{j}} := \frac{{p}_{{bur}_{j}}}{{p}_{j}} \qquad ( equation 28.4 )$$

wherein,
p_{burj} is the burst pressure of the expandable tubular member 4000, and
c_{burj} is the burst coefficient of the expandable tubular member 4000.

The above equations result in the following graph: [image]
wherein,
p_{burj} is the burst pressure of the expandable tubular member 4000.

The above equations also result in the following graph: [image]
wherein,
c_{burj} is the burst coefficient of the expandable tubular member 4000.

Checking the Von Mises expanded tube gives us the following equation:

$${σ}_{{i}_{j}} := \sqrt{\begin{matrix}{( \frac{{p}_{j} \cdot {D}_{pig}}{2 \cdot {h}_{j}} )}^{2} - [ ( \frac{{p}_{j} \cdot {D}_{pig}}{2 \cdot {h}_{j}} ) \cdot \\ {S}_{{s}_{100}} \cdot {σ}_{T} + {( {S}_{{s}_{100}} \cdot {σ}_{T} )}^{2} ]\end{matrix}} \qquad ( equation 28.5 )$$

wherein,
D_{pig} is the diameter of the expansion device 3900, and
σ_{T} is a stress in the expandable tubular member 4000 given by the Von Mises condition in equation 13 and is a function of stresses in the expandable tubular member 4000.

Equation 28.5 gives us the following graph: [image]
wherein,
σ_{T} is a stress in the expandable tubular member 4000 given by the Von Mises condition in equation 13 and is a function of stresses in the expandable tubular member 4000.

Similar results to those obtained above can be produced as follows: If the coefficient of friction is μ, then the shear stress is given by the following equation:
τ=μ·pₙ (equation 2)
wherein,
τ is the shear stress on the expansion device 3900,
μ is the coefficient of friction between the expansion device 3900 and the expandable tubular member 4000, and
pₙ is the normal force on the expansion device 3900.

Assuming that the expandable tubular member 4000 is a thin walled tube, the thickness h is small enough to use a membrane approximation for the bending stiffness. The expandable tubular member 4000 will have the following equilibrium equation:

$$\frac{ⅆ}{ⅆ r} ( {σ}_{s} \cdot r \cdot h ) - {σ}_{t} \cdot h - \frac{τ \cdot r}{sin ( α )} = 0 \qquad ( equation 4 )$$

wherein,
σₛ is a stress in the expandable tubular member 4000,
r is the radius of the expandable tubular member 4000,
h is the thickness of the expandable tubular member 4000,
σₜ is a tangential stress in the expandable tubular member 4000,
τ is the shear stress on the expansion device 3900,
α is the expansion surface angle of the expansion device 3900, and
dr is the incremental change in the radius of the expandable tubular member 4000.

The expandable tubular member 4000 will also have the following equilibrium equation:

$$\frac{{σ}_{t} \cdot cos ( α )}{r} = \frac{{p}_{n}}{h} \qquad ( equation 5 )$$

wherein,
σₜ is a tangential stress in the expandable tubular member 4000,
α is the expansion surface angle of the expansion device 3900,
r is the radius of the expandable tubular member 4000,
pₙ is the normal force on the expandable tubular member 4000 and is a function of the expansion surface radius r of the expansion device 3900, and
h is the thickness of the expandable tubular member 4000.

Substituting equation 5 and equation 2 into equation 4 results in the following equation:

$$\frac{ⅆ}{ⅆ r} ( {σ}_{s} \cdot r \cdot h ) - {σ}_{t} \cdot h + μ \cdot {σ}_{t} \cdot cot ( α ) \cdot h = 0 \qquad ( equation 6.1 )$$

wherein,
σₛ is a longitudinal stress in the expandable tubular member 4000,
r is the radius of the expandable tubular member 4000,
h is the thickness of the expandable tubular member 4000,
σₜ is a tangential stress in the expandable tubular member 4000,
μ is the coefficient of friction between the expansion device 3900 and the expandable tubular member 4000,
α is the expansion surface angle of the expansion device 3900, and
dr is the incremental change in the radius of the expandable tubular member.

Equation 6.1 may be simplified to give the following equation:

$$\frac{ⅆ}{ⅆ r} ( {σ}_{s} \cdot r \cdot h ) - {σ}_{t} \cdot h ( 1 + μ \cdot cot ( α ) ) = 0 \qquad ( equation 6.2 )$$

wherein,
σₛ is a longitudinal stress in the expandable tubular member 4000,
r is the radius of the expandable tubular member 4000,
h is the thickness of the expandable tubular member 4000,
σₜ is a tangential stress in the expandable tubular member 4000,
μ is the coefficient of friction between the expansion device 3900 and the expandable tubular member 4000,
α is the expansion surface angle of the expansion device 3900, and
dr is the incremental change in the radius of the expandable tubular member 4000.

A variable k is defined by the following equation:
k=1+μ·cot(α) (equation 6.3)
wherein,
μ is the coefficient of friction between the expansion device 3900 and the expandable tubular member 4000, and
α is the expansion surface angle of the expansion device 3900.

Equations 6.2 and 6.3 result in the following equation:

$$r \cdot \frac{ⅆ}{ⅆ r} {σ}_{S} ( r ) + \frac{r}{h ( r )} \cdot {σ}_{S} ( r ) \cdot \frac{ⅆ}{ⅆ r} h ( r ) + {σ}_{S} ( r ) - k \cdot {σ}_{t} = 0 \qquad ( equation 6.4 )$$

wherein,
r is the radius of the expandable tubular member 4000,
σₛ(r) is a longitudinal stress in the expandable tubular member 4000 and is a function of the radius of the expandable tubular member 4000,
h(r) is the thickness of the expandable tubular member 4000 and is a function of the radius of the expandable tubular member 4000,
σₜ is a tangential stress in the expandable tubular member 4000,
dr is the incremental change in the radius of the expandable tubular member 4000, and
k=1+μcot(α), where μ is the coefficient of friction between the expansion device 3900 and the expandable tubular member 4000 and α is the expansion surface angle of the expansion device 3900.

The strain increments in the normal/radial and circumferential directions in the expandable tubular member 4000 are given by the following equations:

$$d {ɛ}_{r} = \frac{dh}{h} \qquad ( equation 7.1 )$$

wherein,
dεᵣ is the incremental change in the radial strain in the expandable tubular member 4000,
dh is the incremental change in the thickness of the expandable tubular member 4000, and
h is the thickness of the expandable tubular member 4000.
and

$$d {ɛ}_{t} = \frac{dr}{r} \qquad ( equation 7.2 )$$
wherein,
dεₜ is the incremental change in the tangential strain in the expandable tubular member 4000,
dr is the incremental change in the radius of the expandable tubular member 4000, and
r is the radius of the expandable tubular member 4000.

The associated flow rule is given by the following equation:

$$d {ɛ}_{ij}^{< p >} = \frac{3}{2} \cdot \frac{{( \overline{d {ɛ}_{i}} )}^{< p >}}{{σ}_{i}} \cdot {s}_{ij} \qquad ( equation 9 )$$

The associated flow rule in coordinate form is given by the following equations:

$$d {ɛ}_{m} = \frac{\overline{d {ɛ}_{i}}}{2 \cdot {σ}_{i}} \cdot ( 2 \cdot {σ}_{S} - {σ}_{t} ) \qquad ( equation 10.1 )$$

wherein,
dεₘ is the incremental change in the axial strain in the expandable tubular member 4000,
dεᵢ is the incremental change in the mean value of the strain in the expandable tubular member 4000,
σᵢ is a mean stress in the expandable tubular member 4000,
σₛ is a longitudinal stress in the expandable tubular member 4000, and
σₜ is a tangential stress in the expandable tubular member 4000.
and

$$d {ɛ}_{t} = \frac{\overline{d {ɛ}_{i}}}{2 \cdot {σ}_{i}} \cdot ( 2 \cdot {σ}_{t} - {σ}_{S} ) \qquad ( equation 10.2 )$$
wherein,
dεₜ is the incremental change in the tangential strain in the expandable tubular member 4000,
dε₁ is the incremental change in the mean value of the strain in the expandable tubular member 4000,
σ₁ is a mean stress in the expandable tubular member 4000,
σₛ is a longitudinal stress in the expandable tubular member 4000, and
σₜ is a tangential stress in the expandable tubular member 4000.
and

$$d {ɛ}_{r} = - \frac{\overline{d {ɛ}_{i}}}{2 \cdot {σ}_{i}} \cdot ( {σ}_{S} + {σ}_{t} ) \qquad ( equation 10.3 )$$
wherein,
dεᵣ is the incremental change in the radial strain in the expandable tubular member 4000,
dεᵢ is the incremental change in the mean value of the strain in the expandable tubular member 4000,
σᵢ is a mean stress in the expandable tubular member 4000,
σₛ is a longitudinal stress in the expandable tubular member 4000, and
σₜ is a tangential stress in the expandable tubular member 4000.

Using equations 10.2 and 10.3, we get:

$$\frac{d {ɛ}_{r}}{d {ɛ}_{t}} = - \frac{{σ}_{S} + {σ}_{t}}{( 2 \cdot {σ}_{t} - {σ}_{S} )} \qquad ( equation 11 )$$

wherein,
dεᵣ is the incremental change in the radial strain in the expandable tubular member 4000,
dεₜ is the incremental change in the tangential strain in the expandable tubular member 4000,
σₛ is a longitudinal stress in the expandable tubular member 4000, and
σₜ is a tangential stress in the expandable tubular member 4000.

The hardening curve may be assumed with the following equation:
σᵢ=σᵢ(εᵢ) (equation 29)

Von Mises condition has the form of the following equation:
σ_{S}²−σ_{S}·σₜ+σₜ²=σ_{T}(εᵢ)² (equation 13)
wherein,
σₛ is a longitudinal stress in the expandable tubular member 4000, and
σₜ(r) is a tangential stress in the expandable tubular member 4000.

We seek a solution in the form of the following equations:

$${σ}_{S} ( r ) = \frac{2}{\sqrt{3}} \cdot {σ}_{T} \cdot cos ( ψ ( r ) ) \qquad ( equation 14.1 )$$

wherein,
σₛ(r) is a longitudinal stress in the expandable tubular member 4000 and is a function of the radius of the expandable tubular member 4000,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.
and

$${σ}_{t} ( r ) = \frac{2}{\sqrt{3}} \cdot {σ}_{T} \cdot cos ( ψ ( r ) - \frac{π}{3} ) \qquad ( equation 14.2 )$$
wherein,
σₜ(r) is a tangential stress in the expandable tubular member 4000 and is a function of the radius of the expandable tubular member 4000,
σ_{T} is a stress in the expandable tubular member 4000 given by the Von Mises condition in equation 13 and is a function of stresses in the expandable tubular member 4000, and
ψ(r) is a function which is a function of the radius of the expandable tubular member 4000.

Substituting equation 14.1 and equation 14.2 into equation 10.2 and equation 10.3 results in the following equation:

$$d {ɛ}_{t} = \frac{\overline{d {ɛ}_{i}}}{2 \cdot {σ}_{i}} \cdot [ 2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ ) ] \qquad ( equation 30.1 )$$

wherein,
dεₜ is the incremental change in the tangential strain in the expandable tubular member 4000, and
ψ is a function which is a function of the radius of the expandable tubular member 4000.

The incremental change in the tangential strain in the expandable tubular member 4000 may also be expressed by the following equation:
dεₜ=sε₁·sin(ψ) (equation 30.2)
wherein,
dεₜ is the incremental change in the tangential strain in the expandable tubular member 4000, and
ψ is a function which is a function of the radius of the expandable tubular member 4000.

The incremental change in the radial strain in the expandable tubular member 4000 may be expressed by the following equation:

$$d {ɛ}_{r} = - \frac{\overline{d {ɛ}_{i}}}{2 \cdot {σ}_{i}} \cdot ( \frac{2}{\sqrt{3}} \cdot {σ}_{i} \cdot cos ( ψ ) + \frac{2}{\sqrt{3}} \cdot {σ}_{i} \cdot cos ( ψ - \frac{π}{3} ) ) \qquad ( equation 30.3 )$$

wherein,
dεᵣ is the incremental change in the radial strain in the expandable tubular member 4000, and
ψ is a function which is a function of the radius of the expandable tubular member 4000.

The incremental change in the radial strain in the expandable tubular member 4000 may be expressed by the following equation:

$$d {ɛ}_{r} = - 1 \cdot d {ɛ}_{i} \cdot sin ( ψ + \frac{π}{3} ) \qquad equation ( 30.4 )$$

wherein,
dεᵣ is the incremental change in the radial strain in the expandable tubular member 4000, and
ψ is a function which is a function of the radius of the expandable tubular member 4000.

Substituting equation 11 into equation 6 results in the following equation:

$$\frac{ⅆ {σ}_{s}}{ⅆ {ɛ}_{t}} - \frac{{σ}_{s} + {σ}_{t}}{2 \cdot {σ}_{t} - {σ}_{s}} \cdot {σ}_{s} + {σ}_{s} - k \cdot {σ}_{t} = 0 \qquad ( equation 31 )$$

wherein,
dσₛ is the incremental change in a longitudinal stress in the expandable tubular member 4000,
dσₜ is the incremental change in a tangential stress in the expandable tubular member 4000,
σₛ is a longitudinal stress in the expandable tubular member 4000,
σₜ is a tangential stress in the expandable tubular member 4000, and
k=1+μcot(α), where μ is the coefficient of friction between the expansion device 3900 and the expandable tubular member 4000 and α is the expansion surface angle of the expansion device 3900.

Substituting equation 25 and equation 14 in to equation 26 results in the following equation

$$\frac{\frac{2}{\sqrt{3}} \cdot d {σ}_{i} \cdot cos ( ψ ) - \frac{2}{\sqrt{3}} \cdot {σ}_{i} \cdot sin ( ψ ) \cdot d ψ}{d {ɛ}_{i} \cdot sin ( ψ )} - \frac{\frac{2}{\sqrt{3}} \cdot {σ}_{i} \cdot cos ( ψ ) + \frac{2}{\sqrt{3}} \cdot {σ}_{i} \cdot cos ( ψ - \frac{π}{3} )}{2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + •… = 0 + \frac{2}{\sqrt{3}} \cdot {σ}_{i} \cdot cos ( ψ ) - k \cdot ( \frac{2}{\sqrt{3}} \cdot {σ}_{i} \cdot cos ( ψ - \frac{π}{3} ) ) \qquad ( equation 32.1 )$$

wherein,
t is a function which is a function of the radius of the expandable tubular member 4000, and
k=1+μcot(α), where μ is the coefficient of friction between the expansion device 3900 and the expandable tubular member 4000 and α is the expansion surface angle of the expansion device 3900

Simplifying equation 32.1 results in the following equation:

$$\frac{d {σ}_{i} \cdot cot ( ψ ) - {σ}_{i} \cdot d ψ}{d {ɛ}_{i}} - \frac{{σ}_{i} \cdot cos ( ψ ) + {σ}_{i} \cdot cos ( ψ - \frac{π}{3} )}{2 \cdot \frac{2}{\sqrt{3}} \cdot {σ}_{i} \cdot cos ( ψ - \frac{π}{3} ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + •… = 0 + {σ}_{i} \cdot cos ( ψ ) - k \cdot {σ}_{i} \cdot cos ( ψ - \frac{π}{3} ) \qquad ( equation 32.2 )$$

wherein,
ψ is a function which is a function of the radius of the expandable tubular member 4000, and
k=1+μcot(α), where μ is the coefficient of friction between the expansion device 3900 and the expandable tubular member 4000 and α is the expansion surface angle of the expansion device 3900.

The incremental change in the function ψ is given by the following equation:

$$d ψ = ( sin ( ψ - \frac{π}{3} ) \cdot cot ( ψ ) - k \cdot cos ( ψ - \frac{1}{3} \cdot π ) ) \cdot d {ɛ}_{i} + d {σ}_{i} \cdot \frac{cot ( ψ )}{{σ}_{i}} \qquad ( equation 32.3 )$$

wherein,
ψ is a function which is a function of the radius of the expandable tubular member 4000,
dψ is the incremental change in the function ψ, and
k=1+μcot(α), where μ is the coefficient of friction between the expansion device 3900 and the expandable tubular member 4000 and α is the expansion surface angle of the expansion device 3900.

The following data may be used:

friction coefficient μ=0.1

expansion surface angle α=22.5 degrees

Deformation Curve Data:

$$\begin{matrix}{ɛ}_{u} := [ \begin{matrix}0 \\ 0.005 \\ 0.01 \\ 0.025 \\ 0.05 \\ 0.1 \\ 0.2 \\ 0.3 \\ 0.5 \\ 1\end{matrix} ] & {σ}_{u} := [ \begin{matrix}320 \\ 340 \\ 360 \\ 380 \\ 440 \\ 510 \\ 570 \\ 620 \\ 700 \\ 840\end{matrix} ] \cdot {10}^{6} \cdot Pa \\ {σ}_{T} := 320 \cdot {10}^{6} \cdot Pa & {σ}_{T} = 4.641 \cdot {10}^{4} ∘ psi\end{matrix}$$

wherein,
σ_{T} is a stress in the expandable tubular member 4000 given by the Von Mises condition in equation 13 and is a function of stresses in the expandable tubular member 4000
   B=45

The strain hardening curve is given by the following equation:
σᵢ(εᵢ,n):=σ_{T}·(1+B·εᵢ)ⁿ (equation 33)
wherein
σ_{T} is a stress in the expandable tubular member 4000 given by the Von Mises condition in equation 13 and is a function of stresses in the expandable tubular member 4000.

For the following data:

x:=0,0.025 . . . 1 n:=0.25

j:=0 . . . 9

the following graph results: [image]
wherein,
σ_{T} is a stress in the expandable tubular member 4000 given by the Von Mises condition: in equation 13 and is a function of stresses in the expandable tubular member 4000.

The numerical procedure is as follows:

N:=100

ε_{f1}:=0.247 ε_{f2}:=0.246

Ranging i from 0 to N results in the following equations for the strain in the expandable tubular member 4000:

$$\begin{matrix}{ɛ}_{{1}_{i}} := {ɛ}_{f 1} \cdot \frac{i}{N} \\ and & ( equation 34.1 ) \\ {ɛ}_{{2}_{i}} := {ɛ}_{f 2} \cdot \frac{i}{N} & ( equation 34.2 )\end{matrix}$$

Ranging i from 0 to N results in the following equations for the incremental change in the strain in the expandable tubular member 4000:

$$\begin{matrix}d {ɛ}_{1} := \frac{{ɛ}_{f 1}}{N} \\ and & ( equation 34.3 ) \\ d {ɛ}_{2} := \frac{{ɛ}_{f 2}}{N} & ( equation 34.4 )\end{matrix}$$

Ranging i from 0 to N results in the following equations for the stress in the expandable tubular member 4000:
σ₁_{ᵢ}:=σᵢ(ε₁_{ᵢ},0) (equation 34.5)
and
σ₂_{ᵢ}:=σᵢ(ε₂_{ᵢ},n) (equation 34.6)

Ranging j from 0 to (N−1) results in the following equations for the incremental change in the stress in the expandable tubular member 4000:
dσ₁_{ⱼ}:=σ₁_{_{j+1−σ}}₁_{ⱼ} (equation 35.1)
and
dσ₂_{ⱼ}:σ₂_{_{j+1−σ}}₂_{ⱼ} (equation 35.2)

K is given by the following equation:
k(α):=1+μ·cot(α) (equation 6.3)
wherein,
μ is the coefficient of friction between the expansion device 3900 and the expandable tubular member 4000, and
α is the expansion surface angle of the expansion device 3900

With ψ₁₀ and ψ₂₀ given the following values:

$${ψ}_{{1}_{0}} := \frac{π}{2} \\ {ψ}_{{2}_{0}} := \frac{π}{2}$$

the result is the following equations:

$$\begin{matrix}{ψ}_{{1}_{j + 1}} := {ψ}_{{1}_{j}} + ( sin ( {ψ}_{{1}_{j}} - \frac{π}{3} ) \cdot cot ( {ψ}_{{1}_{j}} ) - k ( α ) \cdot cos ( {ψ}_{{1}_{j}} - \frac{1}{3} \cdot π ) ) \cdot \\ d {ɛ}_{1} + ( {σ}_{{1}_{j + 1}} - {σ}_{{1}_{j}} ) \cdot \frac{cot ( {ψ}_{{1}_{j}} )}{{σ}_{{1}_{j}}} \\ and & ( equation 35.3 ) \\ {ψ}_{{2}_{j + 1}} := {ψ}_{{2}_{j}} + ( sin ( {ψ}_{{2}_{j}} - \frac{π}{3} ) \cdot cot ( {ψ}_{{2}_{j}} ) - k ( α ) \cdot cos ( {ψ}_{{2}_{j}} - \frac{1}{3} \cdot π ) ) \cdot \\ d {ɛ}_{2} + ( {σ}_{{2}_{j + 1}} - {σ}_{{2}_{j}} ) \cdot \frac{cot ( {ψ}_{{2}_{j}} )}{{σ}_{{2}_{j}}} & ( equation 35.4 )\end{matrix}$$

With R₁₀ and R₂₀ given the following values:
R₁_{₀}:=1 R₂_{₀}:=1
the result is the following equations:
R₁_{ⱼ₊₁}:=R₁_{ⱼ}+R₁_{ⱼ}·dε₁·sin(ψ₁_{ⱼ}) (equation 35.5)
and
R₂_{ⱼ₊₁}:=R₂_{ⱼ}+R₂_{ⱼ}·(dε₂·sin(ψ₂_{ⱼ})) (equation 35.6)

With R_{1N} and R_{2N} and ψ_{1N} given the following values:
R₁_{_{N}}=1.276 R₂_{_{N}}=1.276
ψ₁_{_{N}}=1299
the following graphs result:

[image]

The following variables are defined by the following equations:

$${S}_{s {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} ) \qquad ( equation 36.1 )$$

wherein,
σ_{T} is a stress in the expandable tubular member 4000 given by the Von Mises condition in equation 13 and is a function of stresses in the expandable tubular member 4000.

$${S}_{t {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} - \frac{π}{3} ) \qquad ( equation 36.2 )$$
wherein,
σ_{T} is a stress in the expandable tubular member 4000 given by the Von Mises condition in equation 13 and is a function of stresses in the expandable tubular member 4000.
and

$${S}_{s {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} ) \qquad ( equation 36.3 )$$
wherein,
σ_{T} is a stress in the expandable tubular member 4000 given by the Von Mises condition in equation 13 and is a function of stresses in the expandable tubular member 4000.
and

$${S}_{t {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} - \frac{π}{3} ) \qquad ( equation 36.4 )$$
wherein,
σ_{T} is a stress in the expandable tubular member 4000 given by the Von Mises condition in equation 13 and is a function of stresses in the expandable tubular member 4000.

Equations 36.1, 36.2, 36.3, and 36.4 result in the following graphs:

[image]

Equations 36.1, 36.2, 36.3, and 36.4 also results in the following graph:

[image]

Equations 36.1, 36.2, 36.3, and 36.4 result in the following equation:
{square root over ([(Sₛ₂_{_{N}})²−Sₛ₂_{_{N}}·Sₜ₂_{_{N}}+(Sₜ₂_{_{N}})²])}_{T}=5.965·10⁸ ·Pa (equation 37.1)
wherein,
σ_{T} is a stress in the expandable tubular member 4000 given by the Von Mises condition in equation 13 and is a function of stresses in the expandable tubular member 4000.

The thickness of the expandable tubular member 4000 may be given by the following equation:

$$\frac{dh}{h} = - 1 \cdot d {ɛ}_{i} \cdot sin ( ψ + \frac{π}{3} ) \qquad ( equation 37.2 )$$

wherein,
dh is the incremental change in the thickness of the expandable tubular member 4000,
h is the thickness of the expandable tubular member 4000, and
ψ is a function which is a function of the radius of the expandable tubular member 4000.

The follow boundary conditions may be used:

$$\begin{matrix}h ( {r}_{i} ) = {h}_{i} & H = \frac{h}{{h}_{i}} & {H}_{i} = 1 \\ {H}_{{1}_{0}} := 1 & {H}_{{2}_{0}} := 1 & \end{matrix}$$

wherein,
h is the thickness of the expandable tubular member 4000

Ranging i from 0 to (n−1) results in the following equations:

$$\begin{matrix}{H}_{{1}_{i + 1}} := {H}_{{1}_{i}} - {H}_{{1}_{i}} \cdot ( d {ɛ}_{1} \cdot sin ( {ψ}_{{1}_{i}} + \frac{π}{3} ) ) \\ and & ( equation 38.1 ) \\ {H}_{{2}_{i + 1}} := {H}_{{2}_{i}} - {H}_{{2}_{i}} \cdot ( d {ɛ}_{2} \cdot sin ( {ψ}_{{2}_{i}} + \frac{π}{3} ) ) & ( equation 38.2 )\end{matrix}$$

Equations 38.1 and 38.2 can be used to get the following graph:

[image]

The pressure needed for the expansion device 3900 to achieve steady state radial expansion and plastic deformation of the expandable tubular member 4000, where r_{pig} is defined as the radius of the expansion device and D_{pig} is defined as the diameter of the expansion device, is given by the following equation:

$$P = \frac{[ {( {r}_{pig} + {h}_{f} )}^{2} - {r}_{pig}^{2} ] \cdot {σ}_{s}}{{r}_{pig}^{2}} \qquad ( equation 24.1 )$$

wherein,
P is the pressure needed for steady state radial expansion and plastic deformation of the expandable tubular member 4000,
r_{pig} is defined as the radius of the expansion device 3900,
h_{f} is the final thickness of the expanded expandable tubular member 4000, and
σₛ is a longitudinal stress in the expandable tubular member 4000.

For estimations, the following experimental data may be used where OD is defined as the outside diameter of the expandable tubular member 4000 an ID is defined as the inside diameter of the expandable tubular member 4000:
OD:=101.6·mm OD=4·in
wherein,
OD is the outside diameter of the expandable tubular member 4000.
   ID:=90.10·mm ID=3.547·in
wherein,
ID is the inside diameter of the expandable tubular member 4000
and

$$\begin{matrix}{h}_{i} := \frac{OD - ID}{2} & {h}_{i} := 5.75 \cdot {10}^{- 3} \cdot m \\ {D}_{pig} := 115 \cdot mm & {σ}_{T} = 320 \cdot \frac{newton}{{mm}^{2}}\end{matrix}$$
wherein,
D_{pig} is the diameter of the expansion device 3900, and
σ_{T} is a stress in the expandable tubular member 4000 given by the Von Mises condition in equation 13 and is a function of stresses in the expandable tubular member 4000.

We can now estimate the pressure needed to propagate the expansion device 3900 using the following equation:

$$p = \frac{P}{{σ}_{T}} \qquad ( equation 24.2 )$$

wherein,
P is the pressure needed for steady state radial expansion and plastic deformation of the expandable tubular member 4000, and
σ_{T} is a stress in the expandable tubular member 4000 given by the Von Mises condition in equation 13 and is a function of stresses in the expandable tubular member 4000.

With H1₁₀₀=0.86, the pressure to radially expand and plastically deform the expandable tubular member 4000 by the expansion device 3900 is given by the following equation:

$${H}_{{1}_{100}} = 0.86 \\ {p}_{1} := \frac{[ {( {D}_{pig} + 2 \cdot {h}_{i} \cdot {H}_{{1}_{100}} )}^{2} - {D}_{pig}^{2} ] \cdot {S}_{s {1}_{100}}}{{D}_{pig}^{2}} \qquad ( equation 24.3 )$$

wherein,
p is the pressure needed to propagate the expansion device 3900, and
D_{pig} is the diameter of the expansion device 3900.
   results in the following pressure:
   p₁=0.056

With H1₁₀₀=0.86, the pressure to radially expand and plastically deform the expandable tubular member 4000 by the expansion device 3900 is given by the following equation:

$${p}_{2} := \frac{[ {( {D}_{pig} + 2 \cdot {h}_{i} \cdot {H}_{{2}_{100}} )}^{2} - {D}_{pig}^{2} ] \cdot {S}_{s {2}_{100}}}{{D}_{pig}^{2}} \qquad ( equation 39 )$$

wherein,
p is the pressure needed to propagate the expansion device 3900 and D_{pig} is the diameter of the expansion device 3900. and the result is:
   p₂=0.087

The pressure pₐₙ may be determined using the following equation:
pₐₙ:=_{T}·p₂ (equation 40.1)
wherein,
σ_{T} is a stress in the expandable tubular member 4000 given by the Von Mises condition in equation 13 and is a function of stresses in the expandable tubular member 4000.
   and an expansion pressure is:
   pₑₓ:=290·bar (equation 40.2)
wherein,
pₑₓ is the pressure used to expand the expandable tubular member 4000.
   and an expansion force is:
   F_{ab}:=405·10³·newton
wherein,
F_{ab} is the force used to expand the expandable tubular member 4000.

The pressure from the force F_{ab} is determined by the following equation:

$${p}_{ab} := \frac{{F}_{ab}}{π \cdot \frac{{D}_{pig}^{2}}{4}} \qquad ( equation 40.3 )$$

wherein,
D_{pig} is the diameter of the expansion device 3900.

The expansion pressure pₑₓ is then:
pₑₓ=4.206·10³·psi (equation 40.4)
wherein,
pₑₓ is the pressure used to expand the expandable tubular member 4000.

The pressure pₐₙ is then:
pₐₙ=4.017·10³·psi
wherein,
   pₐₙ is a pressure used to expand the expandable tubular member 4000.

The pressure p_{ab} is then:
p_{ab}=5.655·10³ ·psi
wherein,
p_{ab} is a pressure used to expand the expandable tubular member 4000.

The formula for the burst pressure is given by the following equation:

$${P}_{bur} = \frac{1.75 \cdot {h}_{f} \cdot {σ}_{T}}{{OD}_{f}} \qquad ( equation 25.1 )$$

wherein,
P_{bur} is the burst pressure of the expandable tubular member 4000,
h_{f} is the thickness of the expandable tubular member 4000 upon burst,
σ_{T} is a stress in the expandable tubular member 4000 given by the Von Mises condition in equation 13 and is a function of stresses in the expandable tubular member 4000, and
OD_{f} is the final outside diameter of the expandable tubular member 4000.

The formula for the burst pressure is also given by the following equation:

$${p}_{bur} = \frac{{P}_{bur}}{{σ}_{T}} \qquad ( equation 25.2 )$$

wherein,
P_{bur} is the burst pressure of the expandable tubular member 4000, and
σ_{T} is a stress in the expandable tubular member 4000 given by the Von Mises condition in equation 13 and is a function of stresses in the expandable tubular member 4000.

The burst pressure may then be determined with the following equation:

$${p}_{bur} = \frac{1.75 \cdot {h}_{i} \cdot {H}_{100}}{( {D}_{pig} + 2 \cdot {h}_{i} \cdot {H}_{100} )} \qquad ( equation 25.3 )$$

wherein,
P_{bur} is the burst pressure of the expandable tubular member 4000, and
D_{pig} is the diameter of the expansion device 3900.
   giving:
   p_{bur}=0.07
wherein,
P_{bur} is the burst pressure of the expandable tubular member 4000.

The design coefficient for burst is given by the following equation:

$${c}_{bur} := \frac{{p}_{bur}}{{p}_{2}}$$

$${c}_{bur} = 0.804$$

wherein,
p_{bur} is the burst pressure of the expandable tubular member 4000, and
p₂ is the pressure needed to propagate the expansion device 3900.

The Von Mises stress is:
σ_{T}=4.641·10⁴ ·psi

wherein,

σ_{T} is a stress in the expandable tubular member 4000 given by the Von Mises condition in equation 13 and is a function of stresses in the expandable tubular member 4000.

The expansion forces to radially expand and plastically deform the expandable tubular member 4000 with the expansion device 3900 are given by the following equations:

$${F}_{exp 1} := {p}_{1} \cdot {σ}_{T} \cdot \frac{π \cdot {( {D}_{pig} )}^{2}}{4} \\ {F}_{exp 1} = 184.703 \cdot kN \qquad ( equation 41.1 )$$

wherein,
Fₑₓₚ₁ is the first expansion force,
P₁ is the pressure used to expand the expandable tubular member 4000,
σ_{T} is a stress in the expandable tubular member 4000 given by the Von Mises condition in equation 13 and is a function of stresses in the expandable tubular member 4000, and
D_{pig} is the diameter of the expansion device 3900.
and

$${F}_{exp 2} := {p}_{2} \cdot {σ}_{T} \cdot \frac{π \cdot {( {D}_{pig} )}^{2}}{4} \\ {F}_{exp 2} = 287.652 ∘ kN \qquad ( equation 41.1 )$$
wherein,
Fₑₓₚ₂ is the second expansion force,
p₂ is the pressure used to expand the expandable tubular member 4000,
σ_{T} is a stress in the expandable tubular member 4000 given by the Von Mises condition in equation 13 and is a function of stresses in the expandable tubular member 4000, and
D_{pig} is the diameter of the expansion device 3900.

The hoop strain in the expandable tubular member 4000 is given by the following equation

$${ɛ}_{hoop} := ln ( \frac{{R}_{{2}_{N}}}{{R}_{{2}_{0}}} ) \\ {ɛ}_{hoop} = 0.244 \qquad ( equation 42.1 )$$

wherein,
εₕₒₒₚ is the hoop strain in the expandable tubular member 4000.

The strain in the expandable tubular member 4000 is given by the following equation:

$${ɛ}_{h} := ln ( \frac{{H}_{{2}_{N}}}{{H}_{{2}_{0}}} ) \\ {ɛ}_{h} = - 0.146 \qquad ( equation 42.1 )$$

wherein,
εₕ is the strain in the expandable tubular member 4000.

A method for operating an expansion device to radially expand and plastically deform an expandable tubular member has been described that includes displacing an expansion device through an expandable tubular member using a propagation pressure, wherein the propagation pressure is given by the equation:

$$p = \frac{2}{{r}_{f}^{2}} \cdot ( 1 + μ \cdot cot ( α ) ) \cdot {\int }_{{r}_{i}}^{{r}_{f}} {p}_{n} ( r ) \cdot r ⅆ r$$

wherein p is a propagation pressure for the expansion device, r_{f} is a final expansion radius of the expansion device, μ is a coefficient of friction between the expansion device and the expandable tubular member, α is an expansion surface angle of the expansion device, rᵢ is an initial radius of the expandable tubular member, pₙ(r) is a normal force on the expansion device and is a function of a expansion surface radius of the expansion device, r is a expansion surface radius of the expansion device, and dr is an incremental change in the expansion surface radius of the expansion device.

A computer program has been described that includes a computer readable medium comprising program instructions operable to determine the propagation pressure needed for displacing an expansion device through an expandable tubular member, wherein the propagation pressure is given by the equation:

$$p = \frac{2}{{r}_{f}^{2}} \cdot ( 1 + μ \cdot cot ( α ) ) \cdot {\int }_{{r}_{i}}^{{r}_{f}} {p}_{n} ( r ) \cdot r ⅆ r$$

wherein p is a propagation pressure for the expansion device, r_{f} is a final expansion radius of the expansion device, μ is a coefficient of friction between the expansion device and the expandable tubular member, α is an expansion surface angle of the expansion device, rᵢ is an initial radius of the expandable tubular member, pₙ(r) is a normal force on the expansion device and is a function of a expansion surface radius of the expansion device, r is a expansion surface radius of the expansion device, and dr is an incremental change in the expansion surface radius of the expansion device.

A method for operating an expansion device to radially expand and plastically deform an expandable tubular member has been described that includes displacing an expansion device through an expandable tubular member and creating stresses in the expansion device and the expandable tubular member, wherein the stresses are given by the equation:

$$r \cdot \frac{ⅆ}{ⅆ r} {σ}_{S} ( r ) + \frac{r}{h ( r )} \cdot {σ}_{S} ( r ) \cdot \frac{ⅆ}{ⅆ r} h ( r ) + {σ}_{S} ( r ) - k \cdot {σ}_{t} = 0$$

where r is a radius of the expandable tubular member, σₛ(r) is a stress in the expandable tubular member and is a function of the radius of the expandable, tubular member, h(r) is a thickness of the expandable tubular member and is a function of the radius of the expandable tubular member, σₜ is a stress in the expandable tubular member, dr is an incremental change in a radius of the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$r \cdot \frac{ⅆ}{ⅆ r} {σ}_{S} ( r ) + \frac{r}{h ( r )} \cdot {σ}_{S} ( r ) \cdot \frac{ⅆ}{ⅆ r} h ( r ) + {σ}_{S} ( r ) - k \cdot {σ}_{t} = 0$$

where r is a radius of the expandable tubular member, σₛ(r) is a stress in the expandable tubular member and is a function of the radius of the expandable tubular member, h(r) is a thickness of the expandable tubular member and is a function of the radius of the expandable tubular member, σₜ is a stress in the expandable tubular member, dr is an incremental change in the radius of the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expansion device and the expandable tubular member, wherein the stresses are given by the equation:
where r is a radius of the expandable tubular member, dr is an incremental change in the radius of the

$$r \cdot \frac{ⅆ}{ⅆ r} {σ}_{S} ( r ) + \frac{ⅆ {ɛ}_{r}}{ⅆ {ɛ}_{t}} \cdot {σ}_{S} ( r ) + {σ}_{S} ( r ) - k \cdot {σ}_{t} = 0$$

expandable tubular member, σₛ(r) is a stress in the expandable tubular member and is a function of the radius of the expandable tubular member, dεᵣ is an incremental change in a radial strain in the expandable tubular member, dεₜ is an incremental change in a tangential strain in the expandable tubular member, σₜ is a stress in the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$r \cdot \frac{ⅆ}{ⅆ r} {σ}_{S} ( r ) + \frac{ⅆ {ɛ}_{r}}{ⅆ {ɛ}_{t}} \cdot {σ}_{S} ( r ) + {σ}_{S} ( r ) - k \cdot {σ}_{t} = 0$$

where r is a radius of the expandable tubular member, dr is an incremental change in the radius of the expandable tubular member, σₛ(r) is a stress in the expandable tubular member and is a function of the radius of the expandable tubular member; dεᵣ is an incremental change in a radial strain in the expandable tubular member, dεₜ is an incremental change in a tangential strain in the expandable tubular member, σₜ is a stress in the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expansion device and the expandable tubular member, wherein the stresses are given by the equation:

$$r \cdot \frac{ⅆ}{ⅆ r} {σ}_{S} ( r ) - \frac{{σ}_{S} ( r ) + {σ}_{t} ( r )}{2 \cdot {σ}_{t} ( r ) - {σ}_{S} ( r )} \cdot {σ}_{S} ( r ) + {σ}_{S} ( r ) - k \cdot {σ}_{t} ( r ) = 0$$

where r is a radius of the expandable tubular member, dr is an incremental change in the radius of the expandable tubular member, σₛ(r) is a stress in the expandable tubular member and is a function of the radius of the expandable tubular member, at(r) is a stress in the expandable tubular member and is a function of the radius of the expandable tubular member 4000, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$r \cdot \frac{ⅆ}{ⅆ r} {σ}_{S} ( r ) - \frac{{σ}_{s} ( r ) + {σ}_{t} ( r )}{2 \cdot {σ}_{t} ( r ) - {σ}_{s} ( r )} \cdot {σ}_{s} ( r ) + {σ}_{s} ( r ) - k \cdot {σ}_{t} ( r ) = 0$$

where r is a radius of the expandable tubular member, dr is an incremental change in the radius of the expandable tubular member, σₛ(r) is a stress in the expandable tubular member and is a function of the radius of the expandable tubular member, at(r) is a stress in the expandable tubular member and is a function of the radius of the expandable tubular member 4000, and k=1+μcot(α), where μ is a coefficient of friction between the expansion device and the expandable tubular member and α is an expansion surface angle, of the expansion device.

A method for operating an expansion device to radially expand and plastically deform an expandable tubular member has been described that includes displacing an expansion device through an expandable tubular member and changing a radius of the expandable tubular member, wherein the radii of the expandable tubular member are given by the equation:

$$\frac{dr}{r} = \frac{2 \cdot {tan ( ψ ( r ) )}^{2} \cdot d ψ}{- \sqrt{3} + ( 1 - k ) \cdot tan ( ψ ( r ) ) - \sqrt{3} \cdot k \cdot {tan ( ψ ( r ) )}^{2}}$$

where r is a radius of the expandable tubular member, dr is an incremental change in the radius of the expandable tubular member, ψ(r) is a function which is a function of the radius of the expandable tubular member, and dψis an incremental change in the function ψ(r).

A computer program has been described that includes a computer readable medium comprising program instructions operable to determine the change in a radius of an expandable tubular member upon radial expansion and plastic deformation of the expandable tubular member by an expansion device, wherein the radii of the expandable tubular member are given by the equation:

$$\frac{dr}{r} = \frac{2 \cdot {tan ( ψ ( r ) )}^{2} \cdot d ψ}{- \sqrt{3} + ( 1 - k ) \cdot tan ( ψ ( r ) ) - \sqrt{3} \cdot k \cdot {tan ( ψ ( r ) )}^{2}}$$

where r is a radius of the expandable tubular member, dr is an incremental change in the radius of the expandable tubular member, ψ(r) is a function which is a function of the radius of the expandable tubular member, and dψis an incremental change in the function ψ(r).

A method for operating an expansion device to radially expand and plastically deform an expandable tubular member has been described that includes displacing an expansion device through an expandable tubular member and changing a radius of the expandable tubular member, wherein the radii of the expandable tubular member are given by the equation:

$$\frac{{r}_{i 1} - {r}_{i}}{{r}_{i}} = \frac{2 \cdot {tan ( {ψ}_{i} )}^{2} \cdot ( {ψ}_{i 1} - {ψ}_{i} )}{- \sqrt{3} + ( 1 - k ) \cdot tan ( {ψ}_{i} ) - \sqrt{3} \cdot k \cdot {tan ( {ψ}_{i} )}^{2}}$$

where k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and changing a radius of the expandable tubular member, wherein

$$\frac{{r}_{i 1} - {r}_{i}}{{r}_{i}} = \frac{2 \cdot {tan ( {ψ}_{i} )}^{2} \cdot ( {ψ}_{i 1} - {ψ}_{i} )}{- \sqrt{3} + ( 1 - k ) \cdot tan ( {ψ}_{i} ) - \sqrt{3} \cdot k \cdot {tan ( {ψ}_{i} )}^{2}}$$

the radii of the expandable tubular member are given by the equation:
where k=1+μcot(α), where μ is a coefficient of friction between the expansion device and the expandable tubular member and α is an expansion surface angle of the expansion device.

A computer program has been described that includes a computer readable medium comprising program instructions operable to determine the change in a radius of an expandable tubular member upon radial expansion and plastic deformation of the expandable tubular member by an expansion device, wherein the radii of the expandable tubular member are given by the equation:

$$\frac{{r}_{i 1} - {r}_{i}}{{r}_{i}} = \frac{2 \cdot {tan ( {ψ}_{i} )}^{2} \cdot ( {ψ}_{i 1} - {ψ}_{i} )}{- \sqrt{3} + ( 1 - k ) \cdot tan ( {ψ}_{i} ) - \sqrt{3} \cdot k \cdot {tan ( {ψ}_{i} )}^{2}}$$

where k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$r \cdot \frac{ⅆ {σ}_{S}}{ⅆ r} + \frac{r}{h} \cdot {σ}_{S} \cdot \frac{ⅆ h}{ⅆ r} + {σ}_{S} - k \cdot {σ}_{t} = 0$$

where r is a radius of the expandable tubular member, dσₛ is an incremental change in a stress in the expandable tubular member, dr is an incremental change in the radius of the expandable tubular member, h is a thickness of the expandable tubular member, σₛ is a stress in the expandable tubular member, dh is an incremental change in a thickness of the expandable tubular member, k=1+μcot(α), where μ is a coefficient of friction between the expansion device and the expandable tubular member and α is an expansion surface angle of the expansion device, and σₜ is a stress in the expandable tubular member.

A computer program has been described that includes a computer readable medium comprising program instructions operable to determine the change in a thickness of an expandable tubular member upon radial expansion and plastic deformation of the expandable tubular member by an expansion device, wherein the thickness of the expandable tubular member is given by the equation:

$$r \cdot \frac{ⅆ {σ}_{S}}{ⅆ r} + \frac{r}{h} \cdot {σ}_{S} \cdot \frac{ⅆ h}{ⅆ r} + {σ}_{S} - k \cdot {σ}_{t} = 0$$

where r is a radius of the expandable tubular member, dσₛ is an incremental change in a stress in the expandable tubular member, dr is an incremental change in the radius of the expandable tubular member, h is a thickness of the expandable tubular member, σₛ is a stress in the expandable tubular member, dh is an incremental change in a thickness of the expandable tubular member, k=1+μcot(α), where μ is a coefficient of friction between the expansion device and the expandable tubular member and α is an expansion surface angle of the expansion device, and σₜ is a stress in the expandable tubular member.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$r \cdot \frac{ⅆ {σ}_{S}}{ⅆ h} \cdot \frac{ⅆ h}{ⅆ r} + \frac{r}{h} \cdot {σ}_{S} \cdot \frac{ⅆ h}{ⅆ r} + {σ}_{S} - k \cdot {σ}_{t} = 0$$

where r is a radius of the expandable tubular member, dσₛ is an incremental change in a stress in the expandable tubular member, dr is an incremental change in the radius of the expandable tubular member, h is a thickness of the expandable tubular member, σₛ is a stress in the expandable tubular member, dh is an incremental change in a thickness of the expandable tubular member, k=1+μcot(α), where μ is a coefficient of friction between the expansion device and the expandable tubular member and α is an expansion surface angle of the expansion device, and σₜ is a stress in the expandable tubular member.

A computer program has been described that includes a computer readable medium comprising program instructions operable to determine the change in a thickness of an expandable tubular member upon radial expansion and plastic deformation of the expandable tubular member by an expansion device, wherein the thickness of the expandable tubular member is given by the equation:

$$r \cdot \frac{ⅆ {σ}_{S}}{ⅆ h} \cdot \frac{ⅆ h}{ⅆ r} + \frac{r}{h} \cdot {σ}_{S} \cdot \frac{ⅆ h}{ⅆ r} + {σ}_{S} - k \cdot {σ}_{t} = 0$$

where r is a radius of the expandable tubular member, dσₛ is an incremental change in a stress in the expandable tubular member, dr is an incremental change in the radius of the expandable tubular member, h is a thickness of the expandable tubular member, σₛ is a stress in the expandable tubular member, dh is an incremental change in a thickness of the expandable tubular member, k=1+μcot(α), where μ is a coefficient of friction between the expansion device and the expandable tubular member and α is an expansion surface angle of the expansion device, and σₜ is a stress in the expandable tubular member.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$\frac{r}{dr} \cdot \frac{dh}{h} = - \frac{{σ}_{s} + {σ}_{t}}{( 2 \cdot {σ}_{t} - {σ}_{s} )}$$

where r is a radius of the expandable tubular member, dr is an incremental change in the radius of the expandable tubular member, h is a thickness of the expandable tubular member, σₛ is a stress in the expandable tubular member, dh is an incremental change in the thickness of the expandable tubular member, and σₜ is a stress in the expandable tubular member.

A computer program has been described that includes a computer readable medium comprising program instructions operable to determine the change in a thickness of an expandable tubular member upon radial expansion and plastic deformation of the expandable tubular member by an expansion device, wherein the thickness of the expandable tubular member is given by the equation:

$$\frac{r}{dr} \cdot \frac{dh}{h} = - \frac{{σ}_{s} + {σ}_{t}}{( 2 \cdot {σ}_{t} - {σ}_{s} )}$$

where r is a radius of the expandable tubular member, dr is an incremental change in the radius of the expandable tubular member, h is a thickness of the expandable tubular member, σₛ is a stress in the expandable tubular member, dh is an incremental change in the thickness of the expandable tubular member, and σₜ is a stress in the expandable tubular member.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$\frac{dh}{h} = \frac{( - \sqrt{3} \cdot cos ( ψ ) \cdot sin ( ψ ) - {sin ( ψ )}^{2} )}{( \begin{matrix}- \sqrt{3} \cdot {cos ( ψ )}^{2} + cos ( ψ ) \cdot sin ( ψ ) - \\ k \cdot {sin ( ψ )}^{2} \cdot \sqrt{3} - k \cdot cos ( ψ ) \cdot sin ( ψ )\end{matrix} )} \cdot d ψ$$

where h is a thickness of the expandable tubular member, ψ is a function which is a function of a final expanded radius of the expandable tubular member, dψis an incremental change in the function ψ, dh is an incremental change in the thickness of the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the change in a thickness of an expandable tubular member upon radial expansion and plastic deformation of the expandable tubular member by an expansion device, wherein the thickness of the expandable tubular member is given by the equation:

$$\frac{dh}{h} = \frac{( - \sqrt{3} \cdot cos ( ψ ) \cdot sin ( ψ ) - {sin ( ψ )}^{2} )}{( \begin{matrix}- \sqrt{3} \cdot {cos ( ψ )}^{2} + cos ( ψ ) \cdot sin ( ψ ) - \\ k \cdot {sin ( ψ )}^{2} \cdot \sqrt{3} - k \cdot cos ( ψ ) \cdot sin ( ψ )\end{matrix} )} \cdot d ψ$$

where h is a thickness of the expandable tubular member, ψ is a function which is a function of a final expanded radius of the expandable tubular member, dψis an incremental change in the function ψ, dh is an incremental change in the thickness of the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$\frac{dh}{h} = - 1 \cdot \frac{tan ( ψ ( r ) ) \cdot ( tan ( ψ ( r ) ) + \sqrt{3} ) \cdot d ψ}{- \sqrt{3} + ( 1 - k ( α ) ) \cdot tan ( ψ ( r ) ) - \sqrt{3} \cdot k ( α ) \cdot {tan ( ψ ( r ) )}^{2}}$$

where h is a thickness of the expandable tubular member, ψ is a function which is a function of a final expanded radius of the expandable tubular member, dψis an incremental change in the function ψ, dh is an incremental change in a thickness of the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the change in a thickness of an expandable tubular member upon radial expansion and plastic deformation of the expandable tubular member by an expansion device, wherein the thickness of the expandable tubular member are given by the equation:

$$\frac{dh}{h} = - 1 \cdot \frac{tan ( ψ ( r ) ) \cdot ( tan ( ψ ( r ) ) + \sqrt{3} ) \cdot d ψ}{- \sqrt{3} + ( 1 - k ( α ) ) \cdot tan ( ψ ( r ) ) - \sqrt{3} \cdot k ( α ) \cdot {tan ( ψ ( r ) )}^{2}}$$

where h is a thickness of the expandable tubular member, ψ is a function which is a function of a final expanded radius of the expandable tubular member, dψis an incremental change in the function ψ, dh is an incremental change in the thickness of the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member using a pressure, wherein the pressure is given by the equation:

$$P = \frac{[ {( {r}_{pig} + {h}_{f} )}^{2} - {r}_{pig}^{2} ] \cdot {σ}_{s}}{{r}_{pig}^{2}}$$

where P is a pressure needed for steady state radial expansion and plastic deformation of the expandable tubular member, r_{pig} is a radius of the expansion device, h_{f} is a final thickness of the expanded expandable tubular member, and σₛ is a stress in the expandable tubular member.

A computer program has been described that includes a computer readable medium comprising program instructions operable to determine the pressure to be applied to an expansion device in order to provide steady state radial expansion and plastic deformation of an expandable tubular member by the expansion device, wherein the pressure is given by the equation:

$$P = \frac{[ {( {r}_{pig} + {h}_{f} )}^{2} - {r}_{pig}^{2} ] \cdot {σ}_{s}}{{r}_{pig}^{2}}$$

where P is a pressure needed for steady state radial expansion and plastic deformation of the expandable tubular member, r_{pig} is a radius of the expansion device, h_{f} is a final thickness of the expanded expandable tubular member, and σₛ is a stress in the expandable tubular member.

A method for operating an expansion device to radially expand and plastically deform an expandable tubular member has been described that includes displacing an expansion device through an expandable tubular member using a pressure, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A method for operating an expansion device to radially expand and plastically deform an expandable tubular member has been described that includes displacing an expansion device through an expandable tubular member using a pressure, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A method for operating an expansion device to radially expand and plastically deform an expandable tubular member has been described that includes displacing an expansion device through an expandable tubular member using a pressure, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A computer program has been described that includes a computer readable medium comprising program instructions operable to determine the pressure to be applied to an expansion device in order to provide steady state radial expansion and plastic deformation of an expandable tubular member by the expansion device, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A computer program has been described that includes a computer readable medium comprising program instructions operable to determine the pressure to be applied to an expansion device in order to provide steady state radial expansion and plastic deformation of an expandable tubular member by the expansion device, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A computer program has been described that includes a computer readable medium comprising program instructions operable to determine the pressure to be applied to an expansion device in order to provide steady state radial expansion and plastic deformation of an expandable tubular member by the expansion device, wherein the pressure is given by the equation:

$$p := \frac{[ {( {D}_{pig} + 2 \cdot {h}_{i} \cdot {H}_{100} )}^{2} - {D}_{pig}^{2} ] \cdot {S}_{{s}_{100}}}{{D}_{pig}^{2}}$$

where μ is a pressure needed to propagate the expansion device and D_{pig} is a diameter of the expansion device.

A method for operating an expansion device to radially expand and plastically deform an expandable tubular member has been described that includes displacing an expansion device through an expandable tubular member without exceeding a burst pressure, wherein the burst pressure is given by the equation:

$${P}_{bur} = \frac{1.75 \cdot {h}_{f} \cdot {σ}_{T}}{{OD}_{f}}$$

where P_{bur} is a burst pressure of the expandable tubular member, h_{f} is a thickness of the expandable tubular member upon burst(?), σ_{T} is a stress in the expandable tubular member given by the Von Mises condition and is a function of stresses in the expandable tubular member, and OD_{f} is a final outside diameter of the expandable tubular member.

A method for operating an expansion device to radially expand and plastically deform an expandable tubular member has been described that includes displacing an expansion device through an expandable tubular member without exceeding a burst pressure, wherein the burst pressure is given by the equation:

$${p}_{bur} := \frac{1.75 \cdot {h}_{i} \cdot {H}_{100}}{( {D}_{pig} + 2 \cdot {h}_{i} \cdot {H}_{100} )}$$

where P_{bur} is a burst pressure of the expandable tubular member and D_{pig} is a diameter of the expansion device.

A computer program has been described that includes a computer readable medium comprising program instructions operable to determine the burst pressure for an expandable tubular member for radial expansion and plastic deformation of the expandable tubular member by an expansion device, wherein the burst pressure is given by the equation:

$${p}_{bur} := \frac{1.75 \cdot {h}_{i} \cdot {H}_{100}}{( {D}_{pig} + 2 \cdot {h}_{i} \cdot {H}_{100} )}$$

where P_{bur} is a burst pressure of the expandable tubular member and D_{pig} is a diameter of the expansion device.

A method for operating an expansion device to radially expand and plastically deform an expandable tubular member has been described that includes displacing an expansion device through an expandable tubular member without exceeding a burst pressure, wherein the design coefficient for burst is given by the equation:

$${c}_{bur} := \frac{{p}_{bur}}{p}$$

where c_{bur} is the design coefficient for burst for the expandable tubular member, p_{bur} is a burst pressure of the expandable tubular member, and p is a pressure needed to propagate the expansion device.

A computer program has been described that includes a computer readable medium comprising program instructions operable to determine the design coefficient for burst for an expandable tubular member for radial expansion and plastic deformation of the expandable tubular member by an expansion device, wherein the design coefficient for burst is given by the equation:

$${c}_{bur} := \frac{{p}_{bur}}{p}$$

where c_{bur} is the design coefficient for burst for the expandable tubular member, p_{bur} is a burst pressure of the expandable tubular member, and p is a pressure needed to propagate the expansion device.

A method for operating an expansion device to radially expand and plastically deform an expandable tubular member has been described that includes displacing an expansion device through an expandable tubular member using an expansion force, wherein the expansion force is given by the equation:

$${F}_{exp} := p \cdot {σ}_{T} \cdot \frac{π \cdot {( {D}_{pig} )}^{2}}{4}$$

where Fₑₓₚ is an expansion force needed to radially expand and plastically deform the expandable tubular member, p is a pressure needed to propagate the expansion device, σ_{T} is a stress in the expandable tubular member given by the Von Mises condition and is a function of stresses in the expandable tubular member, and D_{pig} is a diameter of the expansion device.

A computer program has been described that includes a computer readable medium comprising program instructions operable to determine the expansion force needed to radially expand and plastically deform an expandable tubular member by an expansion device, wherein the expansion force is given by the equation:

$${F}_{exp} := p \cdot {σ}_{T} \cdot \frac{π \cdot {( {D}_{pig} )}^{2}}{4}$$

where Fₑₓₚ is an expansion force needed to radially expand and plastically deform the expandable tubular member, p is a pressure needed to propagate the expansion device, σ_{T} is a stress in the expandable tubular member given by the Von Mises condition and is a function of stresses in the expandable tubular member, and D_{pig} is a diameter of the expansion device.

A method for operating an expansion device to radially expand and plastically deform an expandable tubular member has been described that includes displacing an expansion device through an expandable tubular member using an expansion force, wherein the expansion force is given by the equation:

$$F = 2 \cdot π \cdot {\int }_{{r}_{i}}^{{r}_{f}} ( {p}_{n} \cdot sin ( α ) + μ \cdot {p}_{n} \cdot cos ( α ) ) \cdot \frac{r}{sin ( α ) \cdot cos ( α )} ⅆ r$$

where F is a force needed to radially expand and plastically deform the expandable tubular member, rᵢ is an initial radius of the expandable tubular member, r_{f} is a final expanded radius of the expandable tubular member, pₙ is a normal force on the expandable tubular member, μ is a coefficient of friction between the expansion device and the expandable tubular member, α is an expansion surface angle of the expansion device, r is a radius of the expandable tubular member, and dr is an incremental change in the radius of the expandable tubular member.

A computer program has been described that includes a computer readable medium comprising program instructions operable to determine the force needed to radially expand and plastically deform an expandable tubular member by an expansion device, wherein the expansion force is given by the equation:

$$F = 2 \cdot π \cdot {\int }_{{r}_{i}}^{{r}_{f}} ( {p}_{n} \cdot sin ( α ) + μ \cdot {p}_{n} \cdot cos ( α ) ) \cdot \frac{r}{sin ( α ) \cdot cos ( α )} ⅆ r$$

where F is a force needed to radially expand and plastically deform the expandable tubular member, r is an initial radius of the expandable tubular member, r_{f} is a final expanded radius of the expandable tubular member, pₙ is a normal force on the expandable tubular member, μ is a coefficient of friction between the expansion device and the expandable tubular member, α is an expansion surface angle of the expansion device, r is a radius of the expandable tubular member, and dr is an incremental change in the radius of the expandable tubular member.a

A method for operating an expansion device to radially expand and plastically deform an expandable tubular member has been described that includes displacing an expansion device through an expandable tubular member using an expansion force, wherein the expansion force is given by the equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} {p}_{n} \cdot r ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, pₙ is a normal force on the expandable tubular member, r is a radius of the expandable tubular member, and dr is an incremental change in the radius of the expandable tubular member.

A computer program has been described that includes a computer readable medium comprising program instructions operable to determine the force needed to radially expand and plastically deform an expandable tubular member by an expansion device, wherein the expansion force is given by the equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} {p}_{n} \cdot r ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, pₙ is a normal force on the expandable tubular member, r is a radius of the expandable tubular member, and dr is an incremental change in the radius of the expandable tubular member.

A method for operating an expansion device to radially expand and plastically deform an expandable tubular member has been described that includes displacing an expansion device through an expandable tubular member using an expansion force, wherein the expansion force is given by the equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} \frac{{σ}_{t} \cdot cos ( α )}{r} \cdot h \cdot r ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, σₜ is a stress in the expandable tubular member, r is the radius of the expandable tubular member, h is a thickness of the expandable tubular member, and dr is an incremental change in the radius of the expandable tubular member.

A computer program has been described that includes a computer readable medium comprising program instructions operable to determine the force needed to radially expand and plastically deform an expandable tubular member by an expansion device, wherein the expansion force is given by the equation:

$$F = 2 \cdot π \cdot \frac{sin ( α ) + μ \cdot cos ( α )}{sin ( α ) \cdot cos ( α )} \cdot {\int }_{{r}_{i}}^{{r}_{f}} \frac{{σ}_{t} \cdot cos ( α )}{r} \cdot h \cdot r ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, σₜ is a stress in the expandable tubular member, r is the radius of the expandable tubular member, h is a thickness of the expandable tubular member, and dr is an incremental change in the radius of the expandable tubular member.

A method for operating an expansion device to radially expand and plastically deform an expandable tubular member has been described that includes displacing an expansion device through an expandable tubular member using an expansion force, wherein the expansion force is given by the equation:

$$F = 2 \cdot π \cdot \frac{sin ( α ) + μ \cdot cos ( α )}{sin ( α )} \cdot {\int }_{{r}_{i}}^{{r}_{f}} {σ}_{t} \cdot h ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, σₜ is a stress in the expandable tubular member, h is a thickness of the expandable tubular member, and dr is an incremental change in the radius of the expandable tubular member.

A computer program has been described that includes a computer readable medium comprising program instructions operable to determine the force needed to radially expand and plastically deform an expandable tubular member by an expansion device, wherein the expansion force is given by the equation:

$$F = 2 \cdot π \cdot \frac{sin ( α ) + μ \cdot cos ( α )}{sin ( α )} \cdot {\int }_{{r}_{i}}^{{r}_{f}} {σ}_{t} \cdot h ⅆ r$$

where F is a force needed to radially expand and plastically deform the expandable tubular member, α is an expansion surface angle of the expansion device, μ is a coefficient of friction between the expansion device and the expandable tubular member, rᵢ is an initial radius of the expandable tubular member, r_{f} is a final expanded radius of the expandable tubular member, σₜ is a stress in the expandable tubular member, h is a thickness of the expandable tubular member, and dr is an incremental change in the radius of the expandable tubular member.

A method for operating an expansion device to radially expand and plastically deform an expandable tubular member has been described that includes displacing an expansion device through an expandable tubular member using an expansion force, wherein the expansion force is given by the equation:

$${F}_{i + 1} := \begin{matrix}{F}_{i} + 2 \cdot π \cdot \frac{sin ( α ) + μ \cdot cos ( α )}{sin ( α )} \cdot \frac{1}{2} \cdot {σ}_{T} \cdot {h}_{i} \cdot \frac{ID}{2} \cdot \\ ( {S}_{{t}_{i + 1}} \cdot {H}_{i + 1} + {S}_{{t}_{i}} \cdot {H}_{i} ) \cdot ( {R}_{i + 1} - {R}_{i} )\end{matrix}$$

where α is an expansion surface angle of the expansion device, ID is an inside diameter of the expandable tubular member, and σ_{T} is a stress in the expandable tubular member given by the Von Mises condition and is a function of stresses in the expandable tubular member.

A computer program has been described that includes a computer readable medium comprising program instructions operable to determine the force needed to radially expand and plastically deform an expandable tubular member by an expansion device, wherein the expansion force is given by the equation:

$${F}_{i + 1} := \begin{matrix}{F}_{i} + 2 \cdot π \cdot \frac{sin ( α ) + μ \cdot cos ( α )}{sin ( α )} \cdot \frac{1}{2} \cdot {σ}_{T} \cdot {h}_{i} \cdot \frac{ID}{2} \cdot \\ ( {S}_{{t}_{i + 1}} \cdot {H}_{i + 1} + {S}_{{t}_{i}} \cdot {H}_{i} ) \cdot ( {R}_{i + 1} - {R}_{i} )\end{matrix}$$

where α is an expansion surface angle of the expansion device, ID is an inside diameter of the expandable tubular member, and σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member using a pressure, wherein the pressure is given by the equation:

$${p}_{j} := \frac{[ {( {D}_{pig} + 2 \cdot {h}_{j} \cdot {H}_{100} )}^{2} - {D}_{pig}^{2} ] \cdot {S}_{{s}_{100}}}{{D}_{pig}^{2}} \cdot {σ}_{T}$$

where pⱼ is a pressure needed to propagate the expansion device, D_{pig} is a diameter of the expansion device, and σ_{T} is a stress in the expandable tubular member given by the Von Mises condition and is a function of stresses in the expandable tubular member.

A computer program has been described that includes a computer readable medium comprising program instructions operable to determine the pressure to apply to an expansion device in order to radially expand and plastically deform an expandable tubular member with the expansion device, wherein the pressure is given by the equation:

$${p}_{j} := \frac{[ {( {D}_{pig} + 2 \cdot {h}_{j} \cdot {H}_{100} )}^{2} - {D}_{pig}^{2} ] \cdot {S}_{{s}_{100}}}{{D}_{pig}^{2}} \cdot {σ}_{T}$$

where pⱼ is a pressure needed to propagate the expansion device, D_{pig} is a diameter of the expansion device, and σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member with exceeding a burst pressure, wherein the burst pressure is given by the equation:

$${p}_{{bur}_{j}} := \frac{1.75 \cdot {h}_{j} \cdot {H}_{100}}{( {D}_{pig} + 2 \cdot {h}_{j} \cdot {H}_{100} )} \cdot {σ}_{T}$$

where p_{burj} is a burst pressure of the expandable tubular member, D_{pig} is a diameter of the expansion device, and σ_{T} is a stress in the expandable tubular member given by the Von Mises condition and is a function of stresses in the expandable tubular member.

A computer program has been described that includes a computer readable medium comprising program instructions operable to determine the burst pressure for an expandable tubular member during radial expansion and plastic deformation of the expandable tubular member by an expansion device, wherein the burst pressure is given by the equation:

$${p}_{{bur}_{j}} := \frac{1.75 \cdot {h}_{j} \cdot {H}_{100}}{( {D}_{pig} + 2 \cdot {h}_{j} \cdot {H}_{100} )} \cdot {σ}_{T}$$

where p_{burj} is a burst pressure of the expandable tubular member, D_{pig} is a diameter of the expansion device, and σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and creating stresses in the expandable tubular member, wherein the stresses are given by the equation:

$${σ}_{{i}_{j}} := \sqrt{{( \frac{{p}_{j} \cdot {D}_{pig}}{2 \cdot {h}_{j}} )}^{2} - [ ( \frac{{p}_{j} \cdot {D}_{pig}}{2 \cdot {h}_{j}} ) \cdot {S}_{{s}_{100}} \cdot {σ}_{T} + {( {S}_{{s}_{100}} \cdot {σ}_{T} )}^{2} ]}$$

where σᵢⱼ is a stress in the expandable tubular member, D_{pig} is a diameter of the expansion device, and σ_{T} is a stress in the expandable tubular member given by the Von Mises condition and is a function of stresses in the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$${σ}_{{i}_{j}} := \sqrt{{( \frac{{p}_{j} \cdot {D}_{pig}}{2 \cdot {h}_{j}} )}^{2} - [ ( \frac{{p}_{j} \cdot {D}_{pig}}{2 \cdot {h}_{j}} ) \cdot {S}_{{s}_{100}} \cdot {σ}_{T} + {( {S}_{{s}_{100}} \cdot {σ}_{T} )}^{2} ]}$$

where σᵢⱼ is a stress in the expandable tubular member, D_{pig} is a diameter of the expansion device, and σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and creating strains in the expandable tubular member, wherein the strains are given by the equation:

$$d {ɛ}_{t} = \frac{\overline{d {ɛ}_{i}}}{2 \cdot {σ}_{i}} \cdot [ 2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ ) ]$$

where dεₜ is an incremental change in a tangential strain in the expandable tubular member, and ψ is a function which is a function of a radius of the expandable tubular member.

A computer program has been described that includes a computer readable medium comprising program instructions operable to determine the strains associated with the radial expansion and plastic deformation of an expandable tubular member by an expansion device, wherein the strains are given by the equation:

$$d {ɛ}_{t} = \frac{\overline{d {ɛ}_{i}}}{2 \cdot {σ}_{i}} \cdot [ 2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ ) ]$$

where dεₜ is an incremental change in a tangential strain in the expandable tubular member, and ψ is a function which is a function of a radius of the expandable tubular member.

A method for operating an expansion device to radially expand and plastically deform an expandable tubular member has been described that includes displacing an expansion device through an expandable tubular member and creating strains in the expandable tubular member, wherein the strains are given by the equation:
dεₜ=dεᵢ·sin(ψ)
where dεₜ is an incremental change in a tangential strain in the expandable tubular member, and ψ is a function which is a function of a radius of the expandable tubular member.

A computer program has been described that includes a computer readable medium comprising program instructions operable to determine the strains associated with the radial expansion and plastic deformation of an expandable tubular member by an expansion device, wherein the strains are given by the equation:
dεₜ=dεᵢ·sin(ψ)
where dεₜ is an incremental change in a tangential strain in the expandable tubular member, and ψ is a function which is a function of a radius of the expandable tubular member.

A method for operating an expansion device to radially expand and plastically deform an expandable tubular member has been described that includes displacing an expansion device through an expandable tubular member and creating strains in the expandable tubular member, wherein the strains are given by the equation:

$$d {ɛ}_{r} = - \frac{\overline{d {ɛ}_{i}}}{2 \cdot {σ}_{i}} \cdot ( \frac{2}{\sqrt{3}} \cdot {σ}_{i} \cdot cos ( ψ ) + \frac{2}{\sqrt{3}} . {σ}_{i} \cdot cos ( ψ - \frac{π}{3} ) )$$

where dεᵣ is an incremental change in a radial strain in the expandable tubular member, and ψ is a function which is a function of a radius of the expandable tubular member.

A computer program has been described that includes a computer readable medium comprising program instructions operable to determine the strains associated with the radial expansion and plastic deformation of an expandable tubular member by an expansion device, wherein the strains are given by the equation:

$$d {ɛ}_{r} = - \frac{\overline{d {ɛ}_{i}}}{2 \cdot {σ}_{i}} \cdot ( \frac{2}{\sqrt{3}} \cdot {σ}_{i} \cdot cos ( ψ ) + \frac{2}{\sqrt{3}} \cdot {σ}_{i} \cdot cos ( ψ - \frac{π}{3} ) )$$

where dεᵣ is an incremental change in a radial strain in the expandable tubular member, and ψ is a function which is a function of a radius of the expandable tubular member.

A method for operating an expansion device to radially expand and plastically deform an expandable tubular member has been described that includes displacing an expansion device through an expandable tubular member and creating strains in the expandable tubular member, wherein the strains are given by the equation

$$d {ɛ}_{r} = - 1 \cdot d {ɛ}_{i} \cdot sin ( ψ + \frac{π}{3} )$$

where dεᵣ is an incremental change in a radial strain in the expandable tubular member, and ψ is a function which is a function of a radius of the expandable tubular member.

A computer program has been described that includes a computer readable medium comprising program instructions operable to determine the strains associated with the radial expansion and plastic deformation of an expandable tubular member by an expansion device, wherein the strains are given by the equation:

$$d {ɛ}_{r} = - 1 \cdot d {ɛ}_{i} \cdot sin ( ψ + \frac{π}{3} )$$

where dεᵣ is an incremental change in a radial strain in the expandable tubular member, and ψ is a function which is a function of a radius of the expandable tubular member

A method for operating an expansion device to radially expand and plastically deform an expandable tubular member has been described that includes displacing an expansion device through an expandable tubular member and creating stresses and strains in the expandable tubular member, wherein the stresses and strains are: given by the equation:

$$\frac{ⅆ {σ}_{s}}{ⅆ {ɛ}_{t}} - \frac{{σ}_{s} + {σ}_{t}}{2 \cdot {σ}_{t} - {σ}_{s}} \cdot {σ}_{s} + {σ}_{s} - k \cdot {σ}_{t} = 0$$

where dσₛ is an incremental change in a stress in the expandable tubular member, dσₜ is an incremental change in a stress in the expandable tubular member, σₛ is a stress in the expandable tubular member, σₜ is a stress in the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses and strains associated with the radial expansion and plastic deformation of an expandable tubular member by an expansion device, wherein the stresses and strains are given by the equation:

$$\frac{ⅆ {σ}_{s}}{ⅆ {ɛ}_{t}} - \frac{{σ}_{s} + {σ}_{t}}{2 \cdot {σ}_{t } - {σ}_{s}} \cdot {σ}_{s} + {σ}_{s} - k \cdot {σ}_{t} = 0$$

where dσₛ is an incremental change in a stress in the expandable tubular member, dσₜ is an incremental change in a stress in the expandable tubular member, σₛ is a stress in the expandable tubular member, σₜ is a stress in the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expandable tubular member, wherein the stresses are given by the equation:

$$\frac{\frac{2}{\sqrt{3}} \cdot d {σ}_{i} \cdot cos ( ψ ) - \frac{2}{\sqrt{3}} \cdot {σ}_{i} \cdot sin ( ψ ) \cdot d ψ}{d {ɛ}_{i} \cdot sin ( ψ )} - \frac{\frac{2}{\sqrt{3}} \cdot {σ}_{i} \cdot cos ( ψ ) + \frac{2}{\sqrt{3}} \cdot {σ}_{i} \cdot cos ( ψ - \frac{π}{3} )}{2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + • … = 0 + \frac{2}{\sqrt{3}} \cdot {σ}_{i} \cdot cos ( ψ ) - k \cdot ( \frac{2}{\sqrt{3}} \cdot {σ}_{i} \cdot cos ( ψ - \frac{π}{3} ) )$$

where ψ is a function which is a function of a radius of the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$\frac{\frac{2}{\sqrt{3}} \cdot d {σ}_{i} \cdot cos ( ψ ) - \frac{2}{\sqrt{3}} \cdot {σ}_{i} \cdot sin ( ψ ) \cdot d ψ}{d {ɛ}_{i} \cdot sin ( ψ )} - \frac{\frac{2}{\sqrt{3}} \cdot {σ}_{i} \cdot cos ( ψ ) + \frac{2}{\sqrt{3}} \cdot {σ}_{i} \cdot cos ( ψ - \frac{π}{3} )}{2 \cdot ( \frac{2}{\sqrt{3}} \cdot {σ}_{i} \cdot cos ( ψ - \frac{π}{3} ) ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + • … = 0 + \frac{2}{\sqrt{3}} \cdot {σ}_{i} \cdot cos ( ψ ) - k \cdot ( \frac{2}{\sqrt{3}} \cdot {σ}_{i} \cdot cos ( ψ - \frac{π}{3} ) )$$

where ψ is a function which is a function of a radius of the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expandable tubular member, wherein the stresses are given by the equation:

$$\frac{d {σ}_{i} \cdot cot ( ψ ) - {σ}_{i} \cdot d ψ}{d {ɛ}_{i}} - \frac{{σ}_{i} \cdot cos ( ψ ) + {σ}_{i} \cdot cos ( ψ - \frac{π}{3} )}{2 \cdot \frac{2}{\sqrt{3}} \cdot {σ}_{i} \cdot cos ( ψ - \frac{π}{3} ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + • … = 0 + {σ}_{i} \cdot cos ( ψ ) - k \cdot {σ}_{i} \cdot cos ( ψ - \frac{π}{3} )$$

where ψ is a function which is a function of a radius of the expandable tubular member, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$\frac{d {σ}_{i} \cdot cot ( ψ ) - {σ}_{i} \cdot d ψ}{d {ɛ}_{i}} - \frac{{σ}_{i} \cdot cos ( ψ ) + {σ}_{i} \cdot cos ( ψ - \frac{π}{3} )}{2 \cdot \frac{2}{\sqrt{3}} \cdot {σ}_{i} \cdot cos ( ψ - \frac{π}{3} ) - \frac{2}{\sqrt{3}} \cdot {σ}_{i} \cdot cos ( ψ )} \cdot ( \frac{2}{\sqrt{3}} \cdot {σ}_{i} \cdot cos ( ψ ) ) + • … = 0 + {σ}_{i} \cdot cos ( ψ ) - k \cdot {σ}_{i} \cdot cos ( ψ - \frac{π}{3} )$$

where ψ is a function which is a function of a radius of the expandable tubular member, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expandable tubular member, wherein the stresses are given by the equation:

$$d ψ = ( sin ( ψ - \frac{π}{3} ) \cdot cot ( ψ ) - k \cdot cos ( ψ - \frac{1}{3} \cdot π ) ) \cdot d {ɛ}_{i} + d {σ}_{i} \cdot \frac{cot ( ψ )}{{σ}_{i}}$$

where ψ is a function which is a function of a radius of the expandable tubular member, dψis an incremental change in the function ψ, and k=1+μcot(α), where μ is a coefficient of friction between the expansion device and the expandable tubular member and α is an expansion surface angle of the expansion device.

A computer program has been described that includes a computer readable medium comprising program instructions operable to determine the stresses associated with the radial expansion and plastic deformation of an expandable tubular member by an expansion device, wherein the stresses are given by the equation:

$$d ψ = ( sin ( ψ - \frac{π}{3} ) \cdot cot ( ψ ) - k \cdot cos ( ψ - \frac{1}{3} \cdot π ) ) \cdot d {ɛ}_{i} + d {σ}_{i} \cdot \frac{cot ( ψ )}{{σ}_{i}}$$

where ψ is a function which is a function of a radius of the expandable tubular member, dψis an incremental change in the function ψ, and k=1+μcot(α), where μ is a coefficient of friction between the expansion device and the expandable tubular member and α is an expansion surface angle of the expansion device.

A method for operating an expansion device to radially expand and plastically deform an expandable tubular member has been described that includes displacing an expansion device through an expandable tubular member and creating stresses in the expandable tubular member, wherein the stresses are given by the equation:

$${S}_{s {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} )$$

where σ_{T} is a stress in the expandable tubular member given by the Von Mises condition and is a function of stresses in the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$${S}_{s {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} )$$

where σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and creating stresses in the expandable tubular member, wherein the stresses are given by the equation:

$${S}_{s {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} )$$

where σ_{T} is a stress in the expandable tubular member given by the Von Mises condition and is a function of stresses in the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$${S}_{s {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} )$$

where σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and creating stresses in the expandable tubular member, wherein the stresses are given by the equation:

$${S}_{t {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} - \frac{π}{3} )$$

where σ_{T} is a stress in the expandable tubular member given by the Von Mises condition and is a function of stresses in the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$${S}_{t {2}_{i}} := \frac{2}{\sqrt{3}} \cdot \frac{{σ}_{i} ( {ɛ}_{{2}_{i}} , n )}{{σ}_{T}} \cdot cos ( {ψ}_{{2}_{i}} - \frac{π}{3} )$$

where σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and creating stresses in the expandable tubular member, wherein the stresses are given by the equation:

$${S}_{t {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} - \frac{π}{3} )$$

where σ_{T} is a stress in the expandable tubular member given by the Von Mises condition and is a function of stresses in the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$${S}_{t {1}_{i}} := \frac{2}{\sqrt{3}} \cdot \frac{{σ}_{i} ( {ɛ}_{{1}_{i}} , 0 )}{{σ}_{T}} \cdot cos ( {ψ}_{{1}_{i}} - \frac{π}{3} )$$

where σ_{T} is a stress in the expandable tubular member given by the Von Mises condition and is a function of stresses in the expandable tubular member.

A method for operating an expansion device to radially expand and plastically deform an expandable tubular member has been described that includes displacing an expansion device through an expandable tubular member and changing a thickness of the expandable tubular member, wherein the thickness of the expandable tubular member is given by the equation:

$$\frac{dh}{h} = - 1 \cdot d {ɛ}_{i} \cdot sin ( ψ + \frac{π}{3} )$$

where dh is an incremental change in a thickness of the expandable tubular member, h is a thickness of the expandable tubular member, and ψ is a function which is a function of a radius of the expandable tubular member.

A computer program has been described that includes a computer readable medium comprising program instructions operable to determine the stresses associated with the radial expansion and plastic deformation of an expandable tubular member by an expansion device, wherein the stresses are given by the equation:

$$\frac{dh}{h} = - 1 \cdot d {ɛ}_{i} \cdot sin ( ψ + \frac{π}{3} )$$

where dh is an incremental change in a thickness of the expandable tubular member, h is a thickness of the expandable tubular member, and ψ is a function which is a function of a radius of the expandable tubular member.

A method for operating an expansion device to radially expand and plastically deform an expandable tubular member has been described that includes displacing an expansion device through an expandable tubular member using a pressure, wherein the pressure is given by the equation:

$${p}_{2} \text{:} = \frac{[ {( {D}_{pig} + 2 \cdot {h}_{i} \cdot {H}_{{2}_{100}} )}^{2} - {D}_{pig}^{2} ] \cdot {S}_{s {2}_{100}}}{{D}_{pig}^{2}}$$

where p₂ is a pressure needed to propagate the expansion device and D_{pig} is a diameter of the expansion device.

A computer program has been described that includes a computer readable medium comprising program instructions operable to determine the pressure to apply to an expansion device in order to radially expand and plastically deform an expandable tubular member with the expansion device, wherein the pressure is given by the equation:

$${p}_{2} \text{:} = \frac{[ {( {D}_{pig} + 2 \cdot {h}_{i} \cdot {H}_{{2}_{100}} )}^{2} - {D}_{pig}^{2} ] \cdot {S}_{s {2}_{100}}}{{D}_{pig}^{2}}$$

where p₂ is a pressure needed to propagate the expansion device and D_{pig} is a diameter of the expansion device.

A method for operating an expansion device to radially expand and plastically deform an expandable tubular member has been described that includes displacing an expansion device through an expandable tubular member without exceeding a burst pressure, wherein the burst pressure is given by the equation:

$${P}_{bur} = \frac{1.75 \cdot {h}_{f} {σ}_{T}}{{OD}_{f}}$$

where P_{bur} is a burst pressure of the expandable tubular member, h_{f} is a thickness of the expandable tubular member upon burst(?), σ_{T} is a stress in the expandable tubular member given by the Von Mises condition and is a function of stresses in the expandable tubular member, and OD_{f} is a final outside diameter of the expandable tubular member.

A computer program has been described that includes a computer readable medium comprising program instructions operable to determine the burst pressure for an expandable tubular member during radial expansion and plastic deformation of the expandable tubular member by an expansion device, wherein the burst pressure is given by the equation:

$${P}_{bur} = \frac{1.75 \cdot {h}_{f} {σ}_{T}}{{OD}_{f}}$$

where P_{bur} is a burst pressure of the expandable tubular member, h_{f} is a thickness of the expandable tubular member upon burst(?), σ_{T} is a stress in the expandable tubular member given by the Von Mises condition and is a function of stresses in the expandable tubular member, and OD_{f} is a final outside diameter of the expandable tubular member.

A method for operating an expansion device to radially expand and plastically deform an expandable tubular member has been described that includes displacing an expansion device through an expandable tubular member using an expansion force, wherein the expansion force is given by the equation:

$${F}_{exp 1} \text{:} = {p}_{1} \cdot {σ}_{T} \cdot \frac{π \cdot {( {D}_{pig} )}^{2}}{4}$$

where Fₑₓₚ₁ is a first expansion force, p₁ is a pressure used to expand the expandable tubular member, σ_{T} is a stress in the expandable tubular member given by the Von Mises condition and is a function of stresses in the expandable tubular member, and D_{pig} is a diameter of the expansion device.

A computer program has been described that includes a computer readable medium comprising program instructions operable to determine the force needed to radially expand and plastically deform an expandable tubular member by an expansion device, wherein the expansion force is given by the equation:

$${F}_{exp 1} \text{:} = {p}_{1} \cdot {σ}_{T} \cdot \frac{π \cdot {( {D}_{pig} )}^{2}}{4}$$

where Fₑₓₚ₁ is a first expansion force, p₁ is a pressure used to expand the expandable tubular member, σ_{T} is a stress in the expandable tubular member given by the Von Mises condition and is a function of stresses in the expandable tubular member, and D_{pig} is a diameter of the expansion device.

A method for operating an expansion device to radially expand and plastically deform an expandable tubular member has been described that includes displacing an expansion device through an expandable tubular member using an expansion force, wherein the expansion force is given by the equation:

$${F}_{exp 2} \text{:} = {p}_{2} \cdot {σ}_{T} \cdot \frac{π \cdot {( {D}_{pig} )}^{2}}{4}$$

where Fₑₓₚ₂ is a second expansion force, p₂ is a pressure used to expand the expandable tubular member, σ_{T} is a stress in the expandable tubular member given by the Von Mises condition and is a function of stresses in the expandable tubular member, and D_{pig} is a diameter of the expansion device.

A computer program has been described that includes a computer readable medium comprising program instructions operable to determine the force needed to radially expand and plastically deform an expandable tubular member by an expansion device, wherein the expansion force is given by the equation:

$${F}_{exp 2} \text{:} = {p}_{2} \cdot {σ}_{T} \cdot \frac{π \cdot {( {D}_{pig} )}^{2}}{4}$$

where Fₑₓₚ₂ is a second expansion force, p₂ is a pressure used to expand the expandable tubular member, σ_{T} is a stress in the expandable tubular member given by the Von Mises condition and is a function of stresses in the expandable tubular member, and D_{pig} is a diameter of the expansion device.

A method for operating an expansion device to radially expand and plastically deform an expandable tubular member has been described that includes displacing an expansion device through an expandable tubular member and creating strains in the expandable tubular member, wherein the strains are given by the equation:

$${ɛ}_{hoop} \text{:} = ln ( \frac{{R}_{{2}_{N}}}{{R}_{{2}_{0}}} )$$

where εₕₒₒₚ is the hoop strain in the expandable tubular member.

A computer program has been described that includes a computer readable medium comprising program instructions operable to determine the strains associated with the radial expansion and plastic deformation of an expandable tubular member by an expansion device, wherein the strains are given by the equation:

$${ɛ}_{hoop} := ln ( \frac{{R}_{{2}_{N}}}{{R}_{{2}_{0}}} )$$

where εₕₒₒₚ is the hoop strain in the expandable tubular member.

A method for operating an expansion device to radially expand and plastically deform an expandable tubular member has been described that includes displacing an expansion device through an expandable tubular member and creating strains in the expandable tubular member, wherein the strains are given by the equation:

$${ɛ}_{h} := ln ( \frac{{H}_{{2}_{N}}}{{H}_{{2}_{0}}} )$$

where εₕ is the strain in the expandable tubular member.

A computer program has been described that includes a computer readable medium comprising program instructions operable to determine the strains associated with the radial expansion and plastic deformation of an expandable tubular member by an expansion device, wherein the strains are given by the equation:

$${ɛ}_{h} := ln ( \frac{{H}_{{2}_{N}}}{{H}_{{2}_{0}}} )$$

where εₕ is the strain in the expandable tubular member.

A method for operating an expansion device to radially expand and plastically deform an expandable tubular member has been described that includes displacing an expansion device through an expandable tubular member, comprising one or more of the following: displacing the expansion device through the expandable tubular member using a pressure; and displacing the expansion device through the expandable tubular member using an expansion force; wherein the pressure is a function of one or more of the following sets of variables: a set of variables comprising r_{pig}, h_{f} and σₛ; a set of variables comprising D_{pig}, hᵢ, H₁₀₀ and S_{s 100}; a set of variables comprising D_{pig}, hⱼ, H₁₀₀, S_{s 100} and σ_{T}; and a set of variables comprising D_{pig}, hᵢ, H_{2 100} and S_{s2 100}; a set of variables comprising r_{f}, pₙ α, rᵢ, pₙ(r), r and dr; and a set of variables comprising r_{f}, μ, α, rᵢ, pₙ(r), r and dr; and wherein the expansion force is a function of one or more of the following sets of variables: a set of variables comprising p, σ_{T} and D_{pig}; a set of variables comprising rᵢ, r_{f}, pₙ, μ, α, r and dr; a set of variables comprising α, μ, rᵢ, r_{f}, pₙ, r and dr; a set of variables comprising α, μ, rᵢ, r_{f}, σₜ, r, h and dr; a set of variables comprising α, μ, rᵢ, r_{f}, σₜ, h and dr; a set of variables comprising α, μ, σ_{T}, h, ID, Sₜ, H and R; a set of variables comprising p₁, σ_{T} and D_{pig}; and a set of variables comprising p₂, σ_{T} and D_{pig}. In an exemplary embodiment, displacing the expansion device through the expandable tubular member comprises displacing the expansion device through the expandable tubular member using the pressure. In an exemplary embodiment, displacing the expansion device through the expandable tubular member comprises displacing the expansion device through the expandable tubular member using the expansion force.

A method for operating an expansion device to radially expand and plastically deform an expandable tubular member has been described that includes displacing an expansion device through an expandable tubular member; and changing at least one of a radius of the expandable tubular member and a thickness of the expandable tubular member; wherein the radii of the expandable tubular member are a function of one or more of the following sets of variables: a set of variables comprising r, dr, ψ(r) and dψ; and a set of variables comprising rᵢ₁, rᵢ, ψᵢ, ψᵢ₁, μ and α; and wherein the thickness of the expandable tubular member is a function of one or more of the following sets of variables: a set of variables comprising r, dσₛ, dr, h, σₛ, dh, μ and α; a set of variables comprising r, dr, h, σₛ, dh and σ₁; a set of variables comprising h, ψ, dψ, dh, μ and α; and a set of variables comprising dh, h, ε₁ and ψ. In an exemplary embodiment, changing at least one of the radius of the expandable tubular member and the thickness of the expandable tubular member comprises changing the radius of the expandable tubular member. In an exemplary embodiment, changing at least one of the radius of the expandable tubular member and the thickness of the expandable tubular member comprises changing the thickness of the expandable tubular member.

A method for operating an expansion device to radially expand and plastically deform an expandable tubular member has been described that includes displacing an expansion device through an expandable tubular member without exceeding a burst pressure, wherein the burst pressure is a function of one or more of the following sets of variables: a set of variables comprising h_{f}, σ_{T} and OD_{f}; a set of variables comprising hᵢ, H₁₀₀ and D_{pig}; a set of variables comprising c_{bur} and p; a set of variables comprising hⱼ, H₁₀₀, D_{pig} and σ_{T}; and a set of variables comprising h_{f}, σ_{T} and OD_{f}.

A method for operating an expansion device to radially expand and plastically deform an expandable tubular member has been described that includes displacing an expansion device through an expandable tubular member; and creating one or more of the following: stresses in the expandable tubular member, wherein the stresses are functions of one or more of the following sets of variables: a set of variables comprising pⱼ, hⱼ, D_{pig} S_{s 100} and σ_{T}; a set of variables comprising ψ, dψ, ε₁, μ and α; a set of variables comprising ψ, dψ, E, μ and α; a set of variables comprising S_{s 1}, ε₁, σ_{T} and ψ₁; a set of variables comprising S_{s 2}, ε₂, n, ψ₂ and σ_{T}; a set of variables comprising S_{t 2}, ε₂, n, ψ₂ and σ_{T}; and a set of variables comprising S_{t 1}, ε₁, σ_{T} and ψ₁; strains in the expandable tubular member, wherein the strains are functions of one or more of the following sets of variables: a set of variables comprising dεₜ and ψ; a set of variables comprising dεᵣ and ψ; if the strains comprise hoop strain, then a set of variables comprising R_{2 N} and R_{2 0}; and a set of variables comprising H_{2 N} and H_{2 0}; stresses and strains in the expandable tubular member, wherein the stresses and strains are functions of dσₛ, dσₜ, σₛ, σₜ, μ and α; and stresses in the expansion device and the expandable tubular member, wherein the stresses are a function of one or more of the following sets of variables: a set of variables comprising r, σₛ(r), h(r), σₜ, dr, μ and α; a set of variables comprising r, dr, σₛ(r), dεᵣ, dεₜ, σₜ, μ and α; and a set of variables comprising r, dr, σₛ(r), σₜ(r), μ and α. In an exemplary embodiment, creating comprises creating the stresses in the expandable tubular member. In an exemplary embodiment, creating comprises creating the strains in the expandable tubular member. In an exemplary embodiment, creating comprises creating the stresses and strains in the expandable tubular member. In an exemplary embodiment, creating comprises creating the stresses in the expansion device and the expandable tubular member.

A computer readable medium has been described that includes program instructions operable to determine one or more of the following: a pressure to be applied to an expansion device in order to provide steady state radial expansion and plastic deformation of an expandable tubular member by the expansion device; and an expansion force needed to radially expand and plastically deform the expandable tubular member by the expansion device; wherein the pressure is a function of one or more of the following sets of variables: a set of variables comprising r_{pig}, h_{f} and as; a set of variables comprising D_{pig}, hᵢ, H₁₀₀ and S_{s 100}; a set of variables comprising D_{pig}, hⱼ, H₁₀₀, S_{s 100} and σ_{T}; and a set of variables comprising D_{pig}, hᵢ, H_{2 100} and S_{s2 100}; a set of variables comprising r_{f}, μ, α, rᵢ, pₙ(r), r and dr; and a set of variables comprising r_{f}, μ, rᵢ, pₙ(r), r and dr; and wherein the expansion force is a function of one or more of the following sets of variables: a set of variables comprising p, σ_{T} and D_{pig}; a set of variables comprising rᵢ, r_{f}, pₙ, pₙ α, r and dr; a set of variables comprising α, μ, rᵢ, r_{f}, pₙ, r and dr; a set of variables comprising α, μ, rᵢ, r_{f}, σₜ, r, h and dr; a set of variables comprising α, pₙ rᵢ, r_{f}, σₜ, h and dr; a set of variables comprising α, μ, σ_{T}, h, ID, Sₜ, H and R; a set of variables comprising p₁, σ_{T} and D_{pig}; and a set of variables comprising p₂, σ_{T} and D_{pig}. In an exemplary embodiment, the program instructions are operable to determine the pressure to be applied to the expansion device in order to provide steady state radial expansion and plastic deformation of the expandable tubular member by the expansion device. In an exemplary embodiment, the program instructions are operable to determine the expansion force needed to radially expand and plastically deform the expandable tubular member by the expansion device.

A computer readable medium has been described that includes program instructions operable to determine the change in at least one of a radius of an expandable tubular member upon radial expansion and plastic deformation of the expandable tubular member by an expansion device, and a thickness of the expandable tubular member upon the radial expansion and plastic deformation of the expandable tubular member by the expansion device; wherein the radii of the expandable tubular member are a function of one or more of the following sets of variables: a set of variables comprising r, dr, ψ(r) and dψ; and a set of variables comprising rᵢ₁, rᵢ, ψᵢ, ψᵢ₁, μ and α; and wherein the thickness of the expandable tubular member is a function of one or more of the following sets of variables: a set of variables comprising r, dσₛ, dr, h, σₛ, dh, μ and α; a set of variables comprising r, dr, h, σₛ, dh and σₜ; a set of variables comprising h, ψ, dψ, dh, μ and α; and a set of variables comprising dh, h, ε₁ and ψ. In an exemplary embodiment, the program instructions are operable to determine the change in the radius of the expandable tubular member upon the radial expansion and plastic deformation of the expandable tubular member by the expansion device. In an exemplary embodiment, the program instructions are operable to determine the change in the thickness of the expandable tubular member upon the radial expansion and plastic deformation of the expandable tubular member by the expansion device.

A computer readable medium has been described that includes program instructions operable to determine a burst pressure of an expandable tubular member adapted to be radially expanded and plastically deformed by an expansion device; wherein the burst pressure is a function of one or more of the following sets of variables: a set of variables comprising h_{f}, σ_{T} and OD_{f}; a set of variables comprising hᵢ, H₁₀₀ and D_{pig}; a set of variables comprising c_{bur} and p; a set of variables comprising hⱼ, H₁₀₀, D_{pig} and σ_{T}; and a set of variables comprising h_{f}, σ_{T} and OD_{f}.

A computer readable medium has been described that includes program instructions operable to determine one or more of the following: stresses in an expandable tubular member associated with the radial expansion and plastic deformation of the expandable tubular member by an expansion device, wherein the stresses are functions of one or more of the following sets of variables: a set of variables comprising pⱼ, hⱼ, D_{pig} S_{s 100} and σ_{T}; a set of variables comprising ψ, dψ, ε₁, μ and α; a set of variables comprising ψ, dψ, ε, μ and α; a set of variables comprising S_{s 1}, ε₁, σ_{T} and ψ₁; a set of variables comprising S_{s 2}, ε₂, n, ψ₂ and σ_{T}; a set of variables comprising S_{t 2}, ε₂, n, ψ₂ and σ_{T}; and a set of variables comprising S_{t 1}, ε₁, σ_{T} and ψ₁; strains in the expandable tubular member associated with the radial expansion and plastic deformation of the expandable tubular member by the expansion device, wherein the strains are functions of one or more of the following sets of variables: a set of variables comprising dεₜ and ψ₁; a set of variables comprising dεᵣ and ψ₁; if the strains comprise hoop strain, then a set of variables comprising R_{2 N} and R_{2 0}; and a set of variables comprising H₂ N and H_{2 0}; stresses and strains in the expandable tubular member associated with the radial expansion and plastic deformation of the expandable tubular member by the expansion device, wherein the stresses and strains are functions of dσₛ, dσₜ, σₛ, σₜ, μ and α; and stresses in the expansion device and the expandable tubular member associated with the radial expansion and plastic deformation of the expandable tubular member by the expansion device, wherein the stresses are a function of one or more of the following sets of variables: a set of variables comprising r, σₛ(r), h(r), σₜ, dr, μ and α; a set of variables comprising r, dr, σₛ(r), dεᵣ, dεₜ, σ₁, μ and α; and a set of variables comprising r, dr, σₛ(r), σₜ(r), μ and α. In an exemplary embodiment, the program instructions are operable to determine the stresses in the expandable tubular member. In an exemplary embodiment, the program instructions are operable to determine the strains in the expandable tubular member. In an exemplary embodiment, the program instructions are operable to determine the stresses and strains in the expandable tubular member. In an exemplary embodiment, the program instructions are operable to determine the stresses in the expansion device and the expandable tubular member.

A method for operating an expansion device to radially expand and plastically deform an expandable tubular member has been described that includes displacing an expansion device through an expandable tubular member using at least one of a pressure and an expansion force; changing a radius of the expandable tubular member; and changing a thickness of the expandable tubular member; wherein the pressure is a function of one or more of the following sets of variables: a set of variables comprising r_{pig}, h_{f} and σₛ; a set of variables comprising D_{pig}, hᵢ, H₁₀₀ and S_{s 100}; a set of variables comprising D_{pig}, hⱼ, H₁₀₀, S_{s 100} and σ_{T}; and a set of variables comprising D_{pig}, hᵢ, H_{2 100} and S_{s2 100}; a set of variables comprising r_{f}, μ, α, rᵢ, pₙ(r), r and dr; and a set of variables comprising r_{f}, μ, rᵢ, pₙ(r), r and dr; wherein the expansion force is a function of one or more of the following sets of variables: a set of variables comprising p, σ_{T} and D_{pig}; a set of variables comprising rᵢ, r_{f}, pₙ, pₙ α, r and dr; a set of variables comprising α, μ, rᵢ, r pₙ, r and dr; a set of variables comprising α, μ, rᵢ, r_{f}, σₜ, r, h and dr; a set of variables comprising α, μ, rᵢ, r_{f}, σₜ, h and dr; a set of variables comprising α, μ, σ_{T}, h, ID, Sₜ, H and R; a set of variables comprising P₁, σ_{T} and D_{pig}; and a set of variables comprising p₂, σ_{T} and D_{pig}; wherein the radii of the expandable tubular member are a function of one or more of the following sets of variables: a set of variables comprising r, dr, ψ(r) and dψ; and a set of variables comprising rᵢ₁, rᵢ, ψᵢ, ψᵢ₁, μ and α; wherein the thickness of the expandable tubular member is a function of one or more of the following sets of variables: a set of variables comprising r, dσₛ, dr, h, σₛ, dh, μ and α; a set of variables comprising r, dr, h, σₛ, dh and σₜ; a set of variables comprising h, ψ, dΨ, dh, μ and α; and a set of variables comprising dh, h, ε₁ and ψ; wherein displacing the expansion device using at least one of the pressure and the expansion force comprises displacing the expansion device through the expandable tubular member without exceeding a burst pressure, wherein the burst pressure is a function of one or more of the following sets of variables: a set of variables comprising hᵣ, σ_{T} and OD_{f}; a set of variables comprising hᵢ, H₁₀₀ and D_{pig}; a set of variables comprising c_{bur} and p; a set of variables comprising hⱼ, H₁₀₀, D_{pig} and σ_{T}; and a set of variables comprising h_{f}, σ_{T} and OD_{f}; and wherein the method further comprises creating one or more of the following: stresses in the expandable tubular member, wherein the stresses are functions of one or more of the following sets of variables: a set of variables comprising pⱼ, hⱼ, D_{pig} S_{s 100} and σ_{T}; a set of variables comprising ψ, dψ, a1, μ and α; a set of variables comprising ψ, dψ, , μ and α; a set of variables comprising S_{s 1}, ε₁, σ_{T} and ψ₁; a set of variables comprising S_{s 2}, ε₂, n, ψ₂ and σ_{T}; a set of variables comprising S_{t 2}, ε₂, n, ψ₂ and σ_{T}; and a set of variables comprising S_{t 1}, ε₁, σ_{T} and ψ₁; strains in the expandable tubular member, wherein the strains are functions of one or more of the following sets of variables: a set of variables comprising dεₜ and ψ₁; a set of variables comprising dεᵣ and ψ₁; if the strains comprise hoop strain, then a set of variables comprising R_{2 N} and R_{2 0}; and a set of variables comprising H₂ N and H_{2 0}; stresses and strains in the expandable tubular member, wherein the stresses and strains are functions of dσₛ, dσₜ, σₛ, σₜ, μ and α; and stresses in the expansion device and the expandable tubular member, wherein the stresses are a function of one or more of the following sets of variables: a set of variables comprising r, σₛ(r), h(r), σₜ, dr, μ and α; a set of variables comprising r, dr, σₛ(r), dεᵣ, dεₜ, σₜ, μ and α; and a set of variables comprising r, dr, σₛ(r), σₜ(r), μ and α.

A computer readable medium has been described that includes program instructions operable to determine the change in a radius of an expandable tubular member upon radial expansion and plastic deformation of the expandable tubular member by an expansion device; program instructions operable to determine the change in a thickness of the expandable tubular member upon the radial expansion and plastic deformation of the expandable tubular member by the expansion device; program instructions operable to determine one or more of the following: a pressure to be applied to an expansion device in order to provide steady state radial expansion and plastic deformation of an expandable tubular member by the expansion device; and an expansion force needed to radially expand and plastically deform the expandable tubular member by the expansion device; and program instructions operable to determine a burst pressure of the expandable tubular member; wherein the pressure is a function of one or more of the following sets of variables: a set of variables comprising r_{pig}, h_{f} and σₛ; a set of variables comprising D_{pig}, hᵢ, H₁₀₀ and S_{s 100}; a set of variables comprising D_{pig}, hⱼ, H₁₀₀, S_{s 100} and σ_{T}; and a set of variables comprising D_{pig}, hᵢ, H_{2 100} and S_{s2 100}; a set of variables comprising r_{f}, μ, rᵢ, pₙ(r), r and dr; and a set of variables comprising r_{f}, μ, rᵢ, pₙ(r), r and dr; wherein the expansion force is a function of one or more of the following sets of variables: a set of variables comprising p, σ_{T} and D_{pig}; a set of variables comprising rᵢ, r_{f}, pₙ, μ, α, r and dr; a set of variables comprising α, μ, rᵢ, r_{f}, pₙ, r and dr; a set of variables comprising α, μ, rᵢ, r_{f}, σₜ, r, h and dr; a set of variables comprising α, μ, rᵢ, r_{f}, σₜ, h and dr; a set of variables comprising α, μ, σ_{T}, h, ID, Sₜ, H and R; a set of variables comprising P₁, σ_{T} and D_{pig}; and a set of variables comprising p₂, σ_{T} and D_{pig}; wherein the radii of the expandable tubular member are a function of one or more of the following sets of variables: a set of variables comprising r, dr, ψ(r) and dψ; and a set of variables comprising rᵢ₁, rᵢ, ψᵢ, ψᵢ₁, μ and α; wherein the thickness of the expandable tubular member is a function of one or more of the following sets of variables: a set of variables comprising r, dσₛ, dr, h, σₛ, dh, μ and α; a set of variables comprising r, dr, h, as, dh and σₜ; a set of variables comprising h, ψ, dψ, dh, μ and α; and a set of variables comprising dh, h, ε₁ and ψ₁; wherein the burst pressure is a function of one or more of the following sets of variables: a set of variables comprising hᵣ, σ_{T} and OD_{f}; a set of variables comprising hᵢ, H₁₀₀ and D_{pig}; a set of variables comprising c_{bur} and p; a set of variables comprising hⱼ, H₁₀₀, D_{pig} and σ_{T}; and a set of variables comprising h_{f}, σ_{T} and OD_{f}; and wherein the computer readable medium further comprises program instructions operable to determine one or more of the following: stresses in an expandable tubular member associated with the radial expansion and plastic deformation of the expandable tubular member by an expansion device, wherein the stresses are functions of one or more of the following sets of variables: a set of variables comprising pⱼ, hⱼ, D_{pig} S_{s 100} and σ_{T}; a set of variables comprising ψ, dψ, ε₁, μ and α; a set of variables comprising ψ, dψ, ε, μ and α; a set of variables comprising S_{s 1}, ε₁, σ_{T} and α; a set of variables comprising S_{s 2}, ε₂, n, ψ₂ and σ_{T}; a set of variables comprising S_{t 2}, ε₂, n, ψ₂ and σ_{T}; and a set of variables comprising S_{t 1}, ε₁, σ_{T} and ψ₁; strains in the expandable tubular member associated with the radial expansion and plastic deformation of the expandable tubular member by the expansion device, wherein the strains are functions of one or more of the following sets of variables: a set of variables comprising dεₜ and ψ; a set of variables comprising dεᵣ and ψ; if the strains comprise hoop strain, then a set of variables comprising R_{2 N} and R_{2 0}; and a set of variables comprising H_{2 N} and H_{2 0}; stresses and strains in the expandable tubular member associated with the radial expansion and plastic deformation of the expandable tubular member by the expansion device, wherein the stresses and strains are functions of dσₛ, dσₜ, σₛ, σₜ, μ and α; and stresses in the expansion device and the expandable tubular member associated with the radial expansion and plastic deformation of the expandable tubular member by the expansion device, wherein the stresses are a function of one or more of the following sets of variables: a set of variables comprising r, σₛ(r), h(r), σₜ, dr, μ and α; a set of variables comprising r, dr, σₛ(r), dεᵣ, dεₜ, σₜ, μ and α; and a set of variables comprising r, dr, σₛ(r), σₜ(r), μ and α.

It is understood that variations may be made in the foregoing without departing from the scope of the invention. For example, the teachings of the present illustrative embodiments may be used to provide a wellbore casing, a pipeline, or a structural support. Furthermore, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

Although illustrative embodiments of the invention have been shown and described, a wide range of modification, changes and substitution is contemplated in the foregoing disclosure. In some instances, some features of the present invention may be employed without a corresponding use of the other features. Accordingly, it is appropriate that the appended claims be construed broadly and in a manner consistent with the scope of the invention.

What is claimed is:

1. A method for operating an expansion device to radially expand and plastically deform an expandable tubular member, comprising:
displacing an expansion device through an expandable tubular member, comprising one or more of the following:
displacing the expansion device through the expandable tubular member using a pressure; and
displacing the expansion device through the expandable tubular member using an expansion force;
wherein the pressure is a function of one or more of the following sets of variables:
a set of variables comprising r_{pig}, h_{f} and σₛ;
a set of variables comprising D_{pig}, hᵢ, H₁₀₀ and S_{s 100};
a set of variables comprising D_{pig}, hⱼ, H₁₀₀, S_{s 100} and σ_{T}; and
a set of variables comprising D_{pig}, hᵢ, H_{2 100} and S_{s2 100};
a set of variables comprising r_{f}, μ, rᵢ, pₙ(r), r and dr; and
a set of variables comprising r_{f}, μ, rᵢ, pₙ(r), r and dr;
and
wherein the expansion force is a function of one or more of the following sets of variables:
a set of variables comprising p, σ_{T} and D_{pig};
a set of variables comprising rᵢ, r_{f}, pₙ, μ, α, r and dr;
a set of variables comprising α, μ, r, r_{f}, pₙ, r and dr;
a set of variables comprising α, μ, rᵢ, r_{f}, σₜ, r, h and dr;
a set of variables comprising α, μ, rᵢ, r_{f}, σₜ, h and dr;
a set of variables comprising α, μ, σ_{T}, h, ID, Sₜ, H and R;
a set of variables comprising P₁, σ_{T} and D_{pig}; and
a set of variables comprising p₂, σ_{T} and D_{pig}.

2. The method of claim 1 wherein displacing the expansion device through the expandable tubular member comprises:
displacing the expansion device through the expandable tubular member using the pressure.

3. The method of claim 1 wherein displacing the expansion device through the expandable tubular member comprises:
displacing the expansion device through the expandable tubular member using the expansion force.

4. A method for operating an expansion device to radially expand and plastically deform an expandable tubular member, comprising:
displacing an expansion device through an expandable tubular member; and
changing at least one of a radius of the expandable tubular member and a thickness of the expandable tubular member;
wherein the radii of the expandable tubular member are a function of one or more of the following sets of variables:
a set of variables comprising r, dr, ψ(r) and dψ; and
a set of variables comprising rᵢ₁, rᵢ, ψᵢ, ψᵢ₁, μ and α;
and
wherein the thickness of the expandable tubular member is a function of one or more of the following sets of variables:
a set of variables comprising r, dσₛ, dr, h, σₛ, dh, μ and α;
a set of variables comprising r, dr, h, σₛ, dh and σₜ;
a set of variables comprising h, ψ, dψ, dh, μ and α; and
a set of variables comprising dh, h, ε₁, and ψ.

5. The method of claim 4 wherein changing at least one of the radius of the expandable tubular member and the thickness of the expandable tubular member comprises changing the radius of the expandable tubular member.

6. The method of claim 4 wherein changing at least one of the radius of the expandable tubular member and the thickness of the expandable tubular member comprises changing the thickness of the expandable tubular member.

7. A method for operating an expansion device to radially expand and plastically deform an expandable tubular member, comprising:
displacing an expansion device through an expandable tubular member without exceeding a burst pressure, wherein the burst pressure is a function of one or more of the following sets of variables:
a set of variables comprising h_{f}, σ_{T} and OD_{f};
a set of variables comprising hᵢ, H₁₀₀ and D_{pig};
a set of variables comprising c_{bur} and p;
a set of variables comprising hⱼ, H₁₀₀, D_{pig} and σ_{T}; and
a set of variables comprising h_{f}, σ_{T} and OD_{f}.

8. A method for operating an expansion device to radially expand and plastically deform an expandable tubular member, comprising:
displacing an expansion device through an expandable tubular member; and
creating one or more of the following:
stresses in the expandable tubular member, wherein the stresses are functions of one or more of the following sets of variables:
a set of variables comprising pⱼ, hⱼ, D_{pig} S_{s 100} and σ_{T};
a set of variables comprising ψ, dψ, ε₁, μ and α;
a set of variables comprising ψ, dψ, ε, μ and α;
a set of variables comprising S_{s 1}, ε₁, σ_{T} and ψ₁;
a set of variables comprising S_{s 2}, ε₂, n, ψ₂ and σ_{T};
a set of variables comprising S_{t 2}, ε₂, n, ψ₂ and σ_{T}; and
a set of variables comprising S_{t 1}, ε₁, σ_{T} and ψ₁;
strains in the expandable tubular member, wherein the strains are functions of one or more of the following sets of variables:
a set of variables comprising dεₜ and ψ₁;
a set of variables comprising dεᵣ and ψ₁;
if the strains comprise hoop strain, then a set of variables comprising R_{2 N} and R_{2 0}; and
a set of variables comprising H₂ N and H_{2 0};
stresses and strains in the expandable tubular member, wherein the stresses and strains are functions of dσₛ, dσₜ, σₛ, σₜ, μ and α;
and
stresses in the expansion device and the expandable tubular member,
wherein the stresses are a function of one or more of the following sets of variables:
a set of variables comprising r, σₛ(r), h(r), σₜ, dr, μ and α;
a set of variables comprising r, dr, σₛ(r), dεᵣ, dεₜ, σₜ, μ and α; and
a set of variables comprising r, dr, σₛ(r), at(r), μ and α.

9. The method of claim 8 wherein creating comprises creating the stresses in the expandable tubular member.

10. The method of claim 8 wherein creating comprises creating the strains in the expandable tubular member.

11. The method of claim 8 wherein creating comprises creating the stresses and strains in the expandable tubular member.

12. The method of claim 8 wherein creating comprises creating the stresses in the expansion device and the expandable tubular member.

13. A computer readable medium, comprising:
program instructions operable to determine one or more of the following:
a pressure to be applied to an expansion device in order to provide steady state radial expansion and plastic deformation of an expandable tubular member by the expansion device; and
an expansion force needed to radially expand and plastically deform the expandable tubular member by the expansion device;
wherein the pressure is a function of one or more of the following sets of variables:
a set of variables comprising r_{pig}, h_{f} and σₛ;
a set of variables comprising D_{pig}, hᵢ, H₁₀₀ and S_{s 100} a set of variables comprising D_{pig}, hⱼ, H₁₀₀, S_{s 100} and σ_{T}; and
a set of variables comprising D_{pig}, hᵢ, H_{2 100} and S_{s2 100};
a set of variables comprising r_{f}, μ, rᵢ, pₙ(r), r and dr; and
a set of variables comprising r_{f}, μ, rᵢ, pₙ(r), r and dr;
and
wherein the expansion force is a function of one or more of the following sets of variables:
a set of variables comprising p, σ_{T} and D_{pig};
a set of variables comprising rᵢ, r_{f}, pₙ p, α, r and dr;
a set of variables comprising α, μ, r, r_{f}, pₙ, r and dr;
a set of variables comprising α, μ, rᵢ, r_{f}, σₜ, r, h and dr;
a set of variables comprising α, μ, rᵢ, r_{f}, σₜ, h and dr;
a set of variables comprising α, P, σ_{T}, h, ID, Sₜ, H and R;
a set of variables comprising P₁, σ_{T} and D_{pig}; and
a set of variables comprising p₂, σ_{T} and D_{pig}.

14. The computer readable medium of claim 13 wherein the program instructions are operable to determine the pressure to be applied to the expansion device in order to provide steady state radial expansion and plastic deformation of the expandable tubular member by the expansion device.

15. The computer readable medium of claim 13 wherein the program instructions are operable to determine the expansion force needed to radially expand and plastically deform the expandable tubular member by the expansion device.

16. A computer readable medium, comprising:
program instructions operable to determine the change in at least one of:
a radius of an expandable tubular member upon radial expansion and plastic deformation of the expandable tubular member by an expansion device, and
a thickness of the expandable tubular member upon the radial expansion and plastic deformation of the expandable tubular member by the expansion device;
wherein the radii of the expandable tubular member are a function of one or more of the following sets of variables:
a set of variables comprising r, dr, ψ(r) and dψ; and
a set of variables comprising rᵢ₁, rᵢ, ψ₁, ψᵢ₁, μ and α;
and
wherein the thickness of the expandable tubular member is a function of one or more of the following sets of variables:
a set of variables comprising r, dσₛ, dr, h, σₛ, dh, μ and α;
a set of variables comprising r, dr, h, σₛ, dh and σₜ;
a set of variables comprising h, ψ, dψ, dh, μ and α; and
a set of variables comprising dh, h, ε₁ and ψ.

17. The computer readable medium of claim 16 wherein the program instructions are operable to determine the change in the radius of the expandable tubular member upon the radial expansion and plastic deformation of the expandable tubular member by the expansion device.

18. The computer readable medium of claim 16 wherein the program instructions are operable to determine the change in the thickness of the expandable tubular member upon the radial expansion and plastic deformation of the expandable tubular member by the expansion device.

19. A computer readable medium, comprising:
program instructions operable to determine a burst pressure of an expandable tubular member adapted to be radially expanded and plastically deformed by an expansion device;
wherein the burst pressure is a function of one or more of the following sets of variables:
a set of variables comprising h_{f}, σ_{T} and OD_{f};
a set of variables comprising hᵢ, H₁₀₀ and D_{pig};
a set of variables comprising c_{bur} and p;
a set of variables comprising hⱼ, H₁₀₀, D_{pig} and σ_{T}; and
a set of variables comprising h_{f}, σ_{T} and OD_{f}.

20. A computer readable medium, comprising:
program instructions operable to determine one or more of the following:
stresses in an expandable tubular member associated with the radial expansion and plastic deformation of the expandable tubular member by an expansion device, wherein the stresses are functions of one or more of the following sets of variables:
a set of variables comprising pⱼ, hⱼ, D_{pig} S_{s 100} and σ_{T};
a set of variables comprising ψ, dψ, ε₁, μ and α;
a set of variables comprising ψ, dψ, ε₁, μ and α;
a set of variables comprising S_{s 1}, ε₁, σ_{T} and ψ₁;
a set of variables comprising S_{s 2}, ε₂, n, ψ₂ and σ_{T};
a set of variables comprising S_{t 2}, ε₂, n, ψ₂ and σ_{T}; and
a set of variables comprising S_{t 1}, ε₁, σ_{T} and ψ₁;
strains in the expandable tubular member associated with the radial expansion and plastic deformation of the expandable tubular member by the expansion device, wherein the strains are functions of one or more of the following sets of variables:
a set of variables comprising dεₜ and ψ;
a set of variables comprising dεᵣ and ψ;
if the strains comprise hoop strain, then a set of variables comprising R_{2 N} and R_{2 0}; and
a set of variables comprising H₂ N and H_{2 0};
stresses and strains in the expandable tubular member associated with the radial expansion and plastic deformation of the expandable tubular member by the expansion device, wherein the stresses and strains are functions of dσₛ, dσₜ, σₛ, σₜ, μ and α;
and
stresses in the expansion device and the expandable tubular member associated with the radial expansion and plastic deformation of the expandable tubular member by the expansion device, wherein the stresses are a function of one or more of the following sets of variables:
a set of variables comprising r, σₛ(r), h(r), σₜ, dr, μ and α;
a set of variables comprising r, dr, σₛ(r), dεᵣ, dεₜ, σₜ, μ and α; and
a set of variables comprising r, dr, σₜ(r), σₜ(r), μ and α.

21. The computer readable medium of claim 20 wherein the program instructions are operable to determine the stresses in the expandable tubular member.

22. The computer readable medium of claim 20 wherein the program instructions are operable to determine the strains in the expandable tubular member.

23. The computer readable medium of claim 20 wherein the program instructions are operable to determine the stresses and strains in the expandable tubular member.

24. The computer readable medium of claim 20 wherein the program instructions are operable to determine the stresses in the expansion device and the expandable tubular member.

25. A method for operating an expansion device to radially expand and plastically deform an expandable tubular member, comprising:
displacing an expansion device through an expandable tubular member using at least one of a pressure and an expansion force;
changing a radius of the expandable tubular member; and
changing a thickness of the expandable tubular member;
wherein the pressure is a function of one or more of the following sets of variables:
a set of variables comprising r_{pig}, h_{f} and σₛ;
a set of variables comprising D_{pig}, hᵢ, H₁₀₀ and S_{s 100};
a set of variables comprising D_{pig}, hⱼ, H₁₀₀, S_{s 100} and σ_{T}; and
a set of variables comprising D_{pig}, hᵢ, H_{2 100} and S_{s2 100};
a set of variables comprising r_{f}, μ, rᵢ, pₙ(r), r and dr; and
a set of variables comprising r_{f}, μ, rᵢ, pₙ(r), r and dr;
wherein the expansion force is a function of one or more of the following sets of variables:
a set of variables comprising p, σ_{T} and D_{pig};
a set of variables comprising rᵢ, r_{f}, pₙ, μ, α, r and dr;
a set of variables comprising α, μ, rᵢ, r_{f}, pₙ, r and dr;
a set of variables comprising α, μ, rᵢ, r_{f}, σₜ, r, h and dr;
a set of variables comprising α, μ, rᵢ, r_{f}, σₜ, h and dr;
a set of variables comprising α, μ, σ_{T}, h, ID, Sₜ, H and R;
a set of variables comprising P₁, σ_{T} and D_{pig}; and
a set of variables comprising p₂, σ_{T} and D_{pig};
wherein the radii of the expandable tubular member are a function of one or more of the following sets of variables:
a set of variables comprising r, dr, ψ(r) and dψ; and
a set of variables comprising rᵢ₁, rᵢ, ψᵢ, ψᵢ₁, ν and α.
wherein the thickness of the expandable tubular member is a function of one or more of the following sets of variables:
a set of variables comprising r, dσₛ, dr, h, σₛ, dh, μ and α;
a set of variables comprising r, dr, h, σₛ, dh and σₜ;
a set of variables comprising h, ψ, dψ, dh, μ and α; and
a set of variables comprising dh, h, ε₁ and ψ;
wherein displacing the expansion device using at least one of the pressure and the expansion force comprises displacing the expansion device through the expandable tubular member without exceeding a burst pressure, wherein the burst pressure is a function of one or more of the following sets of variables:
a set of variables comprising h_{f}, σ_{T} and OD_{f};
a set of variables comprising hᵢ, H₁₀₀ and D_{pig};
a set of variables comprising c_{bur} and p;
a set of variables comprising hⱼ, H₁₀₀, D_{pig} and σ_{T}; and
a set of variables comprising h_{f}, σ_{T} and OD_{f};
and
wherein the method further comprises creating one or more of the following:
stresses in the expandable tubular member, wherein the stresses are functions of one or more of the following sets of variables:
a set of variables comprising pⱼ, hⱼ, D_{pig} S_{s 100} and σ_{T};
a set of variables comprising ψ, dψ, ε₁, μ and α;
a set of variables comprising ψ, dψ, ε, μ and α;
a set of variables comprising S_{s 1}, ε₁, σ_{T} and ψ₁;
a set of variables comprising S_{s 2}, ε₂, n, ψ₂ and σ_{T};
a set of variables comprising S_{t 2}, ε₂, n, ψ₂ and σ_{T}; and
a set of variables comprising S_{t 1}, ε₁, σ_{T} and ψ₁;
strains in the expandable tubular member, wherein the strains are functions of one or more of the following sets of variables:
a set of variables comprising dεₜ and ψ;
a set of variables comprising dεᵣ and ψ;
if the strains comprise hoop strain, then a set of variables comprising R_{2 N} and R_{2 0}; and
a set of variables comprising H₂ N and H_{2 0};
stresses and strains in the expandable tubular member, wherein the stresses and strains are functions of dσₛ, dσₜ, σₛ, σₜ, μ and α;
and
stresses in the expansion device and the expandable tubular member,
wherein the stresses are a function of one or more of the following sets of variables:
a set of variables comprising r, σₛ(r), h(r), σₜ, dr, μ and α;
a set of variables comprising r, dr, σₛ(r), dεᵣ, dεₜ, σₜ, μ and α; and
a set of variables comprising r, dr, σₛ(r), σₜ(r), μ and α.

26. A computer readable medium, comprising:
program instructions operable to determine the change in a radius of an expandable tubular member upon radial expansion and plastic deformation of the expandable tubular member by an expansion device;
program instructions operable to determine the change in a thickness of the expandable tubular member upon the radial expansion and plastic deformation of the expandable tubular member by the expansion device;
program instructions operable to determine one or more of the following:
a pressure to be applied to an expansion device in order to provide steady state radial expansion and plastic deformation of an expandable tubular member by the expansion device; and
an expansion force needed to radially expand and plastically deform the expandable tubular member by the expansion device;
and
program instructions operable to determine a burst pressure of the expandable tubular member;
wherein the pressure is a function of one or more of the following sets of variables:
a set of variables comprising r_{pig}, h_{f} and σₛ;
a set of variables comprising D_{pig}, hᵢ, H₁₀₀ and S_{s 100};
a set of variables comprising D_{pig}, hⱼ, H₁₀₀, S_{s 100} and OT; and
a set of variables comprising D_{pig}, hᵢ, H_{2 100} and S_{s2 100};
a set of variables comprising r_{f}, μ, rᵢ, pₙ(r), r and dr; and
a set of variables comprising r_{f}, μ, rᵢ, pₙ(r), r and dr;
wherein the expansion force is a function of one or more of the following sets of variables:
a set of variables comprising p, σ_{T} and D_{pig};
a set of variables comprising rᵢ, r_{f}, pₙ, pₙ α, r and dr;
a set of variables comprising α, μ, r, rᵢ, pₙ, r and dr;
a set of variables comprising α, μ, rᵢ, r_{f}, σₜ, r, h and dr;
a set of variables comprising α, μ, rᵢ, r_{f}, σₜ, h and dr;
a set of variables comprising α, μ, σ_{T}, h, ID, Sₜ, H and R;
a set of variables comprising P₁, σ_{T} and D_{pig}; and
a set of variables comprising p₂, σ_{T} and D_{pig};
wherein the radii of the expandable tubular member are a function of one or more of the following sets of variables:
a set of variables comprising r, dr, ψ(r) and dψ; and
a set of variables comprising rᵢ, rᵢ, ψᵢ, ψᵢ₁, μ and α;
wherein the thickness of the expandable tubular member is a function of one or more of the following sets of variables:
a set of variables comprising r, dσₛ, dr, h, σₛ, dh, μ and α;
a set of variables comprising r, dr, h, σₛ, dh and σₜ;
a set of variables comprising h, ψ, dψ, dh, μ and α; and
a set of variables comprising dh, h, ε₁ and ψ;
wherein the burst pressure is a function of one or more of the following sets of variables:
a set of variables comprising h_{f}, σ_{T} and OD_{f};
a set of variables comprising hᵢ, H₁₀₀ and D_{pig};
a set of variables comprising c_{bur} and p;
a set of variables comprising hⱼ, H₁₀₀, D_{pig} and σ_{T}; and
a set of variables comprising h_{f}, σ_{T} and OD_{f};
and
wherein the computer readable medium further comprises program instructions operable to determine one or more of the following:
stresses in an expandable tubular member associated with the radial expansion and plastic deformation of the expandable tubular member by an expansion device, wherein the stresses are functions of one or more of the following sets of variables:
a set of variables comprising pⱼ, hⱼ, D_{pig} S_{s 100} and σ_{T};
a set of variables comprising ψ, dψ, ε₁, μ and α;
a set of variables comprising ψ, dψ, , μ and α;
a set of variables comprising S_{s 1}, ε₁, σ_{T} and ψ₁;
a set of variables comprising S_{s 2}, ε₂, n, ψ₂ and σ_{T};
a set of variables comprising S_{t 2}, ε₂, n, ψ₂ and σ_{T}; and
a set of variables comprising S_{t 1}, ε₁, σ_{T} and ψ₁;
strains in the expandable tubular member associated with the radial expansion and plastic deformation of the expandable tubular member by the expansion device, wherein the strains are functions of one or more of the following sets of variables:
a set of variables comprising dεₜ and ψ,
a set of variables comprising dεᵣ and ψ;
if the strains comprise hoop strain, then a set of variables comprising R_{2 N} and R_{2 0}; and
a set of variables comprising H_{2 N} and H_{2 0};
stresses and strains in the expandable tubular member associated with the radial expansion and plastic deformation of the expandable tubular member by the expansion device, wherein the stresses and strains are functions of dσₛ, dσₜ, σₛ, σₜ, μ and α;
and
stresses in the expansion device and the expandable tubular member associated with the radial expansion and plastic deformation of the expandable tubular member by the expansion device, wherein the stresses are a function of one or more of the following sets of variables:
a set of variables comprising r, σₛ(r), h(r), σₜ, dr, μ and α,
a set of variables comprising r, dr, σₛ(r), dεᵣ, dεₜ, σₜ, μ and α; and
a set of variables comprising r, dr, σₛ(r), σₜ(r), μ and α.
